(19) United States
(12) Patent Application Publication
(10) Pub. No.: US 2023/0262660 A1
(43) Pub. Date: Aug. 17, 2023

(54) COMMUNICATION METHOD AND DEVICE IN WIRELESS COMMUNICATION SYSTEM SUPPORTING SIDELINK CARRIER AGGREGATION

(71) Applicant: Samsung Electronics Co., Ltd., Suwon-si, Gyeonggi-do (KR)

(72) Inventors: Sungjin PARK, Suwon-si (KR); Hyunseok RYU, Suwon-si (KR); Cheolkyu SHIN, Suwon-si (KR); Jeongho YEO, Suwon-si (KR)

(21) Appl. No.: 18/015,237

(22) PCT Filed: Jun. 14, 2021
(86) PCT No.: PCT/KR2021/007384

§ 371 Date: Jan. 9, 2023

(30) Foreign Application Priority Data
Jul. 10, 2020 (KR) 10-2020-0085510

(51) Int. Cl. H04W 72/02; H04W 72/0446; H04W 72/25; H04L 5/00

(52) U.S. Cl. CPC H04W 72/02; H04W 72/0446; H04W 72/25; H04L 5/0053

(57) ABSTRACT

The present disclosure relates to a resource allocation method and device in a wireless communication system. A communication method of a transmission terminal in a wireless communication system supporting sidelink carrier aggregation, according to the present disclosure, comprises the steps of receiving, from a network, information on a resource pool for sidelink communication, and information on a sidelink feedback channel, transmitting sidelink data in a sidelink data channel through at least one carrier, and receiving, in the sidelink feedback channel through at least one carrier from at least one receiving terminal which has received the sidelink data, sidelink feedback information including acknowledgement information for the sidelink data.

### CROSS-REFERENCE TO RELATED APPLICATION(S)

This application is a U.S. National Stage application under 35 U.S.C. § 371 of an International application number PCT/KR2021/007384, filed on Jun. 14, 2021 which is based on and claims priority of a Korean patent application number 10-2020-0085510, filed on Jul. 10, 2020, in the Korean Intellectual Property Office, the disclosure of which is incorporated by reference herein in its entirety.

### TECHNICAL FIELD

The disclosure relates to a resource allocation method and device in a wireless communication system.

### BACKGROUND ART

In order to meet the demand for wireless data traffic soaring since the 4G communication system came to the market, there are ongoing efforts to develop enhanced 5G communication systems or pre-5G communication systems. For the reasons, the 5G communication system or pre-5G communication system is called the beyond 4G network communication system or post long term evolution (LTE) system. For higher data transmit rates, 5G communication systems are considered to be implemented on ultra-high frequency bands (mmWave), such as, e.g., 70 GHz. To mitigate pathloss on the ultra-high frequency band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna. Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation. There are also other various schemes under development for the 5G system including, e.g., hybrid FSK and QAM modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. To implement the IoT, technology elements, such as a sensing technology, wired/wireless communication and network infra, service interface technology, and a security technology, are required. There is a recent ongoing research for inter-object connection technologies, such as the sensor network, Machine-to-Machine (M2M), or the Machine-Type Communication (MTC). In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, healthcare, or smart appliance industry, or state-of-art medical services, through conversion or integration of existing information technology (IT) techniques and various industries.

Thus, there are various ongoing efforts to apply the 5G communication system to the IoT network. For example, the sensor network, machine-to-machine (M2M), machine type communication (MTC), or other 5G techniques are implemented by schemes, such as beamforming, multi-input multi-output (MIMO), and array antenna schemes. The above-mentioned application of the cloud radio access network (RAN) as a big data processing technique may be said to be an example of the convergence of the 3eG and IoT technologies.

As described above, as mobile communication systems evolve to provide various services, a need arises for a method for effectively providing such services. For example, a method for allocating resources in a wireless communication system is required.

### DETAILED DESCRIPTION OF THE INVENTION

### Technical Problem

The disclosure provides a method and device for communication by a UE in a wireless communication system supporting sidelink carrier aggregation.

The disclosure also provides a communication method and device for transmitting/receiving a signal on a sidelink feedback channel by a UE and a resource allocation method and device therefor, in a wireless communication environment where the sidelink feedback channel is present between UEs.

### Technical Solution

According to an embodiment of the disclosure, a method for communication by a transmission user equipment (UE) in a wireless communication system supporting sidelink carrier aggregation comprises receiving, from a network, information about a resource pool for sidelink communication and information about a sidelink feedback channel, transmitting sidelink data on a sidelink data channel through at least one carrier, and receiving sidelink feedback information including acknowledgement information for the sidelink data on the sidelink feedback channel through at least one carrier from at least one reception UE receiving the sidelink data.

Further, according to an embodiment of the disclosure, a method for communication by a reception UE in a wireless communication system supporting sidelink carrier aggregation comprises receiving, from a network, information about a resource pool for sidelink communication and information about a sidelink feedback channel, receiving sidelink data on a sidelink data channel through at least one carrier, and transmitting sidelink feedback information including acknowledgement information for the sidelink data on the sidelink feedback channel through at least one carrier to at least one transmission UE transmitting the sidelink data.

Further, according to an embodiment of the disclosure, a transmission UE in a wireless communication system supporting sidelink carrier aggregation comprises a transceiver and a processor configured to receive, from a network, information about a resource pool for sidelink communication and information about a sidelink feedback channel, transmit sidelink data on a sidelink data channel through at least one carrier, and receive sidelink feedback information including acknowledgement information for the sidelink data on the sidelink feedback channel through at least one carrier from at least one reception UE receiving the sidelink data.

Further, according to an embodiment of the disclosure, a reception UE in a wireless communication system supporting sidelink carrier aggregation comprises a transceiver and a processor configured to receive, from a network, information about a resource pool for sidelink communication and information about a sidelink feedback channel, receive sidelink data on a sidelink data channel through at least one carrier, and transmit sidelink feedback information including acknowledgement information for the sidelink data on the sidelink feedback channel through at least one carrier to at least one transmission UE transmitting the sidelink data.

### BRIEF DESCRIPTION OF THE DRAWINGS

FIG. 1 is a view illustrating a system according to an embodiment of the disclosure;

FIG. 2 is a view illustrating a vehicle to everything (V2X) communication method according to an embodiment of the disclosure;

FIG. 3 is a view illustrating a protocol of a V2X UE according to an embodiment of the disclosure;

FIG. 4 is a view illustrating an example of a V2X communication procedure according to an embodiment of the disclosure;

FIG. 5 is a view illustrating another example of a V2X communication procedure according to an embodiment of the disclosure;

FIG. 6 is a view illustrating a sidelink resource pool for performing V2X communication by a V2X UE according to an embodiment of the disclosure;

FIG. 7 is a view illustrating a multiplexing scheme of a sidelink control channel, a sidelink data channel, and a sidelink feedback channel in a sidelink resource pool according to an embodiment of the disclosure;

FIG. 8A is a view illustrating an example of a time axis resource allocation of a sidelink feedback channel according to an embodiment of the disclosure;

FIG. 8B is a view illustrating another example of a time axis resource allocation of a sidelink feedback channel according to an embodiment of the disclosure;

FIG. 9A is a view illustrating an example of a resource structure of a sidelink feedback channel according to an embodiment of the disclosure;

FIG. 9B is a view illustrating another example of a resource structure of a sidelink feedback channel according to an embodiment of the disclosure;

FIG. 10 is a view illustrating an example of a frequency resource allocation of a sidelink feedback channel according to an embodiment of the disclosure;

FIG. 11 is a view illustrating another example of a frequency resource allocation of a sidelink feedback channel according to an embodiment of the disclosure;

FIG. 12 is a view illustrating another example of a time axis resource allocation of a sidelink feedback channel according to an embodiment of the disclosure;

FIG. 13A is a view illustrating another example of a frequency resource allocation of a sidelink feedback channel according to an embodiment of the disclosure;

FIG. 13B is a view illustrating a specific example of a frequency resource allocation of a sidelink feedback channel according to an embodiment of the disclosure;

FIG. 13C is a view illustrating another example of a frequency resource allocation of a sidelink feedback channel according to an embodiment of the disclosure;

FIG. 13D is a view illustrating another example of a frequency resource allocation of a sidelink feedback channel according to an embodiment of the disclosure;

FIG. 13E is a view illustrating an example for calculating the number of bits of feedback information transmitted on a sidelink feedback channel according to an embodiment of the disclosure;

FIG. 14 is a view illustrating another example of a frequency resource allocation of a sidelink feedback channel according to an embodiment of the disclosure;

FIG. 15 is a view illustrating another example of a frequency resource allocation of a sidelink feedback channel according to an embodiment of the disclosure;

FIG. 16 is a view illustrating another example of a frequency resource allocation of a sidelink feedback channel according to an embodiment of the disclosure;

FIG. 17 is a view illustrating another example of a frequency resource allocation of a sidelink feedback channel according to an embodiment of the disclosure;

FIG. 18 is a view illustrating another example of a frequency resource allocation of a sidelink feedback channel according to an embodiment of the disclosure;

FIG. 19 is a view illustrating another example of a frequency resource allocation of a sidelink feedback channel according to an embodiment of the disclosure;

FIG. 20A is a view illustrating another example of a frequency resource allocation of a sidelink feedback channel according to an embodiment of the disclosure;

FIG. 20B is a view illustrating another example of a frequency resource allocation of a sidelink feedback channel according to an embodiment of the disclosure;

FIG. 21A is a view illustrating another example of a frequency resource allocation of a sidelink feedback channel according to an embodiment of the disclosure;

FIG. 21B is a view illustrating another example of a frequency resource allocation of a sidelink feedback channel according to an embodiment of the disclosure;

FIG. 22A is a flowchart illustrating operations of a reception UE for sidelink HARQ feedback transmission according to an embodiment of the disclosure;

FIG. 22B is another flowchart illustrating operations of a reception UE for sidelink HARQ feedback transmission according to an embodiment of the disclosure;

FIG. 23 is a view illustrating a transmit power control method of a sidelink feedback channel according to an embodiment of the disclosure;

FIG. 24 is a view illustrating a communication method using a sidelink feedback channel in a CA environment according to an embodiment of the disclosure;

FIG. 25 is a view illustrating an example of resource allocation of a sidelink feedback channel in a CA environment according to an embodiment of the disclosure;

FIG. 26 is a view illustrating another example of resource allocation of a sidelink feedback channel in a CA environment according to an embodiment of the disclosure;

FIG. 27 is a view illustrating another example of resource allocation of a sidelink feedback channel in a CA environment according to an embodiment of the disclosure;

FIG. 28 is a view illustrating another example of resource allocation of a sidelink feedback channel in a CA environment according to an embodiment of the disclosure;

FIG. 29 is a view illustrating another example of resource allocation of a sidelink feedback channel in a CA environment according to an embodiment of the disclosure;

FIG. 30 is a flowchart illustrating operations of a transmission UE in a CA environment according to an embodiment of the disclosure;

FIG. 31 is a flowchart illustrating operations of a reception UE in a CA environment according to an embodiment of the disclosure;

FIG. 32 is a block diagram illustrating an internal structure of a transmission UE according to an embodiment of the disclosure;

FIG. 33 is a block diagram illustrating an internal structure of a reception UE according to an embodiment of the disclosure; and

FIG. 34 is a block diagram illustrating an internal structure of a base station according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a ‘unit’ may be combined with additional elements or may be split into sub elements or sub units. Further, an element or a ‘unit’ may be implemented to reproduce one or more CPUs in a device or a security multimedia card. According to embodiments, a “ . . . unit” may include one or more processors.

The description of embodiments of the disclosure focuses on the radio access network, new RAN (NR), and the core network, packet core (5G system, or 5G core network, or NG core, or next generation core), which are specified by the 3rd generation partnership (3GPP) which is a mobile communication standardization organization. However, the subject matter of the disclosure, or slight changes thereto, may also be applicable to other communication systems that share similar technical backgrounds without departing from the scope of the disclosure, which would readily be appreciated by one of ordinary skill in the art.

In the 5G system, network data collection and analysis function (NWDAF) which is a network function for analyzing the data collected from the 5G network and providing it may be defined to support network automation. The NWDAF may collect/store/analyze information from the 5G network and provide the result to an unspecified network function (NF), and the analysis result may be used independently in each NF.

For ease of description, some of the terms or names defined in the 3rd generation partnership project (3GPP) standards (standards for 5G, new radio (NR), long-term evolution (LTE), or similar systems) may be used. However, the disclosure is not limited by such terms and names and may be likewise applicable to systems conforming to other standards.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited by the terms, and such terms may be replaced with other terms denoting objects with equivalent technical concept.

In order to meet the demand for wireless data traffic soring since the 4G communication system came to the market, there are ongoing efforts to develop enhanced 5G communication systems (new radio (NR)). For higher data transmit rates, 5G communication systems have been designed so that resources on ultra-high frequency bands (e.g., 28 GHz frequency band) are also available. To mitigate pathloss on the ultra-high frequency band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna. Besides, unlike LTE, the 5G communication system supports various subcarrier spacings such as 30 kHz, 60 kHz, and 120 kHz as well as 15 kHz, uses polar coding for the physical control channel, and uses low density parity check (LDPC) for the physical data channel. Further, as waveforms for uplink transmission, not only Discrete Fourier Transform Spread Orthogonal Frequency Division Multiplexing (DFT-S-OFDM) but also Cyclic Prefix OFDM (CP-OFDM) is used. While LTE supports hybrid ART (HARQ) retransmission in transport block (TB) units, 5G may additionally support HARQ retransmission based on the code block group (CBG) which is a bundle of several code blocks (CBs).

Also being developed are various technologies for the 5G communication system to have an enhanced network, such as evolved or advanced small cell, cloud radio access network (cloud RAN), ultra-dense network, device-to-device (D2D) communication, wireless backhaul, vehicle-to-everything (V2X) network, cooperative communication, coordinated multi-point (CoMP), and interference cancellation.

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. To implement the IoT, technology elements, such as a sensing technology, wired/wireless communication and network infra, service interface technology, and a security technology, are required. There is a recent ongoing research for inter-object connection technologies, such as the sensor network, Machine-to-Machine (M2M), or the Machine-Type Communication (MTC). In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, healthcare, or smart appliance industry, or state-of-art medical services, through conversion or integration of existing information technology (IT) techniques and various industries.

Thus, there are various ongoing efforts to apply the 5G communication system to the IoT network. For example, the sensor network, machine-to-machine (M2M), machine type communication (MTC), or other 5G techniques are implemented by schemes, such as beamforming, multi-input multi-output (MIMO), and array antenna schemes. The above-mentioned application of the cloud radio access network (RAN) as a Big data processing technique may be said to be an example of the convergence of the 5G and IoT technologies. As such, a plurality of services may be provided to users in the communication system and, to that end, there are required a method for providing the services in the same time interval according to characteristics and a device using the method. Various services provided by 5G communication systems are being studied, and among them, one is a service to meet the requirements of low latency and high reliability high reliability.

In the case of vehicle communication, LTE-based V2X based on device-to-device (D2D) communication structure has completed standardization in 3GPP Rel-14 and Rel-15, and efforts are currently underway to develop V2X based on 5G new radio (NR). NR-based V2X (hereinafter, NR V2X) is scheduled to support unicast communication between UEs, groupcast (or multicast) communication, and broadcast communication. Further, unlike LTE-based V2X (hereinafter, LTE V2X), which aims to transmit and receive basic safety information necessary for vehicles to travel on the road, NR V2X aims to provide more advanced services, such as platooning, advanced driving, extended sensor, or remote driving.

The NR V2X reception UE may transmit sidelink control information and data information to the NR V2X reception UE. The NR V2X reception UE receiving the information may transmit an acknowledgement (ACK) or negative acknowledgement (NACK) for the received sidelink data information to the NR V2X transmission UE. The ACK/NACK information may be referred to as sidelink feedback control information (SFCI). The SFCI may be transmitted through the physical sidelink feedback channel (PSFCH) of the physical layer.

Meanwhile, the NR V2X transmission UE may transmit a sidelink reference signal to allow the NR V2X reception UE to obtain information about the sidelink channel state. In this case, the sidelink reference signal may be a demodulation reference signal (DMRS) used for the NR V2X reception UE to perform channel estimation or channel state information reference signal (CSI-RS) for obtaining channel state information. When the CSI-RS is used, it may be transmitted using a time/frequency/code resource different from that of the DMRS. The NR V2X reception UE, obtaining the channel state information about the sidelink channel through the DMRS or CSI-RS transmitted by the NR V2X transmission UE, may report the obtained channel state information (CSI) to the NR V2X transmission UE. The CSI may be the above-mentioned SFCI and be transmitted through the sidelink feedback channel.

As another example, HARQ-ACK/NACK information and the CSI may be multiplexed to be simultaneously transmitted through the sidelink feedback channel.

Embodiments of the disclosure are proposed to support the above-described scenario and provide an efficient method and device for the NR V2X UE to transmit/receive information through the sidelink feedback channel.

The disclosure relates to a resource allocation method of a feedback channel in a wireless communication system and specifically relates to a resource allocation method and device for transmission and reception of information on the sidelink feedback channel transmitted between UEs.

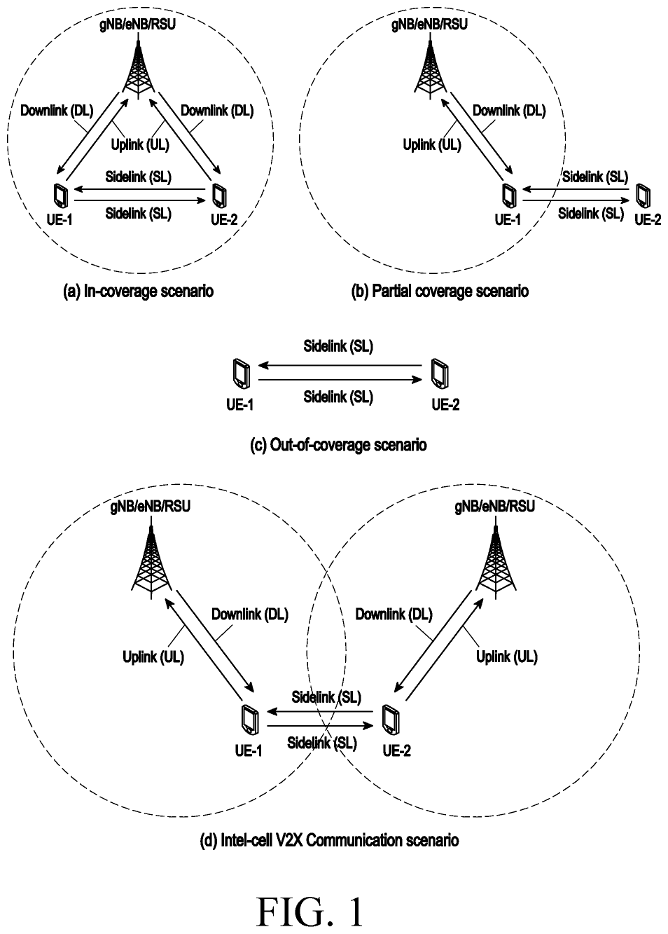

FIG. 1 is a view illustrating a system according to an embodiment of the disclosure.

FIG. 1(a) illustrates an example in which all V2X UEs (UE-1 and UE-2) are positioned within the coverage of a base station.

All V2X UEs may receive data and control information through a downlink (DL) from the base station or transmit data and control information through an uplink (UL) to the base station. In this case, the data and control information may be data and control information for V2X communication. Or, the data and control information may be data and control information for normal cellular communication. Further, V2X UEs may transmit/receive data and control information for V2X communication through a sidelink (SL).

FIG. 1(b) illustrates an example in which UE-1 among V2X UEs is positioned within the coverage of the base station and UE-2 is positioned outside the coverage of the base station. The example according to FIG. 1(b) may be referred to as an example of partial coverage.

UE-1 located in the coverage of the base station may receive data and control information through a downlink (DL) from the base station or transmit data and control information through an uplink (UL) to the base station.

UE-2 positioned outside the coverage of the base station cannot receive data and control information through downlink from the base station, and cannot transmit data and control information through uplink to the base station.

UE-2 may transmit/receive data and control information for V2X communication with UE-1 through a sidelink.

FIG. 1(c) illustrates an example in which all the V2X UEs are located outside the coverage of the base station.

Accordingly, UE-1 and UE-2 cannot receive data and control information through downlink from the base station, and cannot transmit data and control information through uplink to the base station.

UE-1 and UE-2 may transmit/receive data and control information for V2X communication with UE-2 through a sidelink.

FIG. 1(d) illustrates an example of a scenario in which V2X communication is performed between the V2X UEs located in different cells. Specifically, FIG. 1(d) illustrates a case in which a V2X transmission UE and a V2X reception UE are connected to different base stations (RRC connected state) or camp on different base stations (RRC connection released state, i.e., RRC idle state). Here, UE-1 may be a V2X transmission UE, and UE-2 may be a V2X reception UE. Or, UE-1 may be a V2X reception UE and UE-2 may be a V2X transmission UE. UE-1 may receive a V2X-dedicated system information block (SIB) from a base station where it is connected (or camps), and UE-2 may receive a V2X-dedicated SIB from another base station where it is connected (or camps). In this case, the V2X-dedicated SIB information received by UE-1 and the V2X-dedicated SIB information received by UE-2 may differ from each other. Therefore, it is necessary to match information to perform V2X communication between UEs positioned in different cells.

In the example of FIG. 1, for convenience of description, a V2X system including two UEs (UE-1 and UE-2) are shown, but is not limited thereto. Further, the uplink and downlink between the base station and the V2X UEs may be named Uu interfaces, and the sidelink between the V2X UEs may be named a PC5 interface. Therefore, in the disclosure, these may be interchangeably used.

Meanwhile, in the disclosure, vehicles may mean vehicles supporting vehicle-to-vehicular (V2V) communication, vehicles supporting vehicle-to-pedestrian (V2P) communication, vehicles supporting vehicle-to-network (V2N) communication, or vehicles supporting vehicle-to-infrastructure (V21). In the disclosure, UEs may mean roadside units (RSUs) equipped with UE features, RSUs equipped with base station features, or RSUs equipped with some of base station features and some of UE features.

Further, in the disclosure, the base station may be previously defined as a base station supporting both V2X communication and general cellular communication, or a base station supporting only V2X communication. In this case, the base station may mean a 5G base station (gNB), a 4G base station (eNB), or a road site unit (RSU). Therefore, unless otherwise mentioned in the disclosure, since base station and RSU may be used in the same concept, base station and RSU may be used interchangeably.

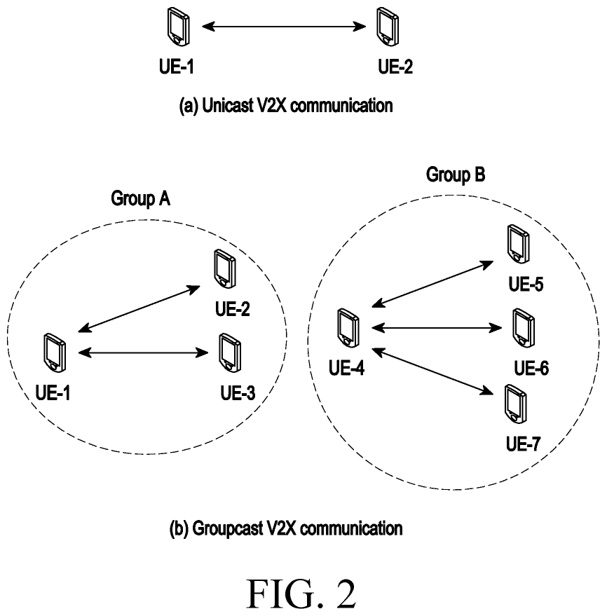

FIG. 2 is a view illustrating a V2X communication method according to an embodiment of the disclosure.

As shown in FIG. 2(a), the TX UE and the RX UE may perform one-to-one communication, which may be referred to as unicast communication.

As shown in FIG. 2(b), the TX UE and the RX UE may perform one-to-many communication. This may be referred to as groupcast or multicast communication.

FIG. 2(b) is a view illustrating that UE-1, UE-2, and UE-3 form one group (group A) to perform groupcast communication, and UE-4, UE-5, UE-6, and UE-7 form another group (group B) to perform groupcast communication. Each UE may perform groupcast communication only within the group to which it belongs and perform communication with UEs present in different groups through unicast, groupcast or broadcast communication. Although it is illustrated that two groups are formed in FIG. 2(b), the disclosure is not limited thereto.

Although not shown in FIG. 2, V2X UEs may perform broadcast communication. Broadcast communication may mean a case in which all V2X UEs receive the data and control information transmitted by a V2X transmission UE through a sidelink. As an example, when it is assumed that UE-1 in FIG. 2(b) is a transmission UE for broadcast, all the UEs (UE-2, UE-3, UE-4, UE-5, UE-6, and UE-7) may receive the data and control information transmitted by UE-1.

According to an embodiment of the disclosure, the sidelink broadcast, groupcast, and unicast communication methods may be supported in the in-coverage, out-of-coverage, and partial-coverage scenarios described in (a) to (c) of FIG. 1.

NR V2X may consider support of a transmission form in which a vehicle UE transmits data to only one specific UE through unicast and a form in which aa vehicle UE transmits data to a number of specific UEs through groupcast, unlike LTE V2X. For example, these unicast and groupcast techniques may be useful when considering service scenarios, such as platooning, which is a technique for connecting two or more vehicles via one network to allow them to travel in group. Specifically, unicast communication may be required for the purpose of controlling one specific UE by a leader node of a group for platooning, and group cast communication may be needed for the purpose of simultaneously controlling a group consisting of a specific number of UEs.

Resource allocation in the V2X system may use the following methods.

Mode 1 Resource Allocation

Mode 1 resource allocation may mean a scheduled resource allocation method by the base station. More specifically, in mode 1 resource allocation, the base station may allocate resources used for sidelink transmission to RRC-connected UEs in a dedicated scheduling scheme. The scheduled resource allocation method may be effective for interference management and resource pool management (dynamic allocation and/or semi-persistent transmission) because the base station may manage sidelink resources. If there is data to be transmitted to the other UE(s), the RRC connected mode UE may transmit information notifying the base station that there is data to be transmitted to the other UE(s) by means of an RRC message or MAC control element (CE), For example, the RRC message may be the SidelinkUEInformation or UEAssistanceInformation message defined in the 3GPP standard, and may be, e.g., a scheduling request (SR) or BSR MAC CE including at least one of an indicator indicating that the MAC CE is a buffer status report (BSR) for V2X communication and information about the size of the data buffered for sidelink communication. In the above-described mode 1 resource allocation method, the sidelink transmission UE receives a schedule for resources by the base station, and thus, the method may apply only when the V2X transmission UE is in the coverage of the base station.

Mode 2 Resource Allocation

Mode 2 resource allocation may mean a method in which a sidelink transmission UE autonomously selects resources (UE autonomous resource selection). More specifically, mode 2 may mean a method in which the base station provides the UE with the sidelink transmission/reception resource pool through system information or RRC message (e.g., RRCReconfiguration message or PC5-RRC message), and the transmission UE selects a resource pool and resources according to a determined rule. In the above-described example, since the base station provides configuration information about the sidelink transmission/reception resource pool, it may apply when the V2X transmission/reception UE is in the coverage of the base station. When the V2X transmission/reception UE is out of the coverage of the base station, the V2X transmission/reception UE may perform the mode 2 operation in a preconfigured transmission/reception resource pool. The UE autonomous resource selection method may include, e.g., zone mapping, sensing-based resource selection, or random selection.

Additionally, although the V2X transmission/reception UE is in the coverage of the base station, it may be impossible to perform scheduled resource allocation or resource allocation or resource selection in the UE autonomous resource selection mode in which case, the UE may perform V2X sidelink communication through a preconfigured sidelink transmission/reception resource pool.

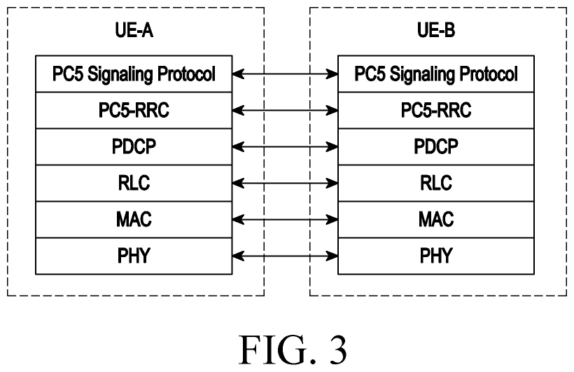

FIG. 3 is a view illustrating a protocol of a V2X UE according to an embodiment of the disclosure.

Although not shown in FIG. 3, the application layers of UE-A and UE-B may perform service discovery. In this case, service discovery may include discovery as to what V2X communication scheme each UE is to perform (i.e., unicast, groupcast, or broadcast communication scheme). In FIG. 3, it may be assumed that UE-A and UE-B have recognized to perform the unicast communication scheme via the service discovery process performed on the application layer. The NR V2X UEs may obtain information about the source ID and destination ID for NR V2X unicast communication in the above-mentioned service discovery process.

If the service discovery process is completed, the PC5 signaling protocol layer shown in FIG. 3 may perform a direct link setup procedure between UEs. In this case, security configuration information for direct communication between UEs may be transmitted/received.

If the direct link setup procedure is completed, a PC5-RRC setup procedure between UEs may be performed in the PC5-RRC layer of FIG. 3. In this case, information about capabilities of UE-A and UE-B may be exchanged, and access stratum (AS) layer parameter information for unicast communication may be exchanged.

When the PC5-RRC configuration procedure is completed, UE-A and UE-B may perform unicast communication.

Although unicast communication has been described as an example in the above-described example, it may be similarly applied to group cast communication. For example, when UE-A, UE-B, and UE-C perform group cast communication, the above-mentioned service discovery between UE-A and UE-B, direct link setup, and PC5-RRC setup procedure may be performed in UE-B and UE-C, and UE-A and UE-C.

More specifically, the NR V2X UEs may obtain information about the source ID and destination ID for NR V2X groupcast communication in the above-mentioned service discovery process. If the service discovery process is completed, the PC5 signaling protocol layer shown in FIG. 3 may perform a direct link setup procedure between UEs. In this case, security configuration information for direct communication between UEs may be transmitted/received.

If the direct link setup procedure is completed, a PC5-RRC setup procedure between UEs may be performed in the PC5-RRC layer of FIG. 3. In this case, information about capabilities of UE-A, UE-B, and UE-C may be exchanged, and access stratum (AS) layer parameter information for groupcast communication may be exchanged. However, when there are three or more UEs, a lot of signaling overhead and communication latency may occur in exchanging information about their capabilities and AS layer parameter information. Therefore, as another example, in the case of groupcast communication, if the aforementioned direct link setup procedure is completed, the PC5-RRC setup procedure between UEs may be omitted.

If the PC5-RRC setup procedure is completed (or when the PC5-RRC setup procedure is omitted, if the direct link setup procedure is completed), UE-A, UE-B, and UE-C may perform groupcast communication.

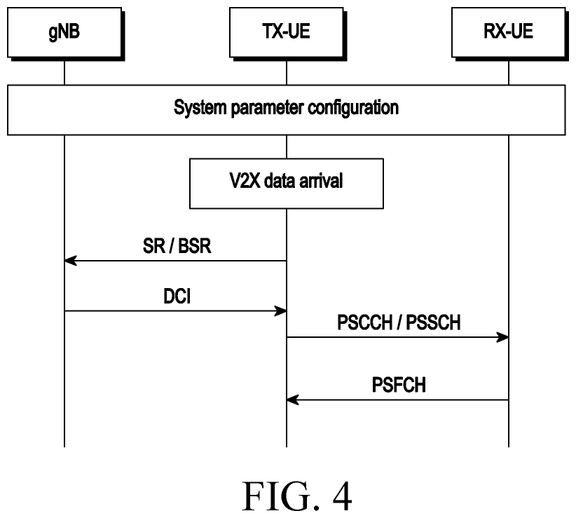

FIG. 4 is a view illustrating an example of a V2X communication procedure according to an embodiment of the disclosure.

More specifically, FIG. 4 is a view for a V2X communication procedure based on the mode 1 resource allocation described in FIG. 2. In FIG. 4, the base station may configure parameters for V2X communication to the V2X UE in the cell through system information. For example, the base station may configure information about a resource pool in which V2X communication may be performed in its own cell. In this case, the resource pool may refer to a transmission resource pool for V2X transmission or a reception resource pool for V2X reception. Further, the resource pool may refer to a sidelink control information resource pool for transmitting/receiving V2X control information, a sidelink data information resource pool for transmitting/receiving V2X data information, or a sidelink feedback information resource pool for transmitting/receiving V2X feedback information.

The V2X UE may receive information about one or more resource pools from the base station. The base station may configure unicast, group cast, and broadcast communication to be performed in different resource pools through system information. For example, resource pool 1 is used for unicast communication. Resource pool 2 may be used for groupcast, and resource pool 3 may be used for broadcast communication. As another example, the base station may configure unicast, group cast, and broadcast communication to be performed in the same resource pool. At least one of the following information may be included in the resource pool information configured by the base station.

Time axis information about a resource pool in which physical sidelink control channel (PSCCH) and physical sidelink shared channel (PSSCH): Specifically, may include the slot index and period when the PSCCH and PSSCH may be transmitted, and the slot index and the symbol index and period in the corresponding slot where the PSCCH and PSSCH may be transmitted.

Frequency axis information about a resource pool in which PSCCH and PSSCH may be transmitted: Specifically, may include the resource block index where PSCCH and PSSCH may be transmitted or the index of the sub-channel constituted of two or more resource blocks.

Information about whether sidelink HARQ-ACK is operated may be included in resource pool configuration information.

At least one of the following information may be included for the case where sidelink HARQ-ACK is operated.

Number of Maximum Retransmissions

HARQ-ACK timing: means the time from the time when the V2X reception UE receives sidelink control information and data information from the V2X transmission UE to the time when the V2X reception UE transmits the HARQ-ACK/NACK information to the V2X transmission UE. In this case, the unit of the time may be the slot or one or more OFDM symbols.

Format of the physical sidelink feedback channel (PSFCH): When two or more PSFCH formats are operated, one PSFCH format may be used to transmit HARQ-ACK/NACK information constituted of 1 bit or 2 bits. Another PSFCH format may be used to transmit HARQ-ACK/NACK information constituted of 3 bits or more. Meanwhile, when the aforementioned HARQ-ACK/NACK information is transmitted through PSFCH, ACK information and NACK information each may be transmitted through PSFCH. In this case, the NR V2X reception UE may transmit an ACK through the PSFCH when decoding of the PSSCH transmitted from the NR V2X transmission UE is successful. If decoding fails, NACK may be transmitted through PSFCH. As another example, the NR V2X reception UE may not transmit ACK when decoding of the PSSCH transmitted from the NR V2X transmission UE is successful, but may transmit NACK through the PSFCH only when decoding fails.

A time/frequency/code resource or set of resources constituting the PSFCH: The time resource may include the slot index and symbol index and period when the PSFCH is transmitted. The frequency resource may include the start point and end point (or the start point and the length of the frequency length) of the sub channel constituted of two or more contiguous blocks or the frequency resource block (RB) where the PSFCH is transmitted.

When sidelink HARQ-ACK is not operated, information related to the sidelink feedback channel may not be included.

Information about whether sidelink blind retransmission is operated may be included in resource pool configuration information.

Unlike HARQ-ACK/NACK-based retransmission, blind retransmission may mean that the NR transmission UE does not receive feedback information about ACK or NACK from the NR reception UE but the NR transmission UE repeatedly transmits it. When blind retransmission is operated, the number of blind retransmissions may be included in resource pool information. For example, when the number of blind retransmissions is set to 4, the NR transmission UE may always transmit the same information 4 times when transmitting the PSCCH/PSSCH to the NR reception UE. In this case, a redundancy version (RV) value may be included in the sidelink control information (SCI) transmitted through the PSCCH.

Information about the DMRS pattern that may be used in PSSCH transmitted in the corresponding resource pool

Depending on the speed of the UE, the DMRS pattern that may be used in the PSSCH may be different. For example, it is necessary to increase the number of OFDM symbols used for DMRS transmission on the time axis to enhance the accuracy of channel estimation when the speed is high. Further, since the accuracy of channel estimation may be guaranteed even when a small number of DMRS symbols are used when the speed of the UE is low, it is necessary to reduce the number of OFDM symbols used for DMRS transmission on the time axis to reduce DMRS overhead. Accordingly, information about the resource pool may include information about the DMRS pattern usable in the corresponding resource pool. In this case, two or more DMRS patterns may be configured in one resource pool, and the NR V2X transmission UE may select and use one DMRS pattern from DMRS patterns configured according to its own speed. Further, the NR V2X transmission UE may transmit the information about the DMRS pattern selected by it to the NR V2X reception UE through the SCI of the PSCCH. The NR V2X reception UE may receive the same and obtain DMRS pattern information, perform channel estimation for PSSCH and perform demodulation and decoding process to obtain sidelink data information.

Whether Sidelink CSI-RS is Operated

At least one of the following information may be included when the sidelink CSI-RS is operated.

CSI-RS transmission start time: may mean the start time when the V2X transmission UE should transmit the CSI-RS to the V2X reception UE. The start time may refer to the index of the slot where the CSI-RS is transmitted or the index of the symbol where the CSI-RS is transmitted or both the slot index and the symbol index.

CSI reporting timing: means the time from the time of reception of the CSI-RS by the V2X reception UE from the V2X transmission UE (i.e., the received slot index or the symbol index in the received slot) to the time when the V2X reception UE transmits CSI reporting to the V2X transmission UE (i.e., the slot index where the CSI reporting is transmitted or the symbol index in the slot index transmitted). In this case, the unit of the time represented may be the slot or one or more OFDM symbols.

When sidelink CSI-RS is not operated, the information may not be included.

Parameters for Sidelink Transmit Power Control

The mentioned information has been exemplified to be included in the resource pool configuration for V2X communication, but is not limited thereto. In other words, the mentioned information may be configured to the V2X transmission UE or the V2X reception UE independently of resource pool configuration.

As shown in FIG. 4, when data to be transmitted to the V2X reception UE (RX-UE) is generated in the V2X transmission UE (TX-UE), the V2X transmission UE may send a request for the sidelink resource to be transmitted to the V2X reception UE using a scheduling request (SR) and/or buffer status report (BSR) to the base station (gNB). The base station, receiving the BSR, may identify that the V2X transmission UE has data for sidelink transmission and determine resources necessary for sidelink transmission based on the BSR.

The base station may transmit, to the V2X transmission UE, a sidelink scheduling grant including at least one of resource information for sidelink data transmission and resource information for sidelink control information (SCI) transmission. The sidelink scheduling grant is information for granting dynamic scheduling in the sidelink and may be downlink control information (DCI) transmitted on the physical downlink control channel (PDCCH). The sidelink scheduling grant may include information indicating the bandwidth part (BWP) where sidelink transmission is performed and the carrier indicator field (CIF) or carrier frequency indicator where sidelink transmission is performed in the case where the base station is an NR base station and may include only the CIF in the case where the base station is an LTE base station. Further, the sidelink scheduling grant may further include resource allocation-related information about the PSFCH transmitting the feedback information (A/N information) for the sidelink data. The resource allocation information may include information for allocating a plurality of PSFCH resources for a plurality of UEs in the group when the sidelink transmission is groupcast. Further, the resource allocation-related information about the feedback information may be information indicating at least one of a set of a plurality of feedback information resource candidates configured by higher layer signaling.

The V2X transmission UE, receiving the sidelink scheduling grant, transmits the SCI scheduling sidelink data according to the sidelink scheduling grant to the V2X reception UE through the physical sidelink control channel (PSCCH) and transmits sidelink data to the V2X reception UE through the physical sidelink shared channel (PSSCH). The SCI may include at least one of resource allocation information used for transmission of the sidelink data, modulation and coding scheme (MCS) information applied to the sidelink data, group destination ID information, source ID information, unicast destination ID information, power control information of sidelink power control, timing advance (TA) information, DMRS configuration information for sidelink transmission, packet repetitive transmission-related information (e.g., the number of packet repetitive transmissions, resource allocation-related information upon packet repetitive transmission, redundancy version (RV), and HARQ process ID). Further, the SCI may further include information indicating the resource where feedback information (A/N information) for sidelink data is transmitted.

The V2X reception UE, receiving the SCI, receives sidelink data. Thereafter, the V2X reception UE transmits ACK/NACK information indicating whether decoding of sidelink data succeeds or fails to the V2X transmission UE on the physical sidelink feedback channel (PSFCH). The feedback information transmission for the sidelink may be applied to unicast transmission or groupcast transmission, but does not exclude broadcast transmission. If the sidelink transmission corresponds to groupcast transmission, each UE receiving the groupcast data may transmit feedback information using different PSFCH resources. Or, each UE receiving groupcast data may transmit feedback information using the same PSFCH resource and, in this case, feed back only NACK information (i.e., the UE receiving data does not perform feedback in the case of ACK). In this case, the PSFCH resources may include not only resources distinguished in the time and/or frequency domain but also resources distinguished by using code, e.g., scrambling code or orthogonal cover code and resources distinguished by using different sequences (and cyclic shift applied to the sequence).

FIG. 4 illustrates a state in which the V2X transmission UE establishes an uplink connection with the base station (i.e., RRC connected state), and assume a scenario in which the V2X transmission UE and the V2X reception UE both are present in the coverage of the base station. Although not shown in FIG. 4, when the V2X transmission UE is in a state of not establishing uplink connection with the base station (i.e., RRC idle state), the V2X transmission UE may perform a random access procedure for establishing an uplink connection with the base station. Further, although not shown in FIG. 4, in a scenario where the V2X transmission UE is present in the coverage of the base station, and the V2X reception UE is present out of the coverage of the base station, the V2X reception UE may be previously configured with and use the aforementioned information for V2X communication. Meanwhile, the V2X transmission UE may be configured with information for V2X communication from the base station as shown in FIG. 4.

When the V2X transmission UE and the V2X reception UE both are present out of the coverage of the base station, the V2X transmission UE and the V2X reception UE may be previously configured with and use the mentioned information for V2X communication. In this case, previously configured may mean that information pre-stored in the UE when the UE is shipped out is used. In another sense, when the V2X transmission UE or reception UE has previously access the base station to obtain information about V2X communication through RRC configuration or has an experience of having obtained the information about V2X communication through the system information, it may mean the latest information obtained.

Further, although not shown in FIG. 4, the V2X transmission UE has completed service discovery, direct link setup procedure, and PC5 RRC configuration with the V2X reception UE through the procedure mentioned in FIG. 3 before transmitting the SR/BSR to the base station.

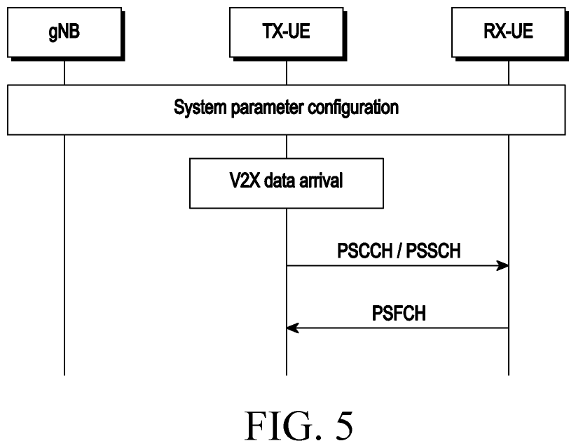

FIG. 5 is a view illustrating another example of a V2X communication procedure according to an embodiment of the disclosure.

More specifically, FIG. 5 is a view for a V2X communication procedure based on the mode 2 resource allocation described in FIG. 2. In FIG. 5, the base station (gNB) may configure parameters for V2X communication to the V2X transmission/reception UEs (TX-UE and RU-UE) in the cell through system information. In this case, the parameters may include at least one of the parameter information illustrated in FIG. 4.

As shown in FIG. 5, when data to be transmitted from the V2X transmission UE (TX-UE) to the V2X reception UE (RX-UE) occurs, the V2X transmission UE may transmit sidelink control information (SCI) to the V2X transmission UE through the PSCCH and transmit sidelink data to the V2X reception UE through the PSSCH. The SCI may include at least one of resource allocation information used for transmission of the sidelink data, MCS information applied to the sidelink data, group destination ID information, source ID information, unicast destination ID information, power control information of sidelink power control, timing advance information, DMRS configuration information for sidelink transmission, packet repetitive transmission-related information (e.g., the number of packet repetitive transmissions, resource allocation-related information upon packet repetitive transmission, redundancy version (RV), and HARQ process ID). Further, the SCI may further include information indicating the resource where feedback information (A/N information) for sidelink data is transmitted.

The V2X reception UE, receiving the SCI, may receive sidelink data. Thereafter, the V2X reception UE may transmit ACK/NACK information indicating whether decoding of sidelink data succeeds or fails to the V2X transmission UE on the PSFCH. The feedback information transmission for the sidelink may be applied to unicast transmission or groupcast transmission, but does not exclude broadcast transmission. If the sidelink transmission corresponds to groupcast transmission, each UE receiving the groupcast data may transmit feedback information using different PSFCH resources. Or, each UE receiving groupcast data may transmit feedback information using the same PSFCH resource and, in this case, feed back only NACK information (i.e., the UE receiving data does not perform feedback upon determining ACK). In this case, the PSFCH resources may include not only resources distinguished in the time and/or frequency domain but also resources distinguished by using code, e.g., scrambling code or orthogonal cover code and resources distinguished by using different sequences (and cyclic shift applied to the sequence).

In FIG. 5, a scenario in which all the V2X transmission/reception UEs are present in the coverage of the base station may be assumed. Although not shown in FIG. 5, the example of FIG. 5 may be applied even when all the V2X transmission/reception UEs are present out of the coverage of the base station. In this case, the V2X transmission/reception UEs may be previously configured with the mentioned information for V2X communication. Further, although not shown in FIG. 5, the example of FIG. 5 may be applied even in a scenario where one UE among the V2X transmission/reception UEs is present in the coverage of the base station, and the remaining UEs are present out of the coverage of the base station. In this case, the UE present in the coverage of the base station may be configured with the information for V2X communication by the base station, and the UE present out of the coverage of the base station may previously be configured with the information for V2X communication. In the example, the ‘information for V2X communication’ may be interpreted as information about at least one of the parameters for V2X communication mentioned in FIG. 4. Further, in an example, previously configured may mean that information pre-stored in the UE when the UE is shipped out is used. In another sense, when the V2X transmission UE or V2X reception UE has previously access the base station to obtain information about V2X communication through RRC configuration or has an experience of having obtained the information about V2X communication through the system information, it may mean the latest information obtained.

Although not shown in FIG. 5, it may be assumed that the V2X transmission UE has completed service discovery, direct link setup procedure, and PC5 RRC configuration with the V2X reception UE through the procedure mentioned in FIG. 3 before the V2X transmission UE transmits the PSCCH/PSSCH to the V2X reception UE.

Although unicast communication where there is only one V2X reception UE is described as an example in FIG. 5, the example of FIG. 5 may be likewise applied to groupcast communication and broadcast communication where there are two or more V2X reception UEs.

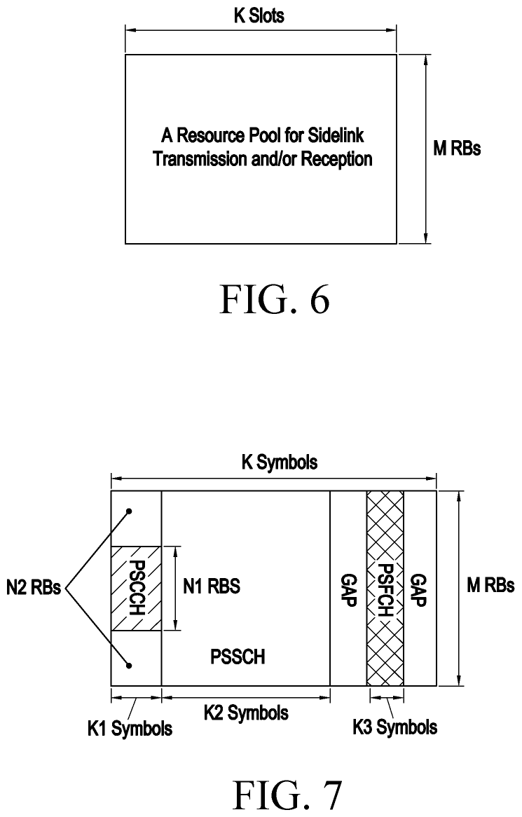

FIG. 6 is a view illustrating a sidelink resource pool for performing V2X communication by a V2X UE according to an embodiment of the disclosure.

Specifically, the sidelink resource pool of FIG. 6 may be constituted of K slots on the time axis and M resource blocks (RBs) on the frequency axis. One slot is generally composed of 14 OFDM symbols, but may not be limited thereto. In other words, one slot constituting the sidelink resource pool may be less than 14 OFDM symbols. Further, in the K slots constituting the sidelink resource pool, each slot may be composed of the same number of OFDM symbols (that is, each slot is composed of L symbols in K slots), or each slot may be constituted of a different number of OFDM symbols. Meanwhile, one resource block may be constituted of 12 subcarriers.

The K slots may be physically contiguous or logically contiguous on the time axis (if they are logically contiguous, they may be physically non-contiguous). Similarly, M resource blocks may be physically contiguous or logically contiguous on the frequency axis (if they are logically contiguous, they may be physically non-contiguous).

Although not shown in FIG. 6, the V2X transmission UE may use the sidelink resource pool of FIG. 6 to transmit sidelink control information, data information or feedback information. Further, the V2X reception UE may use the sidelink resource pool of FIG. 6 to receive sidelink control information or data information and transmit sidelink feedback information.

FIG. 7 is a view illustrating a multiplexing scheme of a sidelink control channel, a sidelink data channel, and a sidelink feedback channel in a sidelink resource pool according to an embodiment of the disclosure.

FIG. 7 illustrates that sidelink control channel (PSCCH) is multiplexed with sidelink data channel (PSSCH) on the time axis and frequency axis (i.e., time division multiplexing (TDM) and frequency division multiplexing (FDM)). In this case, PSCCH and PSSCH may be composed of different numbers of resource blocks on the frequency axis. In other words, as illustrated in FIG. 7, PSCCH may be constituted of N1 resource blocks on the frequency axis, and PSSCH may be constituted of M resource blocks. In this case, N1 may be smaller than M (N1<M). However, the case that the PSCCH and the PSSCH are composed of the same number of resource blocks (M RBs) on the frequency axis, or the case that the number of resource blocks of the PSCCH is larger than the number of resource blocks of the PSSCH (i.e., N1>M) may not be excluded.

Further, as shown in FIG. 7, the PSCCH and the PSSCH are frequency division multiplexed in K1 OFDM symbols on the time axis and, in the remaining K2 symbols, only the PSSCH may be transmitted without transmitting the PSCCH. In other words, the PSCCH may be constituted of N1 frequency blocks on the frequency axis and K1 OFDM symbols on the time axis. The PSSCH may be composed of N2 frequency blocks for the length of K1 OFDM symbols and may be frequency-divided with the PSCCH. Further, the PSSCH may be composed of M frequency blocks without frequency division with the PSCCH for the length of K2 OFDM symbols. In this case, the sum of N2 and N1 may be equal to or different from M.

FIG. 7 shows that the N1 frequency blocks constituting the PSCCH and the PSSCH constituting the (M-N2) frequency blocks are physically contiguous, but they may not be physically contiguous (that is, logically contiguous but physically non-contiguous). Meanwhile, K1 and K2 may be equal to or different from each other. When K1 and K2 are different, K1>K2 or K1<K2. The V2X transmission UE may include time/frequency allocation information about the PSSCH in sidelink control information transmitted through the PSCCH and transmit it. After receiving and decoding the PSCCH, the V2X reception UE may obtain time/frequency allocation information about the PSSCH and decode the PSSCH. Although FIG. 7 shows that the PSSCH constituting the K2 symbols is physically continuously positioned after the K1 symbols constituting the PSCCH, they may not be physically contiguous (that is, they may be logically contiguous but physically non-contiguous).

FIG. 7 illustrates a case in which a sidelink feedback channel (PSFCH) exists in a sidelink resource composed of K OFDM symbols. In this case, one slot may be constituted of PSCCH K1 symbol, PSSCH K2 symbol (when considering only symbols not FDMed with PSCCH. If considering FDM with PSCCH, PSSCH is K1+K2 symbols), guard symbol (GAP), PSFCH K3 symbol, and guard symbol GAP. In other words, K1+K2+guard symbol 1+K3+guard symbol 2=K. In this case, guard symbol 1 and guard symbol 2 may be one or two or more OFDM symbols. Guard symbol 1 may be required for conversion between transmission and reception for the V2X transmission UE to transmit the PSCCH and PSSCH and receive the PSFCH.

Conversely, from the perspective of the V2X reception UE, guard symbol 1 may be required for conversion between reception and transmission for the V2X reception UE to receive the PSCCH and PSSCH and transmit the PSFCH. Similarly, guard symbol 2 may be required for conversion between reception and transmission for the V2X transmission UE to receive the PSFCH from the V2X reception UE and transmit the PSCCH and PSSCH in the next sidelink resource. Conversely, from the perspective of the V2X reception UE, guard symbol 2 may be required for conversion between transmission and reception for the V2X reception UE to transmit the PSFCH to the V2X transmission UE and to receive the PSCCH and PSSCH in the next sidelink resource.

Meanwhile, although not shown in FIG. 7, the number of symbols in one of guard symbol 1 and guard symbol 2 may be 0. For example, when the V2X transmission UE receives PSFCH and receives the PSCCH and PSSCH from another UE in the next sidelink resource, conversion between reception and transmission is not required so that the number of guard symbols 2 may be 0. Further, the case where at least one of K1, K2, and K3 is 0 may not be excluded.

Although the frequency resource block size of PSFCH is shown as being the same as that of PSSCH in FIG. 7 (i.e., M RBs), the resource block size of PSFCH on the frequency axis may be the same as or different from the resource block size of PSCCH and PSSCH. After decoding the PSSCH, the V2X reception UE may include the success result (i.e., ACK/NACK information) in the PSFCH and transmit it to the V2X transmission UE.

In the above-described examples, the time and frequency resources of the PSFCH transmitted by one V2X UE may be defined as K3 OFDM symbols and M resource blocks, respectively. In this case, all the V2X UEs may use the same K3 value and M value regardless of the location of the UE (in coverage, out of coverage, or partial coverage of the base station). As another example, at least one of K3 and M may be set by the base station or V2X UE. More specifically, the base station may transmit information about the sidelink resource pool to V2X UEs present in its cell through system information (SIB) or RRC configuration. In this case, information about the resource pool may include at least one of K3 and M. As another example, when V2X transmission/reception UE pairs performing unicast or groupcast communication exchange AS layer parameters through PC-5 RRC configuration as mentioned in FIG. 3, at least one of K3 and M may be configured. As another example, at least one of K3 and M may be a preset value.

When the PSFCH uses two or more formats (e.g., one PSFCH format is used to transmit sidelink feedback information of 2 bits or less, and another PSFCH format is used to transmit sidelink feedback information including more than 2 bits), at least one PSFCH format may use a fixed value for at least one of K3 and M.

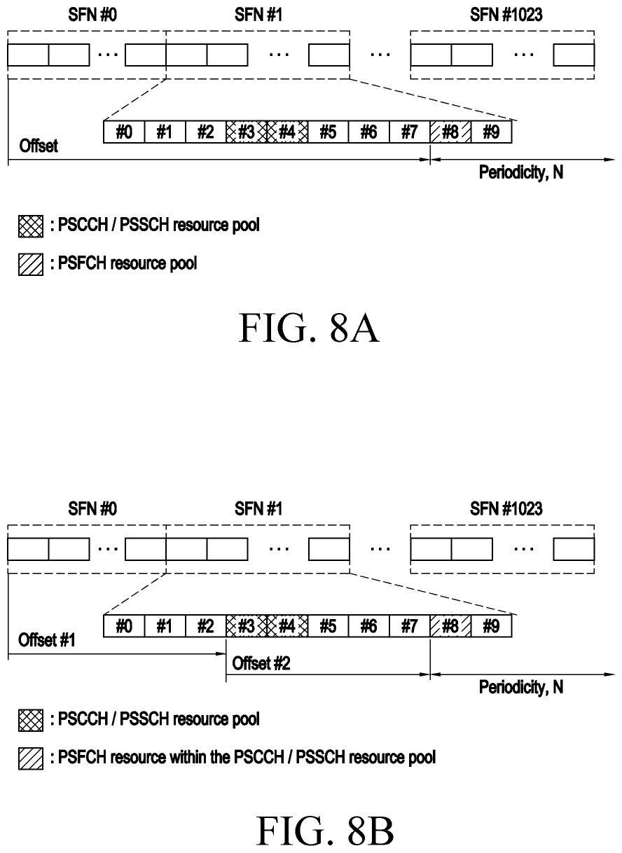

FIGS. 8A and 8B are views illustrating an example of a time axis resource allocation of a sidelink feedback channel according to an embodiment of the disclosure.

Resource allocation on the time axis of the PSFCH may mean the start point of the resource where the PSFCH may be transmitted and the period when there is the resource where the PSFCH may be transmitted. Specifically, the start point of the resource where the PSFCH may be transmitted may include the index of the slot where the PSFCH may be transmitted or the index of the slot where the PSFCH may be transmitted and the symbol index in the corresponding slot.

FIG. 8A illustrates a method for allocating a resource pool of PSFCH and illustrates a case where the resource pool of PSFCH is allocated independently from the configuration of the resource pool where PDCCH and PSSCH are transmitted. In other words, it is illustrated that the PSFCH resource starts from slot index 8 of system frame ‘1’ with respect to system frame number (SFN) ‘0’, and such PSFCH time axis resource is repeated with period N. The V2X reception UE may transmit HARQ-ACK/NACK information to the V2X transmission UE through the PSFCH in the slot where the PSFCH is present, based on such information.

When there is no base station (i.e., when the V2X reception UE is present out of the coverage of the base station), the start point of the resource pool where PSFCH may be transmitted may be set with respect to direct frame number (DFN) 0.

The aforementioned PSFCH time axis resource allocation method may be seen as described in terms of the system. In other words, in the V2X system, the start slot and period of PSFCH resource pool may be set, which may not mean that one V2X reception UE should always use the corresponding resource. As an example, in terms of the system, the PSFCH resource pool may start from slot ‘8’ in system frame ‘1’ and the period may have N slots as shown in FIG. 8A. A specific V2X reception UE may use the PSFCH resource only when it should transmit PSFCH of the PSFCH resource pool configured in terms of the system. For example, the time when the V2X reception UE should transmit PSFCH may be K slots after the V2X reception UE receives PSCCH and PSSCH from the V2X transmission UE. The timing relationship ‘K’ between PSCCH/PSSCH and PSFCH may be configured per PSFCH resource pool. ‘K’ may differ per PSFCH resource pool or may be the same in the entire PSFCH resource pool.

In terms of the system, PSFCH resource pool period N may be set to 1 or an integer larger than 1. According to the mentioned relationship between N and K (i.e., N=K, N<K, or N>K), the resource of the PSFCH that should be transmitted by a specific V2X reception UE may not be present in the corresponding slot. For example, when N is assumed to be 4 in FIG. 8A, the PSFCH time axis resource may be present every four slots in terms of the system. In other words, the PSFCH time axis resource may be present in slot 2 and slot 6 of system frame 2, slot 0, slot 4, and slot 8 of system frame 3 with respect to slot 8 of system frame 1. In this case, when it is assumed that K=4 (i.e., PSFCH is transmitted four slots after the V2X reception UE receives PSCCH/PSSCH from the V2X transmission UE), and the V2X reception UE receives PSCCH/PSSCH in slot 9 of system frame 1 from the V2X transmission UE, the V2X reception UE should transmit HARQ-ACK/NACK information through the PSFCH in slot 3 of system frame 2. However, since the corresponding slot has no PSFCH resource, the V2X reception UE may not transmit PSFCH. In such a case, the V2X reception UE may transmit PSFCH in the PSFCH slot present earliest with respect to the slot where it should transmit PSFCH. In other words, in the above-described example, the V2X reception UE may transmit HARQ-ACK/NACK information through the PSFCH in slot 6 of system frame 2.

FIG. 8B is a view illustrating another example of a time axis resource allocation of a sidelink feedback channel according to an embodiment of the disclosure.

FIG. 8A illustrates a case where PSFCH resource pool is allocated independently from configuration of the resource pool for transmitting PSCCH and PSSCH. Unlike FIG. 8A, FIG. 8B illustrates a method in which PSFCH resource pool is configured in the resource pool where PSCCH and PSSCH are transmitted. In other words, the resource of PSCCH and PSSCH may start from slot index 3 of system frame ‘1’ with respect to system frame number ‘0’. The start point may be known as offset 1. Since PSFCH is present in the resource pool of PSCCH and PSSCH, the start point of PSFCH may be known through offset 2 with respect to the time when PSCCH/PSSCH starts. In other words, it may be known that the PSFCH resource starts in slot index ‘8’ which is 5 slots after slot index 3 of system frame ‘1’. FIG. 8B illustrates that the PSFCH time axis resource is repeated with period N. The V2X reception UE may transmit HARQ-ACK/NACK information to the V2X transmission UE through the PSFCH in the slot where the PSFCH is present, based on such information.

The aforementioned PSFCH time axis resource allocation method may be seen as described in terms of the system. Accordingly, as described in connection with FIG. 8A, in terms of the system, the PSFCH resource may not be present in the slot where a specific V2X reception UE should transmit PSFCH. In such a case, the V2X reception UE may transmit PSFCH in the PSFCH slot present earliest with respect to the slot where it should transmit PSFCH as described in connection with FIG. 8A.

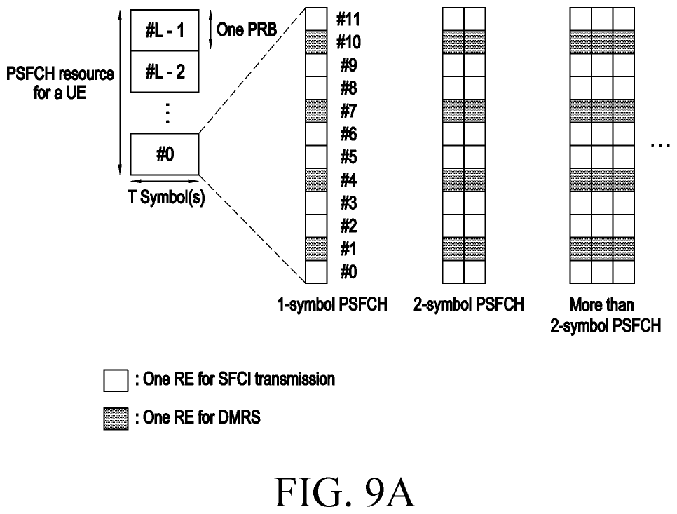

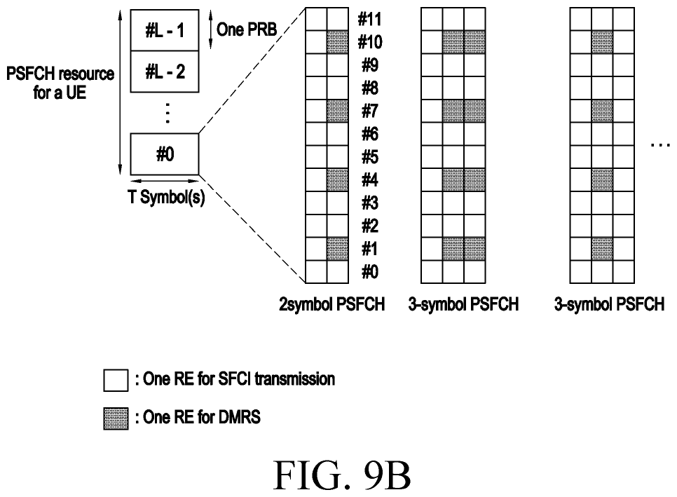

FIGS. 9A and 9B are views illustrating an example of a resource structure of a sidelink feedback channel according to an embodiment of the disclosure.

Referring to FIGS. 9A and 9B, the sidelink feedback channel (PSFCH) resource structure of FIGS. 9A and 9B may mean the resource structure of PSFCH which the V2X reception UE transmits to the V2X transmission UE in the unicast communication procedure shown in FIGS. 4 and 5. Further, the PSFCH resource structure of FIGS. 9A and 9B may mean the resource structure of PSFCH used in the case (Option 2) where the V2X reception UEs in the group each transmit HARQ ACK information and NACK information to the V2X transmission UE in groupcast communication as described in connection with FIG. 4. Further, the PSFCH resource structure of FIGS. 9A and 9B may mean the resource structure of PSFCH used in the case (Option 1) where a plurality of V2X reception UEs in the group transmit only NACK information to the V2X transmission UE in groupcast communication as described in connection with FIG. 4.

In the above-described unicast and groupcast communication, each V2X reception UE may transmit sidelink feedback control information (SFCI) to the V2X transmission UE using the PSFCH resource structure of FIGS. 9A and 9B. In this case, the PSFCH that one V2X reception UE uses to transmit SFCI may be constituted of T symbols on the time axis and L frequency blocks (resource blocks (RBs)) on the frequency axis as shown in FIG. 9A or 9B. T and L may include 1 and, when T=L=1, each V2X reception UE may transmit PSFCH connected to one orthogonal frequency division multiplexing (OFDM) symbol and one RB on the time axis to the V2X transmission UE. In this case, one RB may be constituted of 12 subcarriers or 12 reference elements (REs). Further, when L>1 in FIGS. 9A and 9B, one PSFCH resource composed of L RBs may be regarded as one PSFCH subchannel. In this case, the number of PSFCH subchannels that one V2X reception UE may use for SFCI transmission may be [x]. In this case, the value of [x] may be 1 or a value larger than 1 and be configured through RRC from the base station or configured through PC-5 RRC (or [x] value may be set in advance). Information on the above-described [x] value may be included in sidelink resource pool configuration information.

In FIGS. 9A and 9B, the DMRS overhead is assumed to be, e.g., 1/3 (i.e., 4 reference elements (REs) of 12 REs are used as the DMRS), but is not limited thereto. For example, if the DMRS overhead is 1/4, that is, 3 REs of 12 resource elements (REs) are used as the DMRS, and the DMRS may be mapped to RE indexes 1, 5, and 9 (or 2, 6, and 10), and the SFCI may be mapped to the remaining RE indexes. Although FIGS. 9A and 9B illustrate the PSFCH structure for on RB constituted of 12 REs, it may be likewise applied to the PSFCH constituted of two or more RBs. In other words, when two RBs are assumed to be the size of the PSFCH frequency resource transmitted by the V2X reception UE, the DMRS may be mapped to RE indexes 1, 4, 7, 10, 13, 16, 19, and 22, and the SFCI may be mapped to the remaining RE indexes. According to this principle, a PSFCH structure composed of RBs larger than 2 (L>2) may be extended and determined.

Meanwhile, when the PSFCH transmitted by one V2X reception UE is composed of two or more OFDM symbols on the time axis, the PSFCH composed of one OFDM symbol may be repeated. In other words, as shown in FIG. 9A, a PSFCH composed of two or more OFDM symbols is a repetitive structure of a PSFCH composed of one OFDM symbol, and a DMRS may exist in an RE in the same location in each OFDM symbol. Meanwhile, although not shown in FIG. 9A, in a PSFCH composed of two or more OFDM symbols, the location of the RE in which a DMRS exists may be different for each OFDM symbol. This may be intended for reducing DMRS overhead. For example, DMRS may exist only in odd-numbered OFDM symbols and may not exist in even-numbered OFDM symbols. Alternatively, DMRS may exist only in even-numbered OFDM symbols and may not exist in odd-numbered OFDM symbols.

As another example, although FIG. 9A illustrates that the DMRS exists in the same RE on the frequency axis even when the number of OFDM symbols increases, the location of the DMRS may be different for each OFDM symbol. For example, DMRS positions in the first OFDM symbol and the second OFDM symbol may be different. In other words, in comparison with the PSFCH structure composed of two OFDM symbols of FIG. 9A, in the first OFDM symbol, the DMRS may be positioned at RE indexes 0 and 7 and, in the second OFDM symbol, DMRS may be positioned at RE indexes 3 and 11. Alternatively, DMRS positions in even-numbered OFDM symbols and odd-numbered OFDM symbols may be different, but DMRS positions in even-numbered OFDM symbols may be the same (i.e., the DMRS positions in the second and fourth OFDM symbols may be the same), and the DMRS positions in odd-numbered OFDM symbols may be the same (i.e., the DMRS positions in the first and third OFDM symbols are the same). This may be generalized as meaning that the positions of DMRS REs may be the same in at least two or more OFDM symbols.

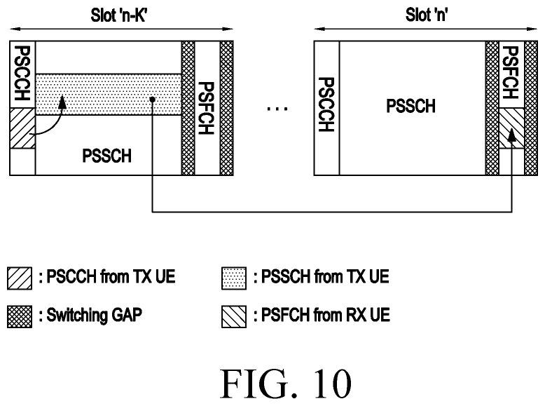

Although not shown in FIG. 9A, SFCI information may be mapped to all the REs of the PSFCH without DMRS in FIG. 9A. In this case, there may be a disadvantage that channel estimation cannot be performed because there is no DMRS. However, when SFCI information is transmitted based on a sequence, the receiving end may receive SFCI without channel estimation. Thus, it is possible to enhance the reception performance of PSFCH by increasing the sequence length for SFCI transmission and reducing DMRS overhead. A specific example of the sequence-based SFCI transmission method is described in detail with reference to FIG. 10.

FIG. 9B is a view illustrating another example of a resource structure of a sidelink feedback channel according to an embodiment of the disclosure.

Referring to FIG. 9B, FIG. 9B illustrates another example of the PSFCH resource structure which is a structure assisting the receiver of the transmission UE receiving PSFCH in configuring automatic gain control (AGC). More specifically, the receiver of the transmission UE should set an AGC range to receive PSFCH. In this case, the reception UE transmitting PSFCH may be located adjacent to the transmission UE receiving PSFCH or may be located far away. For example, it may be assumed that UE-A is located adjacent to the transmission UE receiving PSFCH, and UE-B is located far away from the transmission UE receiving PSFCH. In this case, the PSFCH transmitted by UE-A may be received by the transmission UE in high reception power, and the PSFCH transmitted by UE-B may be received by the transmission UE in low reception power. When the transmission UE receiving PSFCH configures AGC according to the PSFCH of UE-A, the PSFCH transmitted by UE-A may be quantized at wide intervals. In such a case, the PSFCH transmitted by UE-B has a low reception signal level and may thus be properly expressed as the above-described quantized value. Therefore, the PSFCH transmitted by UE-B may not properly be received. Similarly, when the transmission UE receiving PSFCH configures AGC according to the PSFCH of UE-B, the PSFCH transmitted by UE-B has a low reception signal, so that the PSFCH reception signal transmitted by UE-A falls outside the AGC range, and resultantly, the reception signal of the PSFCH transmitted by UE-A may be distorted. Accordingly, the PSFCH transmitted by UE-A may not properly be received. To address the issues, the receiver of the transmission UE needs to set an AGC range with a sufficient time to secure many samples upon receiving the PSFCH.

To perform such AGC range setting, as shown in FIG. 9B, DMRS is not mapped, but SFCI information may be mapped to the first symbol. More specifically, as shown in FIG. 9A, when DMRS is mapped to the first symbol, and the first symbol is used for AGC range setting, channel estimation performance using DMRS may be deteriorated. Accordingly, when the first symbol is used for AGC range setting, DMRS may not be mapped to the first symbol as shown in FIG. 9B. As another example, rather than SFCI information being mapped to the first symbol, a sequence for assisting the transmission UE receiving PSFCH in performing AGC configuration may be transmitted. In other words, a preamble for AGC training may be transmitted in the first symbol of PSFCH. Except that no DMRS is mapped to the first symbol, the position of the DMRS mapped to the remaining symbols may follow one of the methods exemplified in FIG. 9A. For example, the position of the RE where DMRS is present in each OFDM symbol may be the same or different.

As another example, the AGC preamble may be transmitted in the first symbol of FIG. 9B, and only SF CI, without DMRS, may be transmitted in the second symbol. In such a case, SFCI may be transmitted in a sequence form. As an example, assuming HARQ ACK transmission constituted of one bit, sequence-A may be used for ACK information transmission, and sequence-B may be used for NACK information transmission. Such sequence-based transmission need not use channel estimation for demodulation and decoding, the above-described feedback channel resource structure may be possible. A sequence-based SFCI transmission method is described in detail with reference to FIG. 10.

FIG. 10 is a view illustrating an example of a frequency resource allocation of a sidelink feedback channel according to an embodiment of the disclosure.

As shown in FIG. 10, the V2X transmission UE may transmit PSCCH and PSSCH in slot n−K. The V2X reception UE may decode PSCCH to obtain sidelink control information and obtain information about time/frequency/code resources of PSSCH therefrom. FIG. 10 illustrates that PSCCH and PSSCH are transmitted in the same slot, but is not limited thereto. In other words, PSCCH is transmitted in slot n−K, but PSSCH may be transmitted in a subsequent slot. In such a case, the time relationship between PSCCH and PSSCH may be fixed (e.g., PSSCH is transmitted 4 ms after PSCCH reception), or be configured by the base station. As another example, the V2X transmission UE may indicate the time relationship between PSCCH and PSSCH in the sidelink control information that it transmits. The V2X reception UE, obtaining the sidelink control information, may decode the PSSCH through information about frequency/code resources of PSSCH and the time relationship between PSCCH and PSSCH.

The V2X reception UE may receive PSCCH and PSSCH transmitted from the V2X transmission UE, perform decoding, and then feed back information about whether PSSCH decoding succeeds (i.e., HARQ-ACK/NACK) to the V2X transmission UE through PSFCH. Therefore, the V2X reception UE needs to know information about the frequency and time resource of PSFCH for transmitting HARQ-ACK and HARQ-NACK information. Further, for the V2X transmission UE to receive PSFCH from the V2X reception UE, the V2X transmission UE needs to know information about frequency and time resource of PSFCH transmitted from the reception UE.

There may be various methods for allocating frequency resources of PSFCH depending on the entity of allocating resources or how to design signaling for resource allocation.

As an example for the entity to allocate resources, the V2X reception UE itself may select resources of PSFCH to transmit. More specifically, the base station may configure a PSFCH resource pool to the V2X reception UEs in the cell through system information and RRC configuration. When there is no base station (i.e., out-of-coverage), the PSFCH resource pool may be pre-configured. The V2X reception UEs may directly select the PSFCH resources that each is to transmit in the PSFCH resource pool configured or pre-configured from the base station. As an example, the V2X reception UE may select PSFCH resources through sensing operation. However, this method may transmit PSFCH only when sensing succeeds and may thus delay HARQ operation and may thus be undesirable. In this case, the sensing operation may mean an operation of decoding sidelink control information transmitted on the sidelink control channel or decoding sidelink control information and measuring the reference signal received power (RSRP) through the demodulation reference signal (DMRS) transmitted on sidelink data channel.

As another example for the entity to allocate resources, the base station may directly allocate frequency resources of PSFCH through DCI to V2X reception UEs to transmit PSFCH. Or, the base station may configure a set of frequency resources of PSFCH, which may be used by each V2X reception UE, through RRC and indicate which frequency resource in the set of frequency resources should be used through DCI. This method may apply only when the V2X reception UEs are in the RRC connected state with the base station. Accordingly, the V2X reception UEs in the RRC connection released state should perform random access for RRC connection setup with the base station, causing an increase in signaling overhead. Further, this method may not be used when the V2X reception UE is out of coverage.

As another example for the entity to allocate resources, the base station may directly allocate frequency resources of PSFCH to V2X transmission UEs to receive PSFCH (i.e., V2X transmission UEs transmitting PSCCH and PSSCH) through DCI. Or, the base station may configure a set of frequency resources of PSFCH, which may be used by each V2X transmission UE, through RRC and indicate which frequency resource in the set of frequency resources should be used through DCI. This method may be used in mode 1 resource allocation method described in connection with FIG. 2. However, in the case of mode 1 resource allocation method, the base station may transmit the frequency resource allocation information of PSCCH and PSSCH to the V2X transmission UE through DCI. Accordingly, when the PSFCH frequency resource allocation information is included in the DCI, the amount of resource allocation information transmitted through DCI may increase. Further, this method may be applicable only to mode 1 resource allocation method as mentioned above but not to mode 2 resource allocation method.

To address the issues, in FIG. 10, a correlation between the frequency resource of PSSCH transmitted by the V2X transmission UE (i.e., received by the V2X reception UE) and the frequency resource of PSFCH transmitted by the V2X reception UE (i.e., received by the V2X transmission UE) needs to be introduced, and at least one of the following methods may be used.

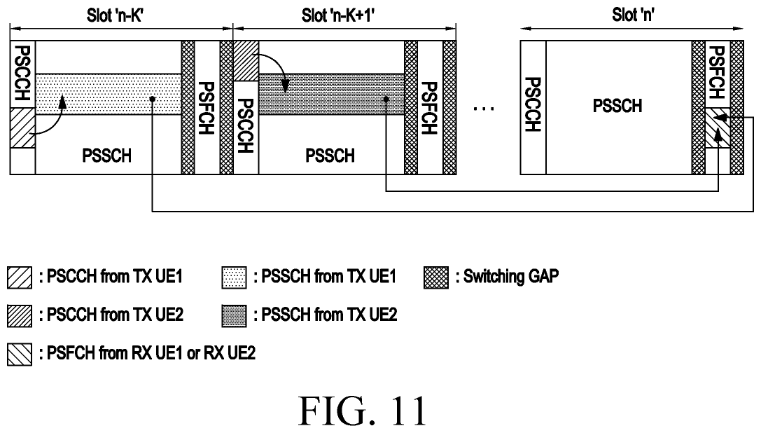

Method 1) The start PRB index of PSSCH transmitted in slot n−K by the V2X transmission UE may have a correlation with the start PRB index of PSFCH transmitted in slot n by the V2X reception UE. These methods are described below in detail in the example of FIGS. 11, 12, 13, 14, and 15.

For example, when the start PRB index of PSSCH in slot n−K is M, the start PRB index of PSFCH in slot n may be the same M. As another example, when the start PRB index of PSSCH in slot n−K is M, the PSFCH in slot n may start at M+offset (or M−offset). In this case, the unit of the offset may be the PRB and be a fixed value identically used by all the V2X UEs or a value set to differ per resource pool. For example, in resource pool 1, 10 may be used as the offset value and, in resource pool 2, 20 may be used as the offset value. In this case, K may be a value equal to or larger than 0.

Similar to the example, the last PRB index of PSSCH transmitted in slot n−K by the V2X transmission UE may have a correlation with the start PRB index of PSFCH transmitted in slot n by the V2X reception UE.

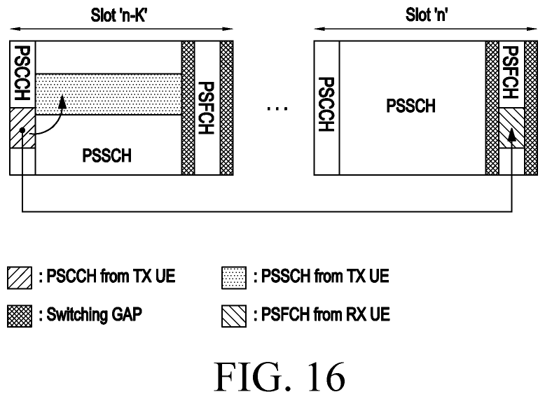

Method 2) The start PRB index of PSCCH transmitted in slot n−K by the V2X transmission UE may have a correlation with the start PRB index of PSFCH transmitted in slot n by the V2X reception UE. Method 2 is described in detail with reference to FIGS. 16, 17, 18, and 19.

Method 2 is similar to method 1 but, unlike method 2, may mean that the start PRB index of PSFCH does not have a correlation with PSSCH but has a correlation with PSCCH.—For example, when the start PRB index of PSSCH in slot n−K is M, the start PRB index of PSFCH in slot n may be the same M. As another example, when the start PRB index of PSSCH in slot n−K is M, the PSFCH in slot n may start at M+offset (or M−offset). In this case, the unit of the offset may be the PRB and be a fixed value identically used by all the V2X UEs or a value set to differ per resource pool. For example, in resource pool 1, 10 may be used as the offset value and, in resource pool 2, 20 may be used as the offset value. In this case, K may be a value equal to or larger than 0.

Method 3) Unlike methods 1 and 2, the start PRB of PSFCH has no correlation with PSSCH or PSCCH.

For example, the V2X transmission UE may transmit the start PRB index of PSFCH to the V2X reception UE through sidelink control information. This information may be a value configured or indicated to the V2X transmission UE from the base station. In other words, the start PRB index of PSFCH may be transferred to the V2X transmission UE through system information or RRC configuration or indicated via DCI. The V2X transmission UE receiving it may transmit the corresponding information to the V2X reception UE through sidelink control information. In this case, the number of PRBs constituting PSFCH may always use a fixed value. Or, the number of PRBs, along with the start PRB index of PSFCH, may also be transferred from the base station through DCI and be included in the sidelink control information and transmitted to the V2X reception UE.

As another example, the start PRB index (or last PRB index) of PSFCH may be inferred by the V2X reception UE through the destination ID or source ID transmitted through PSCCH or PSSCH. The V2X transmission UE may transfer information about the number of PRBs constituting PSFCH to the V2X reception UE through SCI. Or, the number of PRBs constituting PSFCH may always use a fixed value.

As another example, the base station may transfer a set of start PRB indexes of PSFCH to the V2X transmission UE through system information or RRC configuration, and the V2X transmission UE receiving it may select one from among the values included in the set and transmit it to the V2X reception UE through sidelink control information.

As mentioned in the examples, the PSFCH frequency resource may need information about how many resource blocks PSFCH is constituted of, as well as information about the start PRB of frequency. The information about how many resource blocks PSFCH is constituted of may use at least one of the following methods, as well as the above-described methods.

PSFCH format 1 may transmit HARQ-ACK or HARQ-NACK information constituted of one bit or two bits. When transmitting one-bit HARQ-ACK/NACK information, sequence 1 may mean HARQ-ACK information, and sequence 2 may mean HARQ-NACK information. When transmitting two-bit HARQ-ACK/NACK information, four sequences may be used. Sequence 1 may mean (ACK, ACK), sequence 2 (ACK, NACK), sequence 3 (NACK, NACK), and sequence 4 (NACK, ACK). Accordingly, PSFCH format 1 may be referred to as using sequence-based transmission. Unlike this, there may be the case of transmitting HARQ-ACK/NACK information of two or more bits. In this case, channel coding may be used, and such format may be named PSFCH format 2. For convenience of description, two PSFCH formats have been exemplified. However, there may be more PSFCH formats depending on the type of sidelink feedback information transmitted through PSFCH and the bit size of sidelink feedback information transmitted through PSFCH.

The same number of PRBs may be used regardless of the exemplified PSFCH format. In this case, the PRB value is a fixed value previously known to all the V2X UEs. As another example, a different fixed value may be used depending on the exemplified PSFCH format. In other words, PSFCH format 1 may use one PRB, and PSFCH format 2 may use four PRBs.

As another example, the number of PRBs used for PSFCH may be set to a different value by the base station or preset to a different value. For example, the base station may include the presence or absence of PSFCH in the resource pool configuration information and, when PSFCH is present in the corresponding resource pool, information about how many PRBs the PSFCH is constituted of may be included.

The HARQ-ACK/NACK information transmitted by one V2X reception UE in groupcast or unicast communication may be transmitted through one PSFCH resource or through two PSFCH resources. When transmitted through one PSFCH, the above-described methods may apply. However, when transmitted through two PSFCH resources (i.e., one PSFCH resource is used for HARQ-ACK transmission, and the other PSFCH resource is used for HARQ-NACK transmission), a method for indicating the start points of the two PSFCH resources may be required.

When the two PSFCH resources are contiguously present, the start PRB index of the first PSFCH resource may be derived from the start PRB index of PSSCH as described above. In other words, the start PRB index of the first PSFCH resource may be M or M+offset (or M−offset) in an example. Further, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be M+[X1] or M+offset+[X1] (or M−offset−[X1]). In this case, [X1] may use a fixed value or be set from the base station or V2X transmission UE.

When the two PSFCH resources are not contiguous, the start PRB index of the first PSFCH resource may be derived from the start PRB index of PSSCH, and the start PRB index of the second PSFCH resource may be set through a separate offset as described above. For example, the start PRB index of the first PSFCH resource may be M or M+offset1 (or M−offset1) in an example. The start PRB index of the second PSFCH resource may be M+offset2 or M+offset1+offset2 (or M−offset1−offset2). In this case, offset1 may mean the difference between the start PRB index of PSSCH and the start PRB index of PSFCH, and offset2 may mean the difference between the start PRB index of the first PSFCH resource and the start PRB index of the second PSFCH resource.

As another example, the start PRB index of the second PSFCH resource may be M+[X1]+offset2 or M+offset1+[X1]+offset2 (or M−offset1−[X1]−offset2). In this case, [X1] means the number of PRBs constituting the first PSFCH resource, and [X1] may use a fixed value or be set from the base station or V2X transmission UE. Further, in the example, offset1 may mean the difference between the start PRB index of PSSCH and the start PRB index of PSFCH. Further, offset2 may mean the difference between the start PRB index of the first PSFCH resource and the start PRB index of the second PSFCH resource.

FIG. 11 is a view illustrating another example of a frequency resource allocation of a sidelink feedback channel according to an embodiment of the disclosure.

FIG. 11 illustrates a case in which the start PRB indexes of PSSCH transmitted by different V2X transmission UEs are the same. In other words, it is the case where the start PRB index of PSSCH transmitted by V2X transmission UE 1 to V2X reception UE 1 in slot n−K is the same as the start PRB index of PSSCH transmitted by V2X transmission UE 2 to V2X reception UE 2 in slot n−K+1. Since the PSSCHs transmitted in different slots use the same start PRB index, if the methods described in connection with FIG. 10 apply as they are, the start PRB indexes of PSFCH are identical, so that collision may occur between the PSFCHs. This issue may arise not only when different V2X transmission UEs transmit PSSCH to different V2X reception UEs btu also when different V2X transmission UEs transmit PSSCH to the same V2X reception UE as in the example shown in FIG. 11 (i.e., when PSCCH/PSSCH transmitted by V2X transmission UE 1 and PSCCH/PSSCH transmitted by V2X transmission UE 2 are transmitted to V2X transmission UE 1). One of the following methods may be used to address such PSFCH collision issue.

Method 1) The start PRB index of PSSCH and V2X UE ID indicate the start PRB index of PSFCH

V2X UE ID may mean destination ID or source ID or both destination ID and source ID. [X1] bits of the destination ID constituted of [X] bits may be transmitted through the PSCCH, and the remaining [X2] bits may be included in the MAC PDU transmitted through the PSSCH ([X]=[X1]+[X2]). The [Y1] bits of the source ID composed of [Y] bits may be transmitted through the PSCCH, and the remaining [Y2] bits may be included in the MAC PDU transmitted through the PSSCH ([Y]=[Y1]+[Y2]). In the example, [X2] and [Y2] may be 0 bits. This may mean that the destination ID and source ID are transmitted only through the PSCCH. Further, in the example, [X1] and [Y1] may be 0 bits. This may mean that the destination ID and source ID are transmitted only through the PSSCH.

The V2X reception UE may decode the PSCCHs transmitted from different V2X transmission UEs in different slots and obtain some of V2X UE ID information (when the bits of the destination ID and the source ID are split and transmitted in the MAC PDUs of the PSCCH and PSSCH) or all (when the bits of the destination ID or source ID are transmitted only through the PSCCH). Further, the V2X reception UE, succeeding in decoding of the PSCCH, may obtain information about the frequency resources of PSSCH and obtain some of the V2X UE ID information (when the bits of the destination ID or source ID are split and transmitted in the MAC PDUs of the PSCCH and PSSCH) or all (when the bits of the destination ID or source ID are transmitted only through the PSSCH).

The destination ID is an ID for identifying the reception UE of the PSSCH transmitted by the V2X transmission UE. The source ID is an ID for identifying the transmission UE of the PSSCH transmitted by the V2X transmission UE. The method may be subdivided into the following methods depending on whether the source ID is used or the destination ID is used to identify the start PRB index of PSFCH.

Method 1-1) Using source ID

Since different V2X transmission UEs may transmit different PSSCHs to the same V2X reception UE, if an offset is given to the start PRB indexes of PSSCHs transmitted in different slots through the destination ID, the PSFCH collision issue still remains as the same destination ID is used. Accordingly, an offset may be given to the start PRB index of PSFCH using the source ID.

More specifically, as shown in FIG. 11, PSCCH-1 or PSSCH-1 transmitted by V2X transmission UE 1 in slot n−K has source ID 1. PSCCH-2 or PSSCH-2 transmitted by transmission UE 2 in slot n−K+1 has source ID 2. Even when PSCCH-1 and PSSCH-2 have the same start PRB index, the start PRB index of PSFCH transmitted in slot n may differ as different source IDs are used. In other words, the different source IDs may give different offsets to the start PRB indexes of the PSFCHs.

In this case, the relationship between the source ID and the offset of the start PRB index of PSFCH may be preset or be set from the base station or the UE's higher layer. As another example, the source ID may be converted into a decimal number and be interpreted as an offset. More specifically, it may be assumed that the source ID is composed of 4 bits and that source ID 1=0011 and source ID 2=1011. In this case, when source ID 1 is converted into a decimal number, it may be expressed as source ID 1=3 and source ID 2=11. Therefore, the PSFCH corresponding to PSSCH-1 transmitted by V2X transmission UE 1 may have offset 3, and the PSFCH corresponding to PSSCH-2 transmitted by V2X transmission UE 2 may have offset 11. For convenience of description, it is exemplified that the source ID is composed of 4 bits, but the number of bits of the source ID may be larger (e.g., 24 bits). In this case, since the offset value becomes very large, it may deviate from the index range of frequency resources in the corresponding resource pool. In this case, a modulo operation may be performed. Further, in the example, all the bits constituting the source ID are converted to a decimal number to express the offset value, but some bits of the source ID (e.g., MSB [K1] bits or LSB [K1] bits) may be converted to a decimal number and interpreted as an offset.

Method 1-2) Using destination ID

One V2X transmission UE may transmit PSSCH to different V2X reception UEs in different slots. In this case, since the source IDs are the same but the destination IDs may be different, the PSFCH collision issue may still occur when the start PRB index of the PSFCH is determined using the source ID. Therefore, an offset may be given to the start PRB index of the PSFCH according to the destination ID. The methods exemplified in the case of using the source ID may be used.

Method 2) The start PRB index of PSSCH and the index of the slot where PSSCH is transmitted indicate the start PRB index of PSFCH

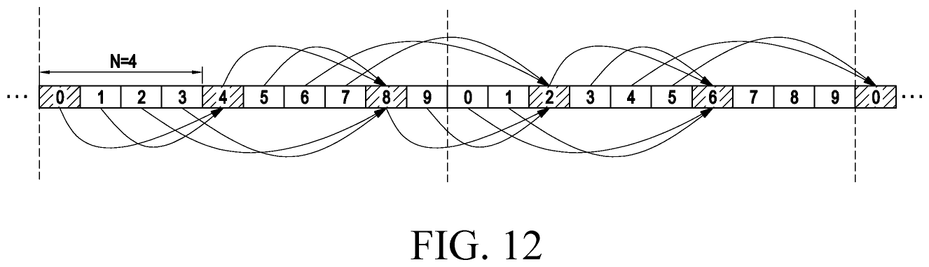

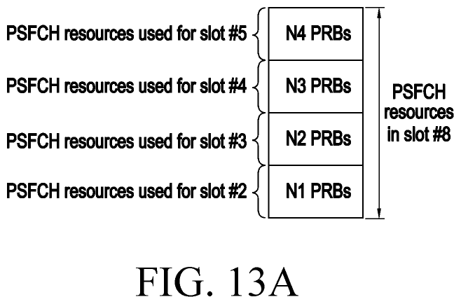

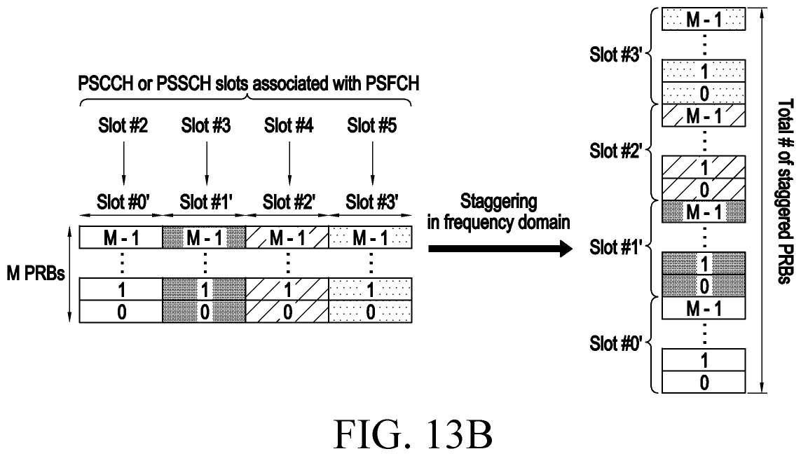

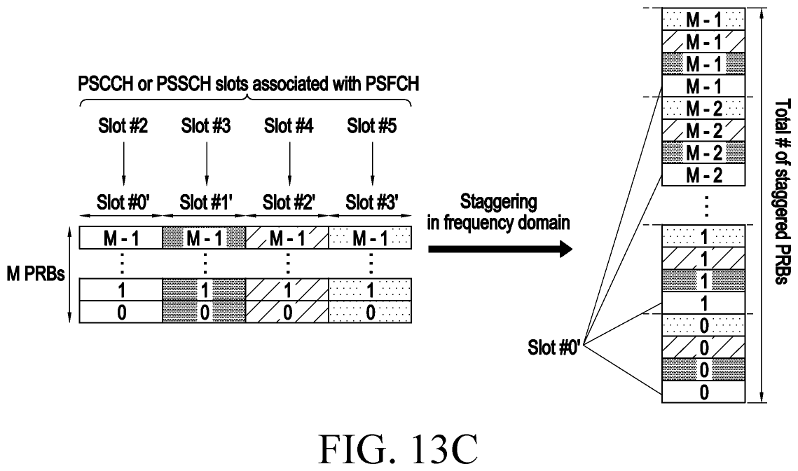

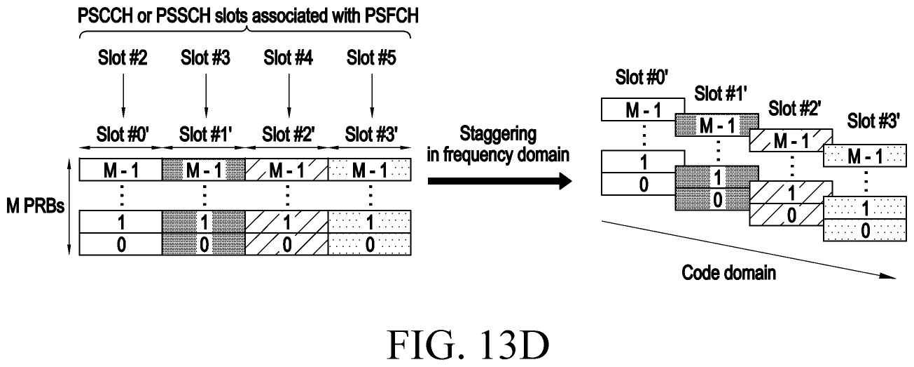

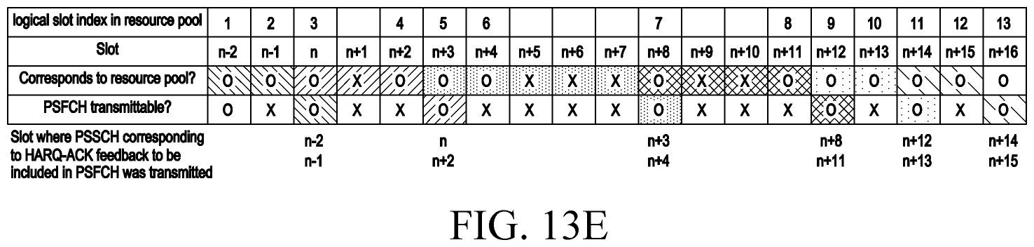

As shown in FIG. 13A, the frequency resources of the PSFCH may be grouped into frequency resources usable in each slot. In other words, the case where HARQ-ACK/NACK information may be transmitted in slot 8 in FIG. 12 is the case where the V2X reception UE receives PSSCH in slot 2 (slot #2), slot 3 (slot #3), slot 4 (slot #4), and slot 5 (slot #5). Accordingly, it may be determined how many groups the frequency resources should be divided into in the slot where PSFCH may be transmitted depending on K and N or one of the two values (in FIG. 12, it is assumed that K=3, and N=4, and in FIG. 13A, the PSFCH frequency resources are divided into four groups). As shown in FIG. 13A, the PSFCH frequency resources (i.e., the number of PRBs constituting the PSFCH) that each group may use may be the same or different. The start PRB index of the PSFCH may be determined through such grouping and the correlation with the start PRB index of the PSSCH exemplified in FIG. 8. Thus, even when different PSSCHs are transmitted using the same start PRB index in different slots, the PSFCH collision issue may be addressed because the start PRB index of the PSFCH may be set to differ.

FIG. 12 is a view illustrating another example of a time axis resource allocation of a sidelink feedback channel according to an embodiment of the disclosure.

In the example of FIG. 12, the time axis resource of the PSFCH starts from slot 0 and has a period of 4 slots (N=4). Accordingly, time axis resources of the PSFCH may exist in slot 0, slot 4, slot 8, slot 2, and slot 6. Further, in FIG. 12, it is assumed that the time relationship between the PSSCH transmitted by the V2X transmission UE (i.e., the PSSCH received by the V2X reception UE) and the PSFCH to be transmitted by the V2X reception UE, K, is 3 slots. In other words, the V2X reception UE may not decode the PSSCH transmitted from the V2X transmission UE within a shorter time than three slots and prepare for HARQ-ACK information and HARQ-NACK information to transmit PSFCH. Accordingly, the HARQ-ACK/NACK information corresponding to the PSSCH received by the V2X reception UE in slot 0 and slot 1 may be transmitted in slot 4 as shown in FIG. 12. The HARQ-ACK/NACK information corresponding to the PSSCH received by the V2X reception UE in slot 2, slot 3, slot 4 and slot 5 may be transmitted in slot 8. Further, the HARQ-ACK/NACK information corresponding to the PSSCH received by the V2X reception UE in slot 6, slot 7, slot 8 and slot 9 may be transmitted in slot 2.

FIG. 13A is a view illustrating another example of a frequency resource allocation of a sidelink feedback channel according to an embodiment of the disclosure.

FIG. 13A illustrates grouping frequency resources of PSFCH to address the PSFCH collision issue mentioned in FIG. 11. As shown in FIG. 13A, the frequency resources of the PSFCH may be grouped into frequency resources usable in each slot. In other words, the case where HARQ-ACK/NACK information may be transmitted in slot 8 in FIG. 12 is the case where the V2X reception UE receives PSSCH in slot 2, slot 3, slot 4, and slot 5 (slot #2 to slot #5). Accordingly, it may be determined how many groups the frequency resources should be divided into in the slot where PSFCH may be transmitted depending on either or both of K and N (in FIG. 12, it is assumed that K=3, and N=4, and in FIG. 13A, the PSFCH frequency resources are divided into four groups). As shown in FIG. 13A, the PSFCH frequency resources (i.e., the number of PRBs constituting the PSFCH) that each group may use may be the same or different. The start PRB index of the PSFCH may be determined through such grouping and the correlation with the start PRB index of the PSSCH exemplified in FIG. 8. Thus, even when different PSSCHs are transmitted using the same start PRB index in different slots, the PSFCH collision issue may be addressed because the start PRB index of the PSFCH may be set to differ.

FIG. 13B is a view illustrating a specific example of a frequency resource allocation of a sidelink feedback channel according to an embodiment of the disclosure.

FIG. 13B illustrates a specific embodiment of FIG. 13A and illustrates an example in which the PSFCH resources associated with the PSCCH or PSSCH received by the reception UE in slots 2, 3, 4, and 5 is present in slot index 8 as shown in FIG. 12. The total number of PSCCH or PSSCH reception slots associated with PSFCH transmission resources is defined as L (L=4 in FIGS. 12 to 13A). Further, the number of PRBs constituting each PSCCH or PSSCH reception slot associated with PSFCH transmission resources may be defined as M. In this case, M may be defined as the total number of PRBs constituting one sidelink resource pool. The total number of PRBs in the frequency axis within the sidelink resource pool is the same in all slots constituting the sidelink resource pool. In the above-described examples, a set of PSCCH or PSSCH reception slots associated with PSFCH transmission resources (i.e., slots 2, 3, 4, and 5 (slot #2 to slot #5) shown in FIGS. 12 and 13A and 13B) may be physically contiguous or logically contiguous (if logically contiguous, physically non-contiguous). Further, M PRBs constituting each reception slot of PSCCH or PSSCH may also be physically contiguous or logically contiguous.

In FIG. 13B, PSCCH or PSSCH reception slot indexes 2, 3, 4, and 5 associated with PSFCH transmission resources may be interpreted as slot indexes 0′, 1′, 2′, and 3′ (slot #0′ to slot #3′), respectively. More generally, assuming that there are L physically contiguous or non-contiguous PSCCH or PSSCH reception slots associated with PSFCH transmission resources, each PSCCH or PSSCH reception slot may be interpreted as slot indexes 0′, 1′, . . . , in chronological order. Since FIG. 13B illustrates the case of L=4, each PSCCH or PSSCH reception slot may be interpreted as slot indexes 0′, 1′, 2′, and 3′ in chronological order.

As illustrated in FIGS. 10 and 11, when the transmission frequency resource of the PSFCH is associated with the reception frequency resource of the PSCCH or PSSCH, the position of the reception frequency resource of the PSCCH or PSSCH received by each reception UE may be mapped to the position of the frequency resource for transmitting PSFCH. Therefore, as many PSFCH transmission resources as the total number of resources of PSCCH or PSSCH that may be received may be required. For example, when it is assumed that the minimum transmission resource unit that one transmission UE may transmit is 1 PRB, up to M PSCCHs or PSSCHs may be received in slot index 0′ of FIG. 13B. Therefore, the total number of frequency resources of PSCCH or PSSCH associated with frequency resources of PSFCH may be (4×M) PRBs. Generally, the total number of frequency resources of PSCCH or PSSCH associated with PSFCH transmission may be (L×M) PRBs. In this case, L may mean the total number of PSCCH or PSSCH reception slots associated with PSFCH transmission resources, as described above.

(L×M) PRB indexes, which indicate the start positions of frequency resources where the above-described PSCCH or PSSCH may be received, may be mapped to the start points of frequency resources for PSFCH transmission as shown in FIG. 13B. In other words, PRB indexes 0, 1, . . . , M−1 of slot index 0′, PRB indexes 0, 1, . . . , M−1 of slot index 1′, PRB indexes 0, 1, . . . , M−1 of slot index 2′, and PRB indexes 0, 1, . . . , M−1 of slot index 3′ may be mapped in order. Based on the mapping rule, the reception UE receiving PSCCH or PSSCH using PRB index 0 of slot index 2′ as the start point and the reception UE receiving PSCCH or PSSCH using PRB index 0 of slot index 3′ as the start point may regard the PSFCH frequency resources mapped to the PRB index and the corresponding slot index as the start points of the frequency resource for PSFCH transmission.

Generally, when the indexes of PSCCH or PSSCH reception slots associated with frequency resources for PSFCH transmission (i.e., slot 2 (or slot 0′), 3 (or slot 1′), 4 (or slot 2′), and 5 (or slot 3′) in FIG. 13B) may be defined as ‘l’, and the index of the PRB in each slot is defined as ‘m’, the start index of the PSFCH frequency resource in the slot in which the PSFCH is transmitted may be determined by ‘l+m+offset’. In this case, the offset value is a parameter for reducing inter-cell interference, and is assumed to be offset=0 in FIG. 13B, but may have a different value for each cell. The offset value may be set by the base station to the UE through system information or RRC configuration, or may be derived through a cell ID (or a virtual cell ID set by the base station) detected by the UE from the synchronization signal of the base station. As an example, the UE obtaining ‘0’ from 0, 1, or 2 obtained through cell ID mod 3 operation may apply offset=0, and the UE obtaining ‘1’ may apply offset=z, and the UE obtaining ‘2’ may apply offset=2z. In this case, it may be assumed that z is a fixed value and is known to both the base station and the UE.

The reception UE needs to know the number of PRBs necessary for PSFCH transmission in addition to the start point (i.e., start PRB index) of the frequency resource for PSFCH transmission. In this case, it may be assumed that the reception UE knows the number of PRBs required for PSFCH transmission before PSFCH transmission. For example, a fixed value is used as the number of PRBs required for PSFCH transmission (i.e., 2 PRBs), or the number of PRBs required for PSFCH transmission may be set through system information or RRC, or PC-5 RRC of the base station.

As in the above-described example, when the minimum resource unit that one UE may use for PSCCH or PSSCH transmission is assumed to be 1 PRB, (L×M) start indexes of the PSFCH frequency resource may be required. In this case, if the number of PRBs required for PSFCH transmission is assumed to be 1, (L×M) PSFCH frequency resources may be required. However, when the number of PRBs required for PSFCH transmission is assumed to be ‘R’ which is larger than 1, (L×M×R) PRBs may be required as PSFCH frequency resources. This may cause a shortage of PSFCH frequency resources in the slot in which the PSFCH is transmitted. For example, when sidelink BWP is set to 20 MHz, and one sidelink resource pool is configured in the sidelink BWP, 100 PRBs may exist in the sidelink resource pool. When the minimum transmission resource of PSCCH or PSSCH is assumed to be 1 PRB and the number of PRBs required for PSFCH transmission is assumed to be 1, 400 (=4×100) PSFCH frequency resources may be required in FIG. 13B. Since one resource pool is constituted of 100 PRBs, 300 UEs in the above-described example may not be able to perform PSFCH transmission. In the above-described example, when the number of PRBs required for PSFCH transmission is increased to 2, 800 (=4×100×2) PSFCH frequency resources may be required, so that the PSFCH frequency resource shortage issue may become more serious.

FIG. 13C is a view illustrating another example of a frequency resource allocation of a sidelink feedback channel according to an embodiment of the disclosure.

FIG. 13C illustrates another example of mapping between the start index of the frequency resource for PSFCH transmission and the start index of frequency resource where PSCCH or PSSCH may be received.

In FIG. 13B, frequency resource indexes of the first slot in which PSCCH or PSSCH is received are sequentially mapped to the start index of the PSFCH frequency resource, and then, the frequency resource indexes of the next slot are sequentially mapped to the start index of the PSFCH frequency resource. Unlike this, FIG. 13C illustrates that the indexes of the first frequency resources of the slots where PSCCH or PSSCH is received are mapped to the start index of the PSFCH frequency resource, and then the next frequency resources are sequentially mapped. The mapping structure of FIG. 13C is different from that of FIG. 13B but may experience the PSFCH frequency resource shortage issue like in FIG. 13B.

The PSFCH frequency resource shortage issue mentioned in FIGS. 13B and 13C may worsen as the minimum resource unit of the PSCCH or PSSCH transmitted by the transmission UE increases (e.g., one PRB) and/or the minimum resource unit of the PSFCH transmitted by the reception UE increases (e.g., 2 PRBs or more). This issue may be addressed by increasing the minimum resource unit of PSCCH or PSSCH and reducing the minimum resource unit of the PSFCH transmitted by the reception UE. As an example, two or more physically contiguous or logically contiguous PRBs may be grouped into a PRB group (PRBG or PRB group). In this case, PRBG may be named as a subchannel. One subchannel may be defined as a minimum resource unit for PSCCH, PSSCH or PSFCH transmission. Further, the PSCCH subchannel meaning the minimum resource unit of the PSCCH, the PSSCH subchannel meaning the minimum resource unit of the PSSCH, and the PSFCH subchannel meaning the minimum resource unit of the PSFCH may be constituted of the same or different numbers of PRBs. For example, the PSCCH subchannel may be constituted of two PRBs, and the PSSCH subchannel may be constituted of 4 PRBs, and the PSFCH subchannel may be constituted of 1 PRB. However, this is merely an example, and the number of PRBs constituting the PSCCH, PSSCH, and PSFCH subchannels may be defined as α, β, γ. In this case, α, β, γ may use a fixed value for each of the PSCCH, PSSCH and PSFCH or set by the base station. Or, it may be set through PC-5 RRC or set in advance. As mentioned above, to address the PSFCH resource shortage issue, α>β (when the PSFCH resource is associated with the PSCCH resource) or β>γ (when the PSFCH resource is associated with the PSSCH resource) needs to be met.

For example, the PSCCH subchannel or PSSCH subchannel may be constituted of α-PRBs (for convenience of description, it is assumed that the numbers of PRBs constituting the PSCCH subchannel and the PSSCH subchannel are the same), and the PSFCH subchannel is constituted of γ PRBs. Further, as shown in FIGS. 13B to 13C, assuming that each slot constituting the sidelink resource pool is composed of a total of M PRBs, the slots in which PSCCH or PSSCH may be received (e.g., slot 2 (or slot 0′), 3 (or slot 1′), 4 (or slot 2′), and 5 (or slot 3′) in FIGS. 13B and 13C) may be regarded as constituted of M/α PSCCH or PSSCH subchannels. In this case, when M/α is not an integer, it may be rounded down or up (i.e., └M/α┘ or ┌M/α┐). Therefore, since there may be a total of

$$( L \times \frac{M}{α} )$$

frequency resources capable of receiving PSCCH or PSSCH subchannels,

$$( L \times \frac{M}{α} \times γ )$$

PSFCH frequency resources are required in the slot where the PSFCH resource is present. To address the PSFCH frequency resource shortage issue described above, the

$$L \times \frac{M}{α} \times γ \leq M$$

condition should be met. More specifically, assuming that L=4, M=100, α=4, and γ=1, the left term is 100 and the right term is 100 in the above-described equation, so that the condition is met. Thus, the PSFCH resource shortage issue may not occur. However, when it is assumed that L=4, M=100, α=4, and γ=2, the left term is 200 and the right term is 100 in the above-described equation, failing to meet the condition. Therefore, the PSFCH resource shortage issue may still occur.

FIG. 13D is a view illustrating another example of a frequency resource allocation of a sidelink feedback channel according to an embodiment of the disclosure.

FIG. 13D illustrates another example of mapping between the start index of the frequency resource for PSFCH transmission and the start index of frequency resource where PSCCH or PSSCH may be received.

Unlike FIGS. 13B to 13C, FIG. 13D illustrates a case where the start index of the frequency resource where PSCCH or PSSCH may be received in one slot is mapped to the start index of the PSFCH frequency resource, and the slot index where PSCCH or PSSCH may be received is mapped to the index of the PSFCH code resource. In other words, according to the scheme shown in FIG. 13D, resource indexes mapped to a total of (L×M) PRBs may be expressed using M PRBs on the frequency axis and L codes on the code axis. More specifically, when the index of the PSCCH or PSSCH reception slot associated with the frequency resource for PSFCH transmission is defined as ‘1’, and the index of the PRB in each slot is defined as ‘m’, the start index of the PSFCH frequency resource in the slot in which the PSFCH is transmitted may be determined by ‘m+offset’. Further, the start index of the PSFCH frequency resource may be determined by ‘m+offset’ regardless of the index of each PSCCH or PSSCH reception slot, and the index of each PSCCH or PSSCH reception slot may be mapped to the code resource. In this case, the offset value is a parameter for reducing inter-cell interference, and is assumed to be offset=0 in FIG. 13B, but may have a different value for each cell. The offset value may be set by the base station to the UE through system information or RRC configuration, or may be derived through a cell ID (or a virtual cell ID set by the base station) detected by the UE from the synchronization signal of the base station. As an example, the UE obtaining ‘0’ from 0, 1, or 2 obtained through cell ID mod 3 operation may apply offset=0, and the UE obtaining ‘1’ may apply offset=z, and the UE obtaining ‘2’ may apply offset=2z. In this case, it may be assumed that z is a fixed value and is known to both the base station and the UE.

The reception UE needs to know the number of PRBs necessary for PSFCH transmission in addition to the start point (i.e., start PRB index) of the frequency resource for PSFCH transmission. It may be assumed that the reception UE knows the number of PRBs required for PSFCH transmission before PSFCH transmission. For example, as the number of PRBs required for PSFCH transmission, a fixed value (i.e., two PRBs) may be used, or the number of PRBs required for PSFCH transmission may be set through the system information of the base station, RRC, or PC-5 RRC.

The above-described example may be applied to the aforementioned PSCCH, PSSCH, and PSFCH subchannel concepts. As an example, a total of

$$( L \times \frac{M}{α} )$$

PSFCH resource indexes may be expressed using M/α subchannels on the frequency axis of each slot where PSCCH or PSSCH may be received and L codes on the code axis. As described above, when the number of PRBs constituting the PSFCH subchannel is γ, there may be

$$( \frac{M}{α} \times γ )$$

PSFCH frequency resources on the frequency axis in the slot where PSFCH resources are present. Since the slots constituting the sidelink resource pool may have a total of M PRBs in the frequency axis, if the

$$\frac{M}{α} \times γ \leq M$$

condition is met, the PSFCH resource shortage issue does not occur. In other words, if α≥γ, the PSFCH resource shortage issue does not occur. Since the bit size of SFCI transmitted through PSFCH is very small as compared to the size of bits transmitted through PSCCH or PSSCH (e.g., the bit size of SFCI transmitted through PSFCH is 1 or 2 and the size of bits transmitted through PSCCH or PSSCH is tens to thousands of bits), α may always be equal to or larger than γ. Therefore, since the above-described condition may always be met, the PSFCH resource shortage issue may not occur.

The examples mentioned in FIGS. 13A, 13B, 13C, and 13D may apply when the frequency resource of a PSCCH or PSSCH transmitted by one transmission UE is associated with the transmission frequency resource of the PSFCH transmitted by one reception UE. Unlike the case described above, in groupcast communication, the frequency resource of the PSCCH or PSSCH transmitted by one transmission UE may be associated with the transmission frequency resources of the PSFCHs transmitted by two or more reception UEs. For example, groupcast communication constituted of three UEs may be assumed (UE-A, UE-B and UE-C). In this case, it may be assumed that UE-A is a transmission UE that transmits a PSCCH or PSSCH, and UE-B and UE-C are reception UEs that receive it. The PSCCH or PSSCH transmitted by UE-A may be received by UE-B and UE-C, and UE-B and UE-C that have received it should transmit the PSFCH to UE-A. In this case, UE-B and UE-C may transmit HARQ feedback information using one of the following two methods.

Option 1: NACK information may be transmitted only when decoding of the received PSSCH fails. In other words, UE-B and UE-C may not transmit ACK information when decoding of the PSSCH received from UE-A succeeds, and may transmit NACK information only when decoding of the PSSCH fails. In this case, UEs transmitting NACK information may transmit NACK information only when a specific condition is met. More specifically, upon failing to decode PSSCH, UE-B and UE-C do not always transmit NACK information but may determine an additional condition. This condition may be a distance from UE-A or RSRP. For example, UE-B fails to decode the PSSCH and thus should transmit NACK information to UE-A, but unless the above-described distance condition or RSRP condition is met, UE-B may not transmit NACK information to UE-A. When the distance condition is used, UE-A which is a transmission UE may transmit its location information to the reception UEs (i.e., UE-B and UE-C), and UE-B and UE-C, receiving it, may measure the distances between them and UE-A using the location information received from UE-A and their own location information that they have measured. Each reception UE may perform a comparison operation with the distance that it has measured, using a threshold for the distance received from the higher layer. When the distance it has measured is larger than the distance threshold, each reception UE does not transmit NACK information to UE-A. Only when the distance that it has measured is smaller than the distance threshold, each reception UE may transmit NACK information to UE-A. When the RSRP condition is used, the reception UEs (i.e., UE-B and UE-C) in the group may measure the RSRP using the reference signal (e.g., DMRS or sidelink CSI-RS) transmitted by the transmission UE. Each reception UE may perform a comparison operation with the RSRP that it has measured, using a threshold for the RSRP received from the higher layer. When the RSRP it has measured is larger than the RSRP threshold, NACK information is not transmitted to UE-A. Only when the RSRP that it has measured is smaller than the RSRP threshold, each reception UE may transmit NACK information to UE-A.

In Option 1, all the reception UEs in the group may transmit the PSFCH using the same time/frequency resource. Therefore, when the PSFCH frequency resource is associated with the frequency resource of the PSCCH or PSSCH, reception UEs transmitting the PSFCH may transmit the PSFCH using one of the methods exemplified in FIGS. 13A, 13B, 13C, and 13D.

Option 2: Unlike option 1 described above, the reception UEs (UE-B and UE-C) in the same group performing groupcast communication, each, may transmit ACK information and NACK information to UE-A. In other words, the reception UE, succeeding in decoding the PSSCH, may transmit ACK information through the PSFCH, and the reception UE, failing to decode the PSSCH, may transmit NACK information through the PSFCH. In option 2, the information transmitted by the reception UEs to the transmission UE (UE-A) may differ from each other (i.e., UE-B transmits NACK information, and UE-C transmits ACK information). Accordingly, for UE-A receiving different feedback information to accurately decode, the reception UEs in the group need to use different PSFCH transmission resources. Further, when UE-B and UE-C transmit the same information using the same PSFCH transmission resource (i.e., when both the UEs transmit ACK or NACK), UE-A receiving it may not determine which reception UE the corresponding feedback information has been received from. Accordingly, the reception frequency resources of PSCCH or PSSCH need to be associated with the two or more PSFCH frequency resources. Meanwhile, the distance condition or RSRP condition mentioned in option 1 may further apply to option 2. In other words, the reception UEs in the group may feed ACK or NACK information back to the transmission UE only when the distance condition or RSRP condition is met.

The methods mentioned in FIGS. 13A, 13B, 13C, and 13D are examples for the case where the reception frequency resource of PSCCH or PSSCH is associated with one PSFCH frequency resource, and thus may not be applied to option 2. Therefore, a new method for applying the methods mentioned in FIGS. 13A, 13B, 13C, and 13B to option 2 is required.

More specifically, it has been described in FIGS. 13B and 13C that the

$$L \times \frac{M}{α} \times γ \leq M$$

condition needs to be met to address the PSFCH resource shortage issue. However, this condition may be applied only when the PSCCH or PSSCH frequency resource and one PSFCH resource are associated (e.g., option 1 above). As mentioned above, in option 2, since the PSCCH or PSSCH frequency resource should be associated with two or more PSFCH resources (i.e., the number of reception UEs in the group should use different PSFCH resources), the number of reception UEs in the group needs to be considered. Therefore, when the number of reception UEs in one group is defined as G, the

$$G \times L \times \frac{M}{α} \times γ \leq M$$

condition should be met to address the PSFCH resource shortage issue. If the example for L=4, M=100, α=4, γ=2 mentioned in FIGS. 13B and 13C is applied, when the number of reception UEs in the group is assumed to be G=5, the left term is

$$5 \times 4 \times \frac{100}{4} \times 2 = 1000 ,$$

and the right term is 100 in the above-described equation, so that the condition is not met.

To address this issue, when using the method of FIGS. 13B and 13C, the reception UEs in the group share the same PSFCH frequency resource, and each reception UE may transmit PSFCH using a different code. For example, when assuming groupcast communication constituted of UE-1, UE-2, UE-3, UE-4, and UE-5, and that UE-1 is a transmission UE, and the remaining UEs are reception UEs in the group. In FIG. 13B, UE-1 transmits PSCCH or PSSCH including start frequency index 0 in slot index 0′, and the reception UEs (UE-2, UE-3, UE-4, and UE-5) receive it. UE-2, UE-3, UE-4, and UE-5 may know that the PSFCH frequency resource having slot index 0′ and the start frequency index 0 is the start frequency index capable of transmitting the PSFCH. In this case, UE-2, UE-3, UE-4, and UE-5 may use the same PSFCH frequency resource but apply different codes. More specifically, UE-2, UE-3, UE-4, and UE-5 may have their own UE IDs. In this case, the UE ID may be the source ID of each reception UE or a higher layer ID capable of identifying each UE included in the same group in groupcast communication. Each reception UE knows its own UE ID and may select a code according to the ID. In this case, the code may mean a root index for determining a sequence or a cyclic shift. As another example, the code may mean the orthogonal cover code (OCC) on the time axis or the OCC on the frequency axis. Each reception UE may select a code resource that it may use through a modulo operation of its own ID and a specific number ‘C’. For example, UE-2 may obtain ‘0’ through the modulo operation of its own ID and ‘C’, and UE-3 may obtain ‘1’ through the modulo operation of its own ID and ‘C’. UE-2, which obtains ‘0’, may select the code corresponding to ‘0’, and UE-3, which obtains ‘1’, may select the code corresponding to ‘1’. UE-2 and UE-3 may multiply the PSFCH to be transmitted by the selected code on the time axis or frequency axis and transmit it. Thus, UE-1 may receive PSFCHs transmitted from UE-2, UE-3, UE-4, and UE-5 through different codes in the same PSFCH frequency resource.

In the above-described example, ‘C’ may be a fixed value or a variable value according to the method for forming the group in groupcast communication. More specifically, the UEs in the group may know their mutual group destination IDs by exchanging information about the group members before performing groupcast communication. For example, when UE-1 is a transmission UE, and UE-2, UE-3, UE-4, and UE-5 are reception UEs in the above-described example, UE-1 is aware of the group destination ID for the reception UEs to receive before groupcast transmission. In this case, ‘C’ may be varied depending on the number of group members constituting the group and be set while exchanging information about the group members before performing groupcast communication. As an example, ‘C’ may be set through PC-5 RRC or be set in the resource pool information performing groupcast communication. Meanwhile, there may be the case where information about the group members is not known before performing groupcast communication. In this case, since the information about the group members is absent, the number of the group members may not be known. In this case, a fixed value may be used as ‘C.’ As another example, in the coverage of the base station, the base station may set the above-described ‘C’ value through system information or RRC. The information may be included in the resource pool configuration information for groupcast communication.

To address the PSFCH resource shortage issue arising in FIGS. 13B and 13C, in FIG. 13D, the PSFCH resources associated with the slots where PSCCH or PSSCH is received are distinguished by using different codes. In the above-described example, the method for selecting the PSFCH resource to be transmitted by each UE through modulo operation of the UE ID and ‘C’ may also apply to FIG. 13D. For example, groupcast communication constituted of UE-1, UE-2, UE-3, UE-4, and UE-5 is assumed, and it may be assumed that UE-1 is a transmission UE, and the remaining UEs are reception UEs in the group. In FIG. 13D, UE-1 transmits PSCCH or PSSCH including start frequency index 0 in slot index 0′, and the reception UEs (UE-2, UE-3, UE-4, and UE-5) receive it. UE-2, UE-3, UE-4, and UE-5 may determine that the PSFCH frequency resource having the start frequency index 0 is the start frequency index capable of transmitting the PSFCH and know that code 0 should be used to transmit PSFCH as PSCCH or PSSCH is received in slot index 0′. In this case, UE-2, UE-3, UE-4, and UE-5 may use the same PSFCH frequency resource and the same code corresponding to slot index 0′ and may apply different codes for distinguishing the UEs. More specifically, UE-2, UE-3, UE-4, and UE-5 may have their own UE IDs. In this case, the UE ID may be the source ID of each reception UE or a higher layer ID capable of identifying each UE included in the same group in groupcast communication. Each reception UE knows its own UE ID and may select a code according to the ID. In this case, the code may mean a root index for determining a sequence or a cyclic shift. As another example, the code may mean the orthogonal cover code (OCC) on the time axis or the OCC on the frequency axis. Each reception UE may select a code resource that it may use through a modulo operation of its own ID and a specific number ‘C’. For example, UE-2 may obtain ‘0’ through the modulo operation of its own ID and ‘C’, and UE-3 may obtain ‘1’ through the modulo operation of its own ID and ‘C’. UE-2, which obtains ‘0’, may select the code corresponding to ‘0’, and UE-3, which obtains ‘1’, may select the code corresponding to ‘1’. UE-2 and UE-3 may multiply the PSFCH to be transmitted by the selected code on the time axis or frequency axis and transmit it. Thus, UE-1 may receive PSFCHs transmitted from UE-2, UE-3, UE-4, and UE-5 through different codes in the same PSFCH frequency resource.

In the examples of FIGS. 12, 13A, 13B, 13C, and 13D, to correctly transmit and receive the PSFCH, the sidelink transmission/reception UE needs to know the number of bits of HARQ-ACK/NACK information included in the PSFCH, which may be determined based on a combination of at least one of the following parameters.

The period of the slot in which the PSFCH resource is present (i.e., the period of the PSFCH time axis resource, N in FIG. 12)

Whether to bundle HARQ-ACK/NACK information: In FIG. 12, the HARQ-ACK/NACK information corresponding to the PSSCH received by the V2X reception UE in slot 2, slot 3, slot 4, and slot 5 may be transmitted in slot 8, and the HARQ-ACK/NACK bits transmitted in slot 8 may be values determined through AND operation of the respective HARQ-ACK/NACK bits of the PSSCHs received in slot 2, slot 3, slot 4, and slot 5 (i.e., if any one is NACK, it is determined to be NACK).

Whether to use and set retransmission in code block group (CBG) units: When retransmission in CBG units is used, one TB may be split into two or more CBGs, and HARQ-ACK/NACK feedback may be possible in CBG units. In this case, two-bit or more HARQ-ACK/NACK feedback information for one TB may be transmitted through the PSFCH.

Number of transport blocks (TBs) included in PSSCH: When one PSSCH transmits two TBs, the number of bits of the HARQ-ACK/NACK information may be two (when the above-described retransmission in CBG units is not used).

Number of PSSCHs actually transmitted/received: FIG. 12 illustrates transmission, in slot 8, of HARQ-ACK/NACK feedback of the PSSCHs received in slot 2, slot 3, slot 4, and slot 5. When the sidelink channel quality is poor, the reception UE may fail to receive one or more of the PSSCHs in some cases. In such a case, the reception UE may generate HARQ-ACK/NACK information based on the number of PSSCHs actually received.

Timing relationship between the minimum signal processing time K or PSS reception time of the UE for PSSCH processing and PSFCH transmission preparation and the PSFCH transmission time: In FIG. 12, it is assumed that K=3. It may be assumed that the reception UE receiving the PSSCH has received the PSSCH in slot ‘n’ and that a PSFCH resource is present in slot ‘n+x’. In this case, the reception UE transmitting the PSFCH may transmit the above-described HARQ-ACK/NACK information of PSSCH through the PSFCH present in slot ‘n+x’ using the smallest ‘x’ value among the integers equal to or larger than K. In other words, the reception UE receiving PSSCH in slot 2 (n=2) in FIG. 12 may be considered. Since PSFCH resources are present in slot 4 (n+x=4) and slot 8 (n+x=8), in the example above, x=2 (when n+x=4) or x=6 (when n+x=8). When it is assumed that K=3, the reception UE should use the smallest ‘x’ value among the integers equal to or larger than K=3, the reception UE may select x=6 and transmit PSFCH in slot 8 in the above-described example. As another example, the reception UE receiving PSSCH in slot 1 (n=1) in FIG. 12 may be considered. Since PSFCH resources are present in slot 4 (n+x=4) and slot 8 (n+x=8), in the example above, x=3 (when n+x=4) or x=7 (when n+x=8). When it is assumed that K=3, the reception UE should use the smallest ‘x’ value among the integers equal to or larger than K=3, the reception UE may select x=3 and transmit PSFCH in slot 4 in the above-described example.

The above-described K value may be determined by the sidelink UE through a combination of at least one of the following methods or be set through system information and RRC of the base station or set through PC-5 RRC.

Method 1) K may be fixed (e.g., K=2) regardless of the size of the subcarrier. This is why a minimum processing time exceeding 28 symbols in all subcarrier spacings may not be defined considering the UE's processing time capability.

Method 2) K may be determined depending on the size of the subcarrier used. For example, K=2 for 15 kHz and 30 kHz, and K=3 for 60 kHz and 120 kHz.

Method 3) K may be configured according to the sidelink resource pool or pre-configured according to the sidelink resource pool. As another example, it may be configured to differ depending on unicast or groupcast communication schemes in the sidelink resource pool.

Method 4) Determining method by a combination of at least one of a) to d) below, such as UE's processing capability and time interval of PSSCH and PSFCH

a) Time when PSSCH transmission ends, i.e., last symbol time

b) Time when PSFCH transmission starts, i.e., first symbol time

c) UE's processing capability

d) Slot boundary point

The above-described methods may be modified and applied as follows. When receiving PSSCH in slot n, the reception UE may transmit HARQ-ACK feedback information for the PSSCH through the PSFCH positioned earliest among the PSFCHs where the PSSCH and PSFCH time axis interval is equal to or larger than y symbols. y may be a value preset by the transmission UE or a value set in the sidelink resource pool where the corresponding PSSCH or PSFCH is transmitted. For this configuration, the sidelink reception UE may be required to exchange its processing capability with the sidelink transmission UE. Further, the configuration may differ depending on the subcarrier spacing.

As another example, the UE's processing capability may be divided into two phases, e.g., normal processing capability (capability type 1) and enhanced processing capability (capability type 2), and different K values may apply depending on subcarriers. More specifically, information about the UE processing capability of the sidelink transmission/reception UE may be exchanged during the RRC configuration between the sidelink UE and the base station or PC-5 RRC connection setup process between sidelink UEs. As specified in Table 1, the UE having the normal processing capability (capability type 1) may apply K=2 when the subcarrier spacing (SCS) used for sidelink transmission/reception is 15 kHz or 30 kHz, and the UE having the enhanced processing capability (capability type 2) may apply K=1 when the subcarrier spacing (SCS) used for sidelink transmission/reception is 15 kHz or 30 kHz.

TABLE 1

| | | K for Processing | K for Processing | |
|---|---|---|---|---|
| SCS [symbol] | | Capability Type 1 [symbol] | Capability Type 2 [symbol] | [symbol] |
| 15 | kHz [symbol] | 2 [symbol] | 1 [symbol] | [symbol] |
| 30 | kHz [symbol] | 2 [symbol] | 1 [symbol] | [symbol] |
| 60 | kHz [symbol] | 3 [symbol] | 2 [symbol] | [symbol] |
| 120 | kHz [symbol] | 3 [symbol] | 2 [symbol] | [symbol] |

To describe an example of the bit size of HARQ-ACK/NACK information constituting the PSFCH, it may be assumed that N=2 and K=1. In other words, it is the case where in the sidelink resource pool, the PSFCH resource is configured on the time axis every N=2 slots, and the reception UE has the capability of transmitting HARQ-ACK/NACK feedback information for the PSSCH received in slot ‘n’ in ‘n+1’ slot (K=1). In this case, the slot where HARQ-ACK feedback may actually be transmitted may be determined as shown in FIG. 13E.

In FIG. 13E, the first row means the indexes of the slots constituting the sidelink resource pool and logical indexes. In this case, logical slot indexes are allocated only to slots included in the sidelink resource pool, and logical slot indexes are not allocated to slots not included in the sidelink resource pool. In other words, since the 4th, 8th, 9th, 10th, 12th, and 13th slots are not included in the sidelink resource pool, logical slot indexes are not allocated. Meanwhile, the second row of FIG. 13E illustrates the physical slot indexes, and the slot indexes may be allocated according to the order of the slots regardless of whether the corresponding slot is included in the sidelink resource pool. The third row of FIG. 13E indicates whether the corresponding slot is included in the sidelink resource pool, and O means that the corresponding slot is included in the sidelink resource pool, and X means that the corresponding slot is not included in the sidelink resource pool. The fourth row of FIG. 13E indicates whether PSFCH transmission is possible. O means a slot in which PSFCH transmission is possible and X means a slot in which PSFCH transmission is impossible. In this case, the slot where PSFCH transmission is possible should be included in the sidelink resource pool, and be determined according to N calculated based on the logical slot index, and is assumed to be N=2 (i.e., PSFCH resources may be present every two slots based on the logical slot indexes). The fifth row of FIG. 13E may mean the slot in which the PSSCH corresponding to HARQ-ACK/NACK information transmitted through the PSFCH is received. For example, the PSFCH transmitted in physical slot index n may include HARQ feedback information about PSSCH received in slot n−1 and slot n−2.

As shown in the fifth row of FIG. 13E, the number of bits of HARQ-ACK/NACK information transmitted on the PSFCH by each reception UE in the slot capable of PSFCH transmission may be 2 bits. In other words, each reception UE may determine the number of HARQ-ACK/NACK feedback bits that should be included in the PSFCH when transmitting PSFCH in a specific slot considering K which is set or determined depending on the UE's processing capability, the period N when PSFCH resources are configured, slots where PSFCH resources are present, and slots included in the sidelink resource pool. More specifically, the determined number of HARQ-ACK/NACK feedback information bits may be determined by Equation 1 below.

Number of HARQ-ACK bits to be included in PSFCH transmitted in physical slot n=Number of slots included in the sidelink resource pool among the slots from physical slot (k−K+1) to physical slot (n−K) Equation 1

In Equation 1, physical slot index k may be the index of the slot where the PSFCH resource configured immediately before the PSFCH which may be transmitted in physical slot n is included.

As another example, when N and K are given, the maximum number of HARQ-ACK feedback bits transmitted on one PSFCH by the reception UE may be fixed (i.e., all the reception UEs transmit HARQ-ACK feedback constituted of the same number of bits). Such fixed size of the number of feedback bits may be defined as the maximum number of HARQ-ACK feedback bits transmitted by one reception UE and be determined by Equation 2 below.

The maximum number of HARQ-ACK/NACK feedback bits that the reception UE may transmit on one PSFCH=N+K−1 Equation 2

As another example, when feedback is transmitted in sidelink unicast or groupcast communication, the number of bits of the feedback may be calculated using the number of slots included in the sidelink resource pool, N, K, and the number of slots where the PSSCH associated with the HARQ-ACK feedback transmitted on the PSFCH in the slot of transmitting the PSFCH may be transmitted. In the above-described examples, the number of HARQ-ACK feedback bits transmitted by the reception UE may be increased to a predetermined value or more depending on a combination of N and K. In this case, since PSFCH should transmit many bits, the reception error rate of PSFCH may increase. Accordingly, the reception UE may transmit only the last K bits among the feedback bits that it should transmit (i.e., transmits only HARQ-ACK/NACK feedback information about the recently received PSSCH) while not transmitting the remaining bits.

Meanwhile, PSFCH resources may be present in a specific slot, but there may be no sidelink slot where the PSSCH associated with HARQ-ACK/NACK feedback is to be transmitted. In other words, there may be a case where feedback information bits to be transmitted are not present in the PSFCH resources of a specific slot depending on N and K and the sidelink resource pool configuration. In this case, the reception UE, although configured with the PSFCH resources in the corresponding slot, may consider that there is no PSFCH resource. In other words, although configured to have PSFCH resources, the reception UE may disregard the corresponding PSFCH resources and may not perform PSFCH transmission. In this case, the reception UE may perform transmission/reception of control information and/or PSSCH in the corresponding slot.

In the disclosure including the present embodiments, when HARQ-ACK/NACK is mentioned, the corresponding PSSCH may be a PSSCH for unicast or groupcast, configured or indicated to transmit HARQ-ACK/NACK. In other words, the proposed scheme may not apply to the PSSCH not required to transmit HARQ-ACK/NACK (i.e., PSSCH where no HARQ-ACK/NACK is configured). Further, in the disclosure including the present embodiment, the control information scheduling PSSCH may mean PSCCH, but is not limited thereto. In other words, the control information may be not transmitted only through PSSCH (e.g., transmitted through PSSCH). Further, the control information may be one piece of control information, but a plurality of pieces of control information may schedule one PSSCH.

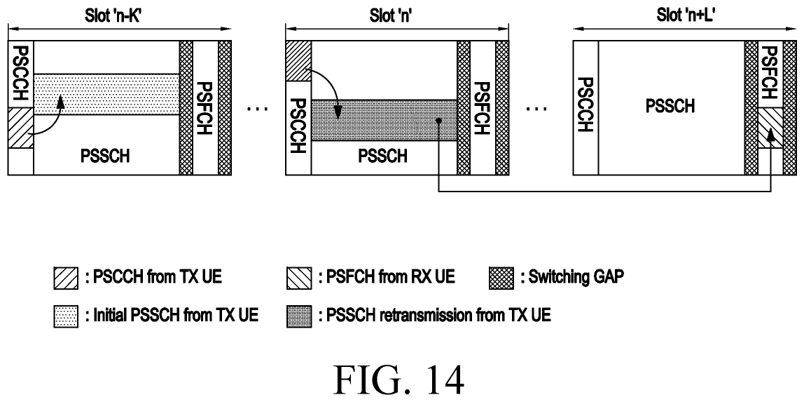

FIG. 14 is a view illustrating another example of a frequency resource allocation of a sidelink feedback channel according to an embodiment of the disclosure.

FIG. 14 illustrates a case where the same TB is repeatedly transmitted through two or more slots by slot aggregation or blind retransmission unlike FIG. 10. As described in connection with FIG. 10, FIG. 14 illustrates that the start PRB index of the last PSSCH transmitted by the V2X transmission UE (or the last PRB index of the last PSSCH) may be associated with the start PRB index of the PSFCH transmitted by the V2X reception UE.

More specifically, in FIG. 14, the V2X transmission UE may transmit PSCCH and PSSCH in n−K slot and repeatedly transmit it in slot n. The V2X reception UE may decode PSCCH to obtain sidelink control information and obtain information about time/frequency/code resources of PSSCH therefrom. Further, the V2X reception UE may obtain information about the redundancy version (RV) and new data indicator (NDI) from the sidelink control information. The V2X reception UE may be aware whether the TB transmitted in slot n is a new TB or a repeated transmission of the TB transmitted in slot n−K from the information.

Further, the V2X transmission/reception UE may be configured with information about the number of aggregated slots (when slot aggregation is configured) or the maximum number of repeated transmissions (when blind retransmission is reconfigured). Through the information, the V2X transmission UE and the V2X reception UE may figure out whether the slot where the last PSSCH of a specific TB is transmitted or the PSSCH in the corresponding slot is the last slot.

Accordingly, as shown in FIG. 14, when the start PRB index of the PSSCH in slot n is M, the start PRB index of the PSFCH in slot n+L may be the same M. As another example, when the start PRB index of PSSCH in slot n is M, the PSFCH in slot n+L may start at M+offset (or M−offset). In this case, the unit of the offset may be the PRB and be a fixed value identically used by all the V2X UEs or a value set to differ per resource pool. For example, in resource pool 1, 10 may be used as the offset value and, in resource pool 2, 20 may be used as the offset value.

Similar to the above-described example, the last PRB index of PSSCH transmitted in slot n by the V2X transmission UE may have a correlation with the start PRB index of PSFCH transmitted in slot n+L by the V2X reception UE.

Meanwhile, FIG. 14 illustrates that PSCCH and PSSCH are transmitted in the same slot, but is not limited thereto. The information about how many resource blocks PSFCH is constituted of may use at least one of the methods mentioned in FIG. 10, as well as the above-described methods.

FIG. 14 illustrates a PSSCH repeatedly transmitted through two or more slots (repeated transmission through blind retransmission or repeated transmission through slot aggregation). In this case, the PSCCH including control information about the corresponding PSSCH may be together transmitted in the slot where the PSSCH is transmitted. In FIG. 14, since the start PRB index of the last PSSCH transmitted is associated with the start PRB index of the PSFCH, if the V2X reception UE fails to decode the last PSSCH transmitted in slot n, the V2X reception UE may not obtain the information about the start PRB index of PSFCH. To address such issue, the V2X reception UE may determine the start PRB index of PSFCH using the start PRB index of the last PSSCH that it has received (or it has successfully decoded).

Meanwhile, the PSSCH may be transmitted always in the same frequency position regardless of the number of slots used for slot aggregation or the number of repeated transmissions of PSSCH. In such a case, the V2X reception UE may determine the start PRB index of PSFCH from the start PRB index of PSSCH with respect to any PSSCH among the PSSCHs that it has received (or has successfully decoded).

The HARQ-ACK/NACK information transmitted by one V2X reception UE in groupcast or unicast communication may be transmitted through one PSFCH resource or through two PSFCH resources. When transmitted through one PSFCH, the methods mentioned in FIG. 14 may apply. However, when transmitted through two PSFCH resources (i.e., one PSFCH resource is used for HARQ-ACK transmission, and the other PSFCH resource is used for HARQ-NACK transmission), a method for indicating the start points of the two PSFCH resources may be required.

When two PSFCH resources are contiguously present, as mentioned in FIG. 14, the start PRB index of the first PSFCH resource may be derived from the start PRB index of the last PSSCH (or derived from the start PRB index of the last PSSCH successfully received by the V2X UE). In other words, the start PRB index of the first PSFCH resource may be M or M+offset (or M−offset) in an example. Further, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be M+[X1] or M+offset+[X1] (or M−offset−[X1]). In this case, [X1] may use a fixed value or be set from the base station or V2X transmission UE.

When two PSFCH resources are not contiguous, as mentioned in FIG. 14, the start PRB index of the first PSFCH resource may be derived from the start PRB index of the last PSSCH (or derived from the start PRB index of the last PSSCH successfully received by the V2X UE). The start PRB index of the second PSFCH resource may be configured through a separate offset. For example, the start PRB index of the first PSFCH resource may be M or M+offset1 (or M−offset1) in an example. The start PRB index of the second PSFCH resource may be M+offset2 or M+offset1+offset2 (or M−offset1−offset2). In this case, offset1 may mean the difference between the start PRB index of PSSCH and the start PRB index of PSFCH, and offset2 may mean the difference between the start PRB index of the first PSFCH resource and the start PRB index of the second PSFCH resource.

As another example, the start PRB index of the second PSFCH resource may be M+[X1]+offset2 or M+offset1+[X1]+offset2 (or M−offset1-[X1]-offset2). In this case, [X1] means the number of PRBs constituting the first PSFCH resource, and [X1] may use a fixed value or be set from the base station or V2X transmission UE. Further, in the example, offset1 may mean the difference between the start PRB index of PSSCH and the start PRB index of PSFCH. Further, offset2 may mean the difference between the start PRB index of the first PSFCH resource and the start PRB index of the second PSFCH resource.

Although not mentioned in FIG. 14, one of the methods mentioned in FIGS. 13B, 13C, and 13D may be applied to FIG. 14.

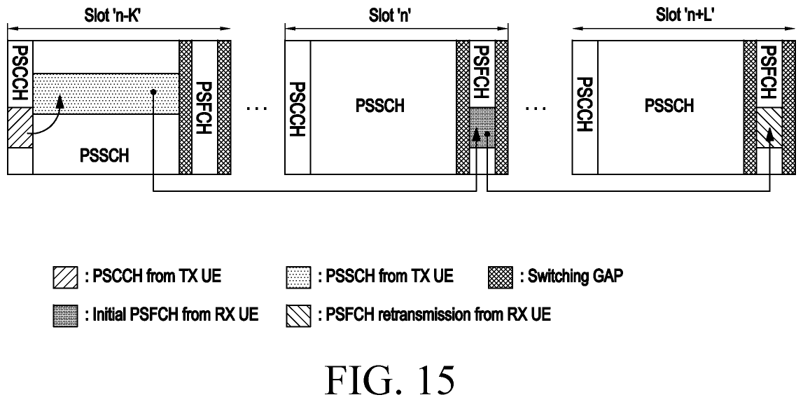

FIG. 15 is a view illustrating another example of a frequency resource allocation of a sidelink feedback channel according to an embodiment of the disclosure.

Unlike FIGS. 10 and 11 to 14, FIG. 15 illustrates a case where the PSFCH is repeatedly transmitted. This case may be the same in that the start PRB index (or last PRB index) of the PSSCH may denote the start PRB index of PSFCH initially transmitted through one of the methods described in connection with FIGS. 10 to 14.

In FIG. 15, it may be assumed that the number of PSFCH repeated transmissions is previously known to the V2X transmission UE receiving PSFCH and the V2X reception UE transmitting PSFCH. For example, the number of repeated transmissions of PSFCH may be included in the resource pool configuration information and be configured by the base station or, when the base station is absent (i.e., in the case of out-of-coverage), be preconfigured.

Therefore, as a method for configuring the start PRB index of the Xth transmitted PSFCH (where X is an integer larger than 1), one of the following methods may be used.

As an example, the same PRB index as the start PRB index of the initially transmitted PSFCH may be used. As another example, if an offset has been applied to determining the start PRB index of the initially transmitted PSFCH, the corresponding offset may apply likewise. More specifically, when the start PRB index of the initially transmitted PSFCH is M+offset (or M−offset), the start PRB index of the second transmitted PSFCH may be M+offset+offset (or M−offset-offset). In the above-described example, M means the start PRB index or last PRB index of the PSSCH.

As another example, a different offset value may be used every PSFCH transmission. In other words, when the start PRB index of the initially transmitted PSFCH is M+offset 1 (or M−offset 1), the start PRB index of the second transmitted PSFCH may be M+offset 1+offset 2 (or M−offset 1−offset 2). In this case, offset 1 and offset 2 may be configured by the base station or, when the base station is absent (i.e., in the case of out-of-coverage), pre-configured.

As the number of PRBs constituting the PSFCH, the same value may be used for initial transmission and retransmission of PSFCH. As another example, the number of PRBs used for PSFCH initial transmission and the number of PRBs used for PSFCH retransmission may differ from each other. For example, when the number of PRBs used for initial transmission is Y1, the number of PRBs of the second transmitted PSFCH may be Y1+Z1. In this case, Z1 may be a fixed value or configured by the base station or pre-configured. The number of PRBs of the third transmitted PSFCH may be Y1+Z1+Z2. In this case, Z2 may be the same value as Z1 or may be a different value from Z1. Likewise, Z2 may be a fixed value or configured by the base station or pre-configured. The aforementioned methods may also be applied to the number of PRBs of the fourth transmitted PSFCH.

Although not mentioned in FIG. 15, one of the methods mentioned in FIGS. 13B, 13C, and 13D may be applied to FIG. 15.

FIG. 16 is a view illustrating another example of a frequency resource allocation of a sidelink feedback channel according to an embodiment of the disclosure.

FIG. 10 illustrates that the PSSCH frequency resources are associated with the PSFCH frequency resources. However, FIG. 16 illustrates that the PSCCH frequency resources are associated with the PSFCH frequency resources, unlike FIG. 10.

As shown in FIG. 16, the V2X transmission UE may transmit PSCCH and PSSCH in slot n−K. The V2X reception UE may decode PSCCH to obtain sidelink control information and obtain information about time/frequency/code resources of PSSCH therefrom. FIG. 16 illustrates that PSCCH and PSSCH are transmitted in the same slot, but is not limited thereto. In other words, PSCCH is transmitted in slot n−K, but PSSCH may be transmitted in a subsequent slot. In such a case, the time relationship between PSCCH and PSSCH may be fixed (e.g., PSSCH is transmitted 4 ms after PSCCH reception), or be configured by the base station. As another example, the V2X transmission UE may indicate the time relationship between PSCCH and PSSCH in the sidelink control information that it transmits. The V2X reception UE, obtaining the sidelink control information, may decode the PSSCH through information about frequency/code resources of PSSCH and the time relationship between PSCCH and PSSCH.

The start PRB index of PSCCH transmitted in slot n−K by the V2X transmission UE may have a correlation with the start PRB index of PSFCH transmitted in slot n by the V2X reception UE.—For example, when the start PRB index of PSCCH in slot n−K is M, the start PRB index of PSFCH in slot n may be the same M. As another example, when the start PRB index of PSCCH in slot n−K is M, the PSFCH in slot n may start at M+offset (or M−offset). In this case, the unit of the offset may be the PRB and be a fixed value identically used by all the V2X UEs or a value set to differ per resource pool. For example, in resource pool 1, 10 may be used as the offset value and, in resource pool 2, 20 may be used as the offset value.

Similar to the above-described example, the last PRB index of PSCCH transmitted in slot n−K by the V2X transmission UE may have a correlation with the start PRB index of PSFCH transmitted in slot n by the V2X reception UE.

The information about how many resource blocks PSFCH is constituted of may use at least one of the methods mentioned in FIGS. 8, 9, and 10, as well as the above-described methods.

FIG. 16 illustrates a case where one piece of sidelink control information is transmitted in one slot, but there may be a case where two pieces of sidelink control information are transmitted in one slot. For example, when sidelink control information is split into two groups, the first sidelink control information may include essential information (e.g., information related to sensing operation and destination ID) and may further include time/frequency/code resource allocation information where the second sidelink control information for decoding the second sidelink control information is transmitted. The second sidelink control information may include time/frequency/code resource allocation information about the sidelink data channel for decoding the sidelink data channel. In such a case, the start PRB index of PSFCH may be associated with the start PRB index (or last PRB index) of the PSCCH where the first sidelink control information is transmitted. As another example, the start PRB index of PSFCH may be associated with the start PRB index (or last PRB index) of the PSCCH where the second sidelink control information is transmitted.

The HARQ-ACK/NACK information transmitted by one V2X reception UE in groupcast or unicast communication may be transmitted through one PSFCH resource or through two PSFCH resources. When transmitted through one PSFCH resource, the aforementioned methods may apply. However, when transmitted through two PSFCH resources (i.e., one PSFCH resource is used for HARQ-ACK transmission, and the other PSFCH resource is used for HARQ-NACK transmission), a method for indicating the start points of the two PSFCH resources may be required.

When the two PSFCH resources are contiguously present, the start PRB index of the first PSFCH resource may be derived from the start PRB index of PSCCH as described above. In other words, the start PRB index of the first PSFCH resource may be M or M+offset (or M−offset) in an example. Further, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be M+[X1] or M+offset+[X1] (or M−offset−[X1]). In this case, [X1] may use a fixed value or be set from the base station or V2X transmission UE.

When the two PSFCH resources are not contiguous, the start PRB index of the first PSFCH resource may be derived from the start PRB index of PSCCH, and the start PRB index of the second PSFCH resource may be set through a separate offset as described above. For example, the start PRB index of the first PSFCH resource may be M or M+offset1 (or M−offset1) in the example. The start PRB index of the second PSFCH resource may be M+offset2 or M+offset1+offset2 (or M−offset1-offset2). In this case, offset1 may mean the difference between the start PRB index of PSCCH and the start PRB index of PSFCH, and offset2 may mean the difference between the start PRB index of the first PSFCH resource and the start PRB index of the second PSFCH resource.

As another example, the start PRB index of the second PSFCH resource may be M+[X1]+offset2 or M+offset1+[X1]+offset2 (or M−offset1-[X1]-offset2). In this case, [X1] means the number of PRBs constituting the first PSFCH resource, and [X1] may use a fixed value or be set from the base station or V2X transmission UE. Further, in the example, offset1 may mean the difference between the start PRB index of PSCCH and the start PRB index of PSFCH. Further, offset2 may mean the difference between the start PRB index of the first PSFCH resource and the start PRB index of the second PSFCH resource.

Although not mentioned in FIG. 16, one of the methods mentioned in FIGS. 13B, 13C, and 13D may be applied to FIG. 16.

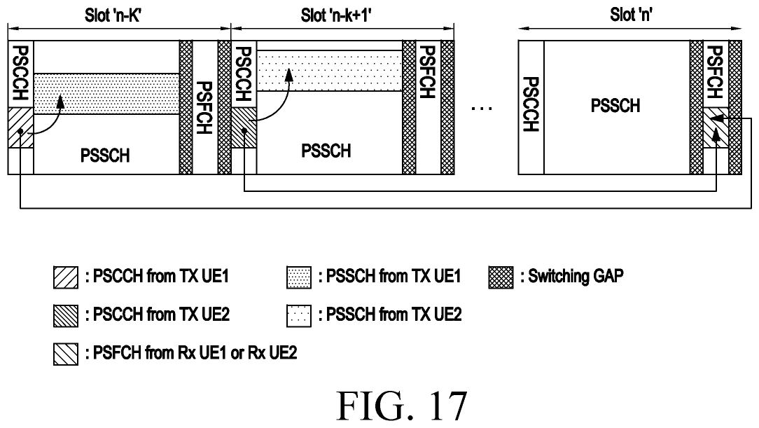

FIG. 17 is a view illustrating another example of a frequency resource allocation of a sidelink feedback channel according to an embodiment of the disclosure.

FIG. 17 illustrates a case in which the start PRB indexes of PSCCH transmitted by different V2X transmission UEs are the same. In other words, it is the case where the start PRB index of PSCCH transmitted by V2X transmission UE 1 to V2X reception UE 1 in slot n−K is the same as the start PRB index of PSCCH transmitted by V2X transmission UE 2 to V2X reception UE 2 in slot n−K+1. Since the PSCCHs transmitted in different slots use the same start PRB index, if the methods described in connection with FIG. 16 apply as they are, the start PRB indexes of PSFCH are identical, so that collision may occur between the PSFCHs. This issue may arise not only when different V2X transmission UEs transmit PSCCH to different V2X reception UEs btu also when different V2X transmission UEs transmit PSCCH to the same V2X reception UE as shown in FIG. 17 (i.e., when PSCCH/PSSCH transmitted by V2X transmission UE 1 and PSCCH/PSSCH transmitted by V2X transmission UE 2 are transmitted to V2X transmission UE 1). One of the following methods may be used to address such PSFCH collision issue.

Method 1) The start PRB index of PSCCH and V2X UE ID indicate the start PRB index of PSFCH

Method 1-1) Using source ID

Method 1-2) Using destination ID

Method 2) The start PRB index of PSCCH and the index of the slot where PSSCH is transmitted indicate the start PRB index of PSFCH

Specific operations of the above-described methods are the same as the operations mentioned in FIG. 11.

Although not mentioned in FIG. 17, one of the methods mentioned in FIGS. 13B, 13C, and 13D may be applied to FIG. 17.

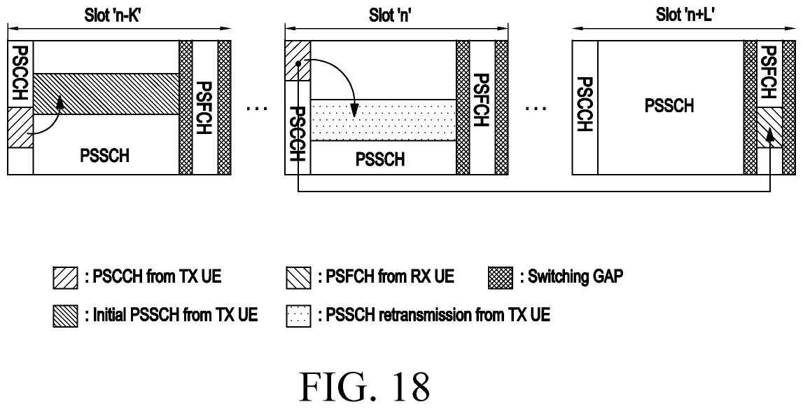

FIG. 18 is a view illustrating another example of a frequency resource allocation of a sidelink feedback channel according to an embodiment of the disclosure.

FIG. 18 illustrates a case where the same TB is repeatedly transmitted through two or more slots by slot aggregation or blind retransmission unlike FIGS. 16 and 17. As described in connection with FIG. 16, FIG. 18 illustrates that the start PRB index of the last PSCCH transmitted by the V2X transmission UE (or the last PRB index of the last PSCCH) may be associated with the start PRB index of the PSFCH transmitted by the V2X reception UE.

More specifically, in FIG. 18, the V2X transmission UE may transmit PSCCH and PSSCH in n−K slot and repeatedly transmit it in slot n. The V2X reception UE may decode PSCCH to obtain sidelink control information and obtain information about time/frequency/code resources of PSSCH therefrom. Further, the V2X reception UE may obtain information about the redundancy version (RV) and new data indicator (NDI) from the sidelink control information. The V2X reception UE may be aware whether the TB transmitted in slot n is a new TB or a repeated transmission of the TB transmitted in slot n−K from the information.

Further, the V2X transmission/reception UE may be configured with information about the number of aggregated slots (when slot aggregation is configured) or the maximum number of repeated transmissions (when blind retransmission is reconfigured). Through the information, the V2X transmission UE and the V2X reception UE may figure out whether the slot where the last PSSCH of a specific TB is transmitted or the PSSCH in the corresponding slot is the last slot.

Accordingly, as shown in FIG. 18, when the start PRB index of the PSCCH in slot n is M, the start PRB index of the PSFCH in slot n+L may be the same M. As another example, when the start PRB index of PSCCH in slot n is M, the PSFCH in slot n+L may start at M+offset (or M−offset). In this case, the unit of the offset may be the PRB and be a fixed value identically used by all the V2X UEs or a value set to differ per resource pool. For example, in resource pool 1, 10 may be used as the offset value and, in resource pool 2, 20 may be used as the offset value.

Similar to the above-described example, the last PRB index of PSCCH transmitted in slot n by the V2X transmission UE may have a correlation with the start PRB index of PSFCH transmitted in slot n+L by the V2X reception UE.

Meanwhile, FIG. 18 illustrates that PSCCH and PSSCH are transmitted in the same slot, but is not limited thereto. The information about how many resource blocks PSFCH is constituted of may use at least one of the methods mentioned in FIGS. 10, 11, 14, and 15, as well as the above-described methods.

FIG. 18 illustrates a PSSCH repeatedly transmitted through two or more slots (repeated transmission through blind retransmission or repeated transmission through slot aggregation). In this case, the PSCCH including control information about the corresponding PSSCH may be together transmitted in the slot where the PSSCH is transmitted. In FIG. 12, since the start PRB index of the last PSCCH transmitted is associated with the start PRB index of the PSFCH, if the V2X reception UE fails to decode the last PSCCH transmitted in slot n, the V2X reception UE may not obtain the information about the start PRB index of PSFCH. To address such issue, the V2X reception UE may determine the start PRB index of PSFCH using the start PRB index of the last PSCCH that it has received (or it has successfully decoded).

Meanwhile, the PSCCH may be transmitted always in the same frequency position regardless of the number of slots used for slot aggregation or the number of repeated transmissions of PSSCH. In such a case, the V2X reception UE may determine the start PRB index of PSFCH from the start PRB index of PSCCH with respect to any PSCCH among the PSCCHs that it has received (or has successfully decoded).

The HARQ-ACK/NACK information transmitted by one V2X reception UE in groupcast or unicast communication may be transmitted through one PSFCH resource or through two PSFCH resources. When transmitted through one PSFCH resource, the aforementioned methods may apply. However, when transmitted through two PSFCH resources (i.e., one PSFCH resource is used for HARQ-ACK transmission, and the other PSFCH resource is used for HARQ-NACK transmission), a method for indicating the start points of the two PSFCH resources may be required.

When the two PSFCH resources are contiguously present, the start PRB index of the first PSFCH resource may be derived from the start PRB index of PSSCH as described above. In other words, the start PRB index of the first PSFCH resource may be M or M+offset (or M−offset) in an example. Further, the start PRB index of the second PSFCH resource may be determined depending on the number of PRBs constituting the first PSFCH resource. For example, if it is assumed that the number of PRBs constituting the first PSFCH resource is [X1], the start PRB index of the second PSFCH resource may be M+[X1] or M+offset+[X1] (or M−offset−[X1]). In this case, [X1] may use a fixed value or be set from the base station or V2X transmission UE.

When the two PSFCH resources are not contiguous, the start PRB index of the first PSFCH resource may be derived from the start PRB index of PSCCH, and the start PRB index of the second PSFCH resource may be set through a separate offset as described above. For example, the start PRB index of the first PSFCH resource may be M or M+offset1 (or M−offset1) in the example. The start PRB index of the second PSFCH resource may be M+offset2 or M+offset1+offset2 (or M−offset1−offset2). In this case, offset1 may mean the difference between the start PRB index of PSCCH and the start PRB index of PSFCH, and offset2 may mean the difference between the start PRB index of the first PSFCH resource and the start PRB index of the second PSFCH resource.

As another example, the start PRB index of the second PSFCH resource may be M+[X1]+offset2 or M+offset1+[X1]+offset2 (or M−offset1−[X1]−offset2). In this case, [X1] means the number of PRBs constituting the first PSFCH resource, and [X1] may use a fixed value or be set from the base station or V2X transmission UE. Further, in the example, offset1 may mean the difference between the start PRB index of PSCCH and the start PRB index of PSFCH. Further, offset2 may mean the difference between the start PRB index of the first PSFCH resource and the start PRB index of the second PSFCH resource.

Although not mentioned in FIG. 18, one of the methods mentioned in FIGS. 13B, 13C, and 13D may be applied to FIG. 18.

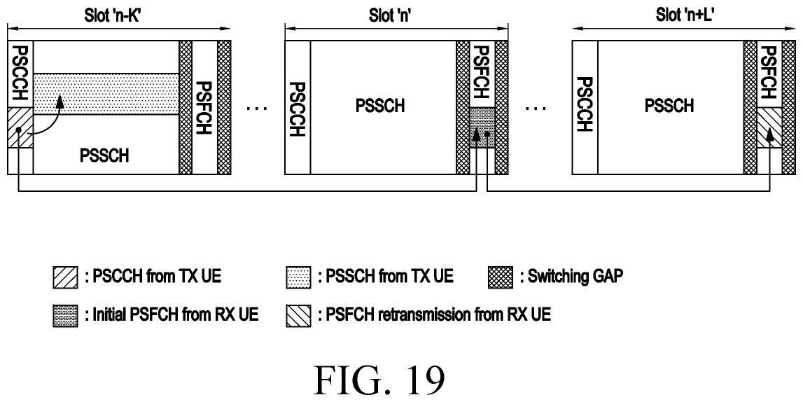

FIG. 19 is a view illustrating another example of a frequency resource allocation of a sidelink feedback channel according to an embodiment of the disclosure.

Unlike FIGS. 16, 17, and 18, FIG. 19 illustrates a case where the PSFCH is repeatedly transmitted. This case may be the same in that the start PRB index (or last PRB index) of the PSCCH may denote the start PRB index of PSFCH initially transmitted through one of the methods described in connection with FIGS. 16, 17, and 18.

In FIG. 19, it may be assumed that the number of PSFCH repeated transmissions is previously known to the V2X transmission UE receiving PSFCH and the V2X reception UE transmitting PSFCH. For example, the number of repeated transmissions of PSFCH may be included in the resource pool configuration information and be configured by the base station or, when the base station is absent (i.e., in the case of out-of-coverage), be preconfigured.

Therefore, as a method for configuring the start PRB index of the Xth transmitted PSFCH (where X is an integer larger than 1), one of the following methods may be used.

As an example, the same PRB index as the start PRB index of the initially transmitted PSFCH may be used. As another example, if an offset has been applied to determining the start PRB index of the initially transmitted PSFCH, the corresponding offset may apply likewise. More specifically, when the start PRB index of the initially transmitted PSFCH is M+offset (or M−offset), the start PRB index of the second transmitted PSFCH may be M+offset+offset (or M−offset-offset). In the above-described example, M means the start PRB index or last PRB index of the PSCCH.

As another example, a different offset value may be used every PSFCH transmission. In other words, when the start PRB index of the initially transmitted PSFCH is M+offset 1 (or M−offset 1), the start PRB index of the second transmitted PSFCH may be M+offset 1+offset 2 (or M−offset 1−offset 2). In this case, offset 1 and offset 2 may be configured by the base station or, when the base station is absent (i.e., in the case of out-of-coverage), pre-configured.

As the number of PRBs constituting the PSFCH, the same value may be used for initial transmission and retransmission of PSFCH. As another example, the number of PRBs used for PSFCH initial transmission and the number of PRBs used for PSFCH retransmission may differ from each other. For example, when the number of PRBs used for initial transmission is Y1, the number of PRBs of the second transmitted PSFCH may be Y1+Z1. In this case, Z1 may be a fixed value or configured by the base station or pre-configured. The number of PRBs of the third transmitted PSFCH may be Y1+Z1+Z2. In this case, Z2 may be the same value as Z1 or may be a different value from Z1. Likewise, Z2 may be a fixed value or configured by the base station or pre-configured. The aforementioned methods may also be applied to the number of PRBs of the fourth transmitted PSFCH.

The index of the start PRB mentioned in FIGS. 10, 11, 14, 15, 16, 17, 18, and 19 may mean the start index of the subchannel or the lowest CCE index. In this case, the subchannel means a set of contiguous PRBs or a set of non-contiguous PRBs and may be interpreted as a resource block group (RBG). Further, CCE means the control channel component constituting the control channel, and one CCE may be constituted of N PRBs. In this case, N may be an integer larger than 1.

In FIGS. 10, 11, 14, 15, 16, 17, 18, and 19, methods for allocating frequency resources of the PSFCH through the start PRB index of the PSFCH and the number of PRBs constituting the PSFCH are described. However, when the number of PRBs constituting the PSFCH is always fixed, frequency resources of the PSFCH may be allocated through the start PRB index of the PSFCH or the last PRB index of the PSFCH. In this case, the start index of the PRB may be interpreted as the start index of the subchannel or the lowest CCE index.

Although not mentioned in FIG. 19, one of the methods mentioned in FIGS. 13B, 13C, and 13D may be applied to FIG. 19.

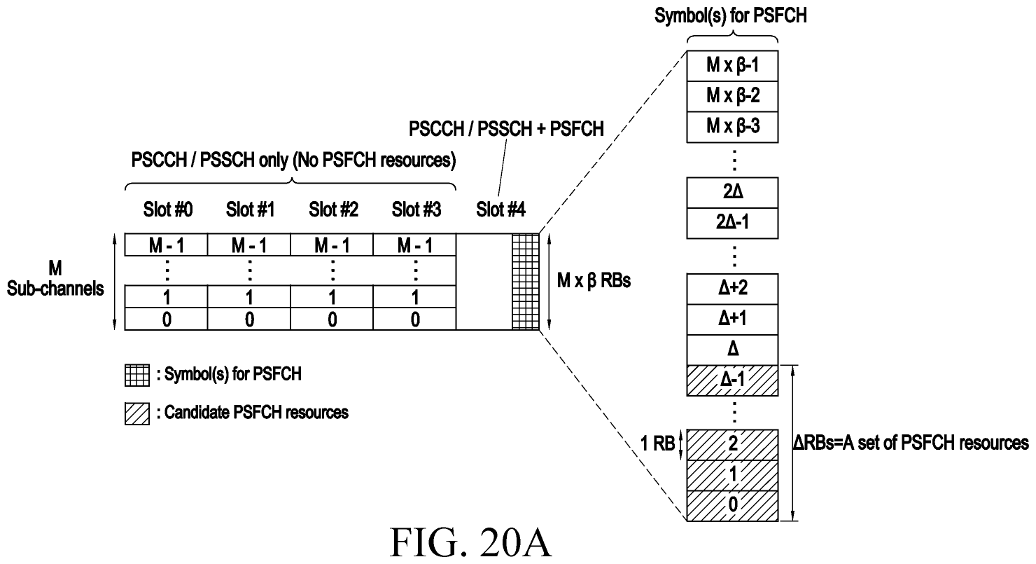

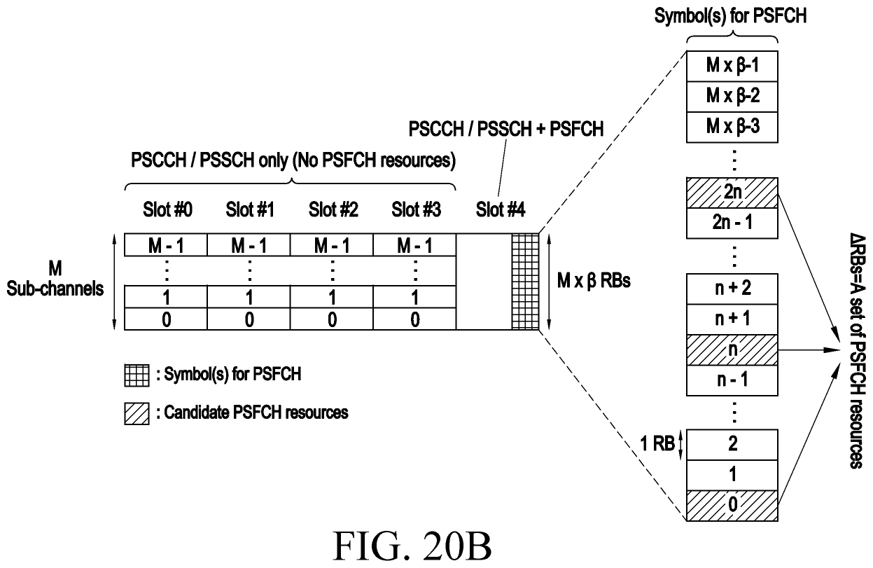

FIGS. 20A and 20B are views illustrating another example of a frequency resource allocation of a sidelink feedback channel according to an embodiment of the disclosure.

FIGS. 20A and 20B are more concrete views of FIGS. 13B, 13C, and 13D. In FIGS. 20A and 20B, M means the number of subchannels of the PSSCH constituting one sidelink bandwidth part (BWP) present in the sidelink bandwidth or the sidelink bandwidth. In this case, one PSSCH subchannel may be constituted of one or more frequency blocks (RBs) and, as defined in FIGS. 13B and 13C, the number of the RBs constituting one PSSCH subchannel may be defined as P. In this case, P may have one value among 10, 15, 20, 50, 75, and 100. As described in FIGS. 6 to 7, may be obtained as the sidelink UE receives resource pool information (in other words, information about the number of RBs constituting the PSSCH subchannel may be included in the resource pool configuration information). Further, as defined in FIGS. 13B and 13C, the number of RBs constituting the PSFCH transmitted by one reception UE may be defined as Y. Y may be 1 or one among integers larger than 1 (e.g., 2, 4, etc.), and may be configured in the sidelink resource pool information like β or, unlike β, may always use a fixed value in all resource pools without separate configuration (e.g., in all resource pools, γ=1).

Further, as described in connection with FIGS. 12, 13B, 13C, and 13D, the PSFCH transmission resource (or PSFCH reception resource, which is referred to below as PSFCH resource) may be preset every N slots, where N may be one of 1, 2, and 4). For example, N=1 may mean that PSFCH resources are present every sidelink slot, and N=2 and N=4, respectively, may mean that PSFCH resources are present every two sidelink slots (N=2) and that PSFCH resources are present every four sidelink slots (N=4). Further, as described in connection with FIG. 12, the minimum difference between the time of reception of PSCCH/PSSCH by the reception UE from the transmission UE and the time of transmission of PSFCH to the transmission UE by the reception UE may be defined as K slots, which may mean the minimum time required for the reception UE to receive sidelink control information (PSCCH) from the transmission UE, decode sidelink data (PSSCH), and prepare to transmit sidelink feedback channel. In other words, K may be required to be determined with a sufficient margin considering the UE's signal processing capability. As an example, K may be one of 1, 2, and 3, and K=1 may be supported by UEs having fast signal processing capability (i.e., having high signal processing capability), and K=3 may be supported by UEs having slow signal processing capability (i.e., having low signal processing capability). K=1 may mean that, when the reception UE receives PSCCH/PSSCH in sidelink slot index n, the reception UE should transmit PSFCH in slots after sidelink slot index n+1. Further, K=2 and K=3 may mean that, when the reception UE receives PSCCH/PSSCH in sidelink slot index n, the reception UE should transmit PSFCH in slots after slot index n+2 (K=2) and slots after sidelink slot index n+3 (K=3).

N and K described above may be set to one value for each sidelink resource pool, and N and K may be set to a different value for each resource pool. For example, in resource pool 1, N=N1 and K=K1 and, in resource pool 2, values of N=N2 and K=K2. In this case, N1 and N2 may be the same or different. K1 and K2 may be the same or different. When the sidelink UE is in the in the coverage of the base station, the sidelink UE may be configured with the corresponding information from the base station through system information and RRC. In the case of out-of-coverage where no base station is present, N and K included in preconfigured resource pool information may be used. When N and K are not included in the resource pool configuration information, the transmission UE and reception UE which are to perform sidelink transmission or reception in the corresponding resource pool may not operate sidelink HARQ in the corresponding resource pool.

Meanwhile, the two UEs performing unicast communication may perform negotiation on the UE's signal processing capability and use K corresponding to the negotiation result during the PC5-RRC connection setup process mentioned in FIG. 3. As an example, it may be assumed that UE-A and UE-B to perform unicast communication have fast signal processing capability (capability A or signal processing A1) and slow signal processing capability (capability B or signal processing time B1). When one resource pool capable of performing unicast communication may be configured, and two or more K values are configured in the corresponding resource pool, UE-A and UE-B may negotiate to perform unicast communication using a K value larger than the slowest signal processing capability (capability B or signal processing time B1). As another example, when two or more resource pools capable of performing unicast communication are configured, and one K value is configured in each resource pool, UE-A and UE-B may negotiate to perform unicast communication in the resource pool configured with a K value larger than the slowest signal processing capability (capability B or signal processing time B1). In the above-described examples, there may be a plurality of K values that may meet the slowest signal processing capability (capability B or signal processing time B1) of UE-A and UE-B. In such a case, they may negotiate to perform unicast communication using the smallest K value among the plurality of K values. As another example, when two or more resource pools capable of performing unicast communication are configured, and two or more K values are configured in each resource pool, they may negotiate to perform unicast communication using a K value capable of meeting the slowest signal processing capability (capability B or signal processing time B1) of UE-A and UE-B. In this case, when there are a plurality of K values meeting the slowest signal processing capability (capability B or signal processing time B1) of UE-A and UE-B, they may negotiate to perform unicast communication using the smallest K value among the plurality of K values.

FIG. 20A illustrates an example of the case where N=4 and K=1 are configured in the sidelink resource pool information, and reception UE-A receiving PSCCH/PSSCH in sidelink slot index 0 may transmit PSFCH in a slot after sidelink slot index 1 (K=1). In this case, since PSFCH resources are present only in slot index 4 (N=4), reception UE-A may transmit PSFCH in slot index 4. As another example, reception UE-B receiving PSCCH/PSSCH in sidelink slot index 1 may transmit PSFCH in a slot after sidelink slot index 2 (K=1). In this case, since PSFCH resources are present only in slot index 4 (N=4), reception UE-B may transmit PSFCH in slot index 4 like reception UE-A. As another example, reception UE-C receiving PSCCH/PSSCH in slot index 2 may transmit PSFCH in a slot after sidelink slot index 3 (K=1). In this case, since PSFCH resources are present only in slot index 4 (N=4), reception UE-C may transmit PSFCH in slot index 4 like reception UE-A and reception UE-B. As another example, reception UE-D receiving PSCCH/PSSCH in slot index 3 may transmit PSFCH in a slot after sidelink slot index 4 (K=1). In this case, since PSFCH resources are present only in slot index 4 (N=4), reception UE-D may transmit PSFCH in slot index 4 like reception UE-A, reception UE-B, and reception UE-C.

As described above, no PSFCH resource is present in slot indexes 0, 1, 2, and 3, and PSFCH resources may be present only in slot index 4. FIGS. 20A and 20B illustrate that a PSFCH symbol present in slot index 4 (when the PSFCH is constituted of one symbol) or PSFCH symbols (when the PSFCH is constituted of two or more symbols) are positioned in the sidelink bandwidth or an entire sidelink BWP in the sidelink bandwidth. Therefore, the PSFCH symbol(s) on the frequency axis may be constituted of M×β RBs. The number of symbol(s) constituting the PSFCH on the time axis may be included in resource pool information as described in FIGS. 9A and 9B and be configured explicitly or implicitly. When the number of symbol(s) constituting the PSFCH is explicitly configured in the resource pool information, such as 1, 2 or 3, the structure of the PSFCH transmitted by one reception UE may be as shown in FIGS. 9A and 9B. The number of symbol(s) constituting the PSFCH may be implicitly configured in the resource pool information through whether the PSFCH is repeatedly transmitted or the number of repeated transmissions. For example, when the default number of PSFCH symbols on the time axis is defined as 1, if repeated transmission is configured in the resource pool information, it may mean that the number of PSFCH symbols transmitted by the reception UE in the corresponding resource pool is 2. If repeated transmission is not configured in the resource pool information, it may mean that the number of PSFCH symbols transmitted by the reception UE in the corresponding resource pool is 1. Similarly, when the number of PSFCH symbols on the time axis is defined as 2, if repeated transmission is configured in the resource pool information, it may mean that the number of PSFCH symbols transmitted by the reception UE in the corresponding resource pool is 4. If repeated transmission is not configured in the resource pool information, it may mean that the number of PSFCH symbols transmitted by the reception UE in the corresponding resource pool is 2. As another example, when the default number of PSFCH symbols on the time axis is defined as 1, if the number of repeated transmissions=2 is configured in the resource pool information, it may mean that the number of PSFCH symbols transmitted by the reception UE in the corresponding resource pool is 2. If the number of repeated transmissions=4 is configured in the resource pool information, it may mean that the number of PSFCH symbols transmitted by the reception UE in the corresponding resource pool is 4. If repeated transmission is not configured in the resource pool information or the number of repeated transmissions=0 is configured, it may mean that the number of PSFCH symbols transmitted by the reception UE in the corresponding resource pool is 1.

Meanwhile, although not shown in FIGS. 20A and 20B, a case where PSFCH symbol(s) are positioned in the sidelink bandwidth or a portion of sidelink BWP on the frequency axis may also be considered. Further, although not shown in FIGS. 20A and 20B, slot 4 may include a GAP as described in connection with FIG. 7.

As described above, the reception UE receiving PSCCH and PSSCH in at least one slot among slot indexes 0, 1, 2, and 3 of FIGS. 20A and 20B may transmit sidelink HARQ feedback to the transmission UE using at least one of the PSFCH resources configured in slot 4. In this case, the mapping relationship between PSSCH resource and PSFCH resource shown in FIGS. 13B, 13C, and 13D (or mapping relationship between PSCCH resource and PSFCH resource) may apply. In other words, the reception UE may obtain the position of PSFCH frequency resource which it is to transmit (or start point of PSFCH frequency resource) through a combination of the index of the slot where the PSSCH is received and the start index of the subchannel where the PSSCH is received. Further, the transmission UE may obtain information about the position of the PSFCH frequency resource that it is to receive (or start point of the PSFCH frequency resource) through a combination of the index of the slot where the PSSCH is transmitted and the start index of the subchannel where the PSSCH is transmitted (or the index of the start subchannel).

In the above-described mapping relationship between PSSCH resource and PSFCH resource or the mapping relationship between PSSCH resource and PSFCH resource described in connection with FIGS. 13B, 13C, and 13D, it has been described that the slot index of the PSSCH and the index of the start subchannel may be associated with the position of the PSFCH frequency resource that is to be actually transmitted (or to be actually received). More generally, as shown in FIGS. 20A and 20B, the slot index of PSSCH and the index of the start subchannel may be associated with candidate PSFCH resources constituted of one or more PSFCH frequency resources, rather than the position of the PSFCH frequency resource to be actually transmitted (or to be actually received) (or the start point of the PSFCH frequency resource). In this case, if the number of PSFCH candidates is one, the above-described mapping relationship between PSSCH resource and PSFCH frequency resource or the mapping relationship between PSSCH resource and PSFCH frequency or code (or frequency and code) resource described in connection with FIGS. 13B, 13C, and 13D may be the same. In contrast, if the number of PSFCH candidates is two or more, the time and frequency resource of one PSSCH may be associated with frequency or code (or frequency and code) resources of a plurality of PSFCH candidates.

More specifically, as shown in FIG. 20A, a set of candidate PSFCH frequency resources constituted of Δ PSFCH resources may be considered. For convenience of description, the candidate PSFCH frequency resources constituted of PSFCH frequency resource indexes 0 to Δ−1 may be defined as candidate PSFCH frequency resource set index 0. The candidate PSFCH frequency resources constituted of PSFCH frequency resource indexes Δ to 2Δ−1 may be defined as candidate PSFCH frequency resource set index 1. Generally, there may be a total of

$$\frac{( M \times β )}{Δ}$$

candidate PSFCH frequency resource sets constituted of Δ PSFCH resources, from index 0 to index

$$\frac{( M \times β )}{Δ} - 1$$

with respect to the slowest frequency (or highest frequency). However, such indexing is an example and, as described in connection with FIGS. 13B, 13C, and 13D, the start index of the candidate PSFCH frequency resource set may not be 0 depending on the configured (or preconfigured or fixed) offset value. For example, when the offset is 3, the set of the candidate PSFCH frequency resources constituting indexes 3Δ to 3Δ−1 may correspond to candidate PSFCH frequency resource set index 0.

The start index of the above-described candidate PSFCH frequency resource set (or indexes of candidate start PSFCH frequency resources) and PSSCH slot index and start subchannel index (or start index of subchannel) may have the following correlation. The PSSCH received in start subchannel index m (or start index m of subchannel) of slot index 1 may denote the start point of the candidate PSFCH frequency resource set constituted of Δ PSFCH candidates. As an example, according to the mapping relationship between PSSCH resource and PSFCH frequency resource described in connection with FIG. 13B, the PSSCH transmitted in start subchannel index 0 (or start index 0 of subchannel) of slot index 0 in FIG. 20A may denote candidate PSFCH frequency resource set index 0 constituted of PSFCH frequency resource indexes 0 to Δ−1 in slot index 4. The PSSCH transmitted in start subchannel index 1 (or start index 1 of subchannel) of slot index 0 may denote candidate PSFCH frequency resource set index 1 constituted of PSFCH frequency resource indexes Δ and 2Δ−1 in slot index 4.

In the above examples, it has been described that slot index 0 of the PSSCH and start subchannel index 0 (or start index 0 of subchannel) are associated with candidate PSFCH frequency resource set index 0. However, as mentioned above, PSSCH slot index 0 and start subchannel index 0 (or start index 0 of subchannel) may be associated with candidate PSFCH frequency resource set index Q depending on a configured (or preconfigured or fixed) offset value. Generally, it may mean that PSSCH slot index 1 and start subchannel index m (or start index m of subchannel) may be associated with candidate PSFCH frequency resource set index δ. In this case, as described above, Δ candidate PSFCH frequency resources may be present in the candidate PSFCH frequency resource set having index δ. The Δ value may be included in the resource pool information configured through RRC or system information by the base station. In the case of out-of-coverage where no base station is present, the Δ value may be included in preconfigured resource pool information.

Meanwhile, the Δ value which means PSFCH frequency resources constituting one candidate PSFCH frequency resource set described above may use an always fixed value, rather than included in the resource pool configuration information. For example, the Δ value may be defined as a function of β (the number of RBs constituting the PSSCH subchannel) described above and γ (the number of RBs constituting the PSFCH used by one UE for transmission or reception of one PSFCH) described above. For example,

$$Δ = floor ( \frac{β}{γ} )$$

may be defined, and in this case, floor( ) may be a function that means rounding down to the decimal point. As another example,

$$Δ = ceil ( \frac{β}{γ} )$$

may be defined, and in this case, ceil( ) may be a function that means rounding up to the decimal point. In this case, separate signaling for configuring the Δ value in the resource pool information may be omitted.

FIG. 20A illustrates that the PSFCH frequency resources constituting one candidate PSFCH frequency resource set are contiguously positioned in one candidate PSFCH frequency resource set. In contrast, FIG. 20B illustrates that the PSFCH frequency resources constituting one candidate PSFCH frequency resource set are non-contiguously positioned in one candidate PSFCH frequency resource set. For example, in FIG. 20B, Δ PSFCH frequency resources having PSFCH frequency resource indexes 0, n, 2n, . . . , (Δ−n) may constitute one candidate PSFCH frequency resource set. In this case, each PSFCH frequency resource may have offset ‘n’ which may be configured in the resource pool information. When offset n=1, FIG. 20B may be the same as FIG. 20A. Accordingly, various embodiments described in FIG. 20A may also be applied to FIG. 20B.

In FIGS. 20A and 20B, the reception UE, which determines the index of one candidate PSFCH frequency resource set constituted of Δ PSFCH frequency resources through the slot index of PSSCH and the index of start subchannel (or start index of subchannel), may transmit PSFCH to the transmission UE using at least one PSFCH frequency resource among Δ PSFCH frequency resources. In this case, there may be various methods for the reception UE to select PSFCH frequency resources, and one or a combination of two or more of at least one methods below may be used.

As an example, as mentioned in FIG. 13D, the reception UE may select one PSFCH frequency resource to actually transmit among Δ PSFCH frequency resources through the source ID. More specifically, one PSFCH frequency resource may be selected through modulo operation of the source ID and Δ. In this case, as described in connection with FIG. 11, the source ID may be constituted of [Y] bits, and be included in the MAC PDU where [Y1] bits of the source ID are transmitted through PSCCH, and the remaining [Y2] bits are transmitted through PSSCH. The source ID used in the above-described modulo operation may mean the [Y] bits or the [Y1] bits transmitted through the PSCCH.

As another example, the reception UE may randomly select one PSFCH frequency resource to actually transmit among Δ PSFCH frequency resources.

As another example, the reception UE may select one PSFCH frequency resource having the lowest (or highest) index, as the PSFCH frequency resource to actually transmit, from among the Δ PSFCH frequency resources.

In the above examples, a case where the reception UE selects one PSFCH frequency resource from among the Δ PSFCH frequency resources, but is not limited thereto. For example, the reception UE may select two or more PSFCH frequency resources from among the Δ PSFCH frequency resources. In this case, the examples of selecting one PSFCH frequency resource described above may be extended.

For example, upon selecting a plurality of PSFCH frequency resources based on the source ID, the reception UE may select one PSFCH frequency resource through the above-described modulo operation and select contiguous PSFCH frequency resources based thereon. In other words, upon selecting PSFCH frequency resource index 6 through modulo operation based on the source ID, the reception UE mays elect a plurality of PSFCH frequency resources in the order of indexes 6, 7, 8, . . . (in ascending order). Or, the reception UE may select a plurality of PSFCH frequency resources in the order of indexes 6, 5, 4, . . . (in descending order).

Upon randomly selecting a plurality of PSFCH frequency resources, the reception UE may randomly select one PSFCH frequency resource and select contiguous PSFCH frequency resources based thereon. In other words, upon selecting PSFCH frequency resource index 6 by random selection, the reception UE may select a plurality of PSFCH frequency resources in the order of indexes 6, 7, 8, . . . (in ascending order), or the reception UE may select a plurality of PSFCH frequency resources in the order of indexes 6, 5, 4, . . . (in descending order). As another example of randomly selecting a plurality of PSFCH frequency resources, the reception UE may randomly select a plurality of PSFCH frequency resources from among the Δ PSFCH frequency resources.

Upon selecting a plurality of PSFCH frequency resources with respect to the lowest (or highest) index among the A, the reception UE may select a plurality of PSFCH frequency resources in ascending order or descending order of index with respect to the selected lowest (or highest) index.

Meanwhile, it may be required to determine whether to transmit one PSFCH through one PSFCH frequency resource among the Δ PSFCH frequency resources or to transmit two or more PSFCHs through two or more PSFCH frequency resources. As an example, in the slot where PSFCH resources are configured (i.e., slot index 4 in FIGS. 20A and 20B), it may be associated with the number of HARQ-ACK and/or HARQ-NACK bits to be transmitted by the reception UE. More specifically, when the number of HARQ-ACK and/or HARQ-NACK bits to be transmitted by the reception UE is 1, one PSFCH may be transmitted through one PSFCH frequency resource. When the number of HARQ-ACK and/or HARQ-NACK bits to be transmitted by the reception UE is 2, two PSFCHs may be transmitted through two PSFCH frequency resources.

As another example, the number of PSFCHs to be transmitted by one reception UE may be configured in the resource pool information. The reception UE may select as many PSFCH frequency resources as the number of the configured PSFCHs through the above-described source ID, random selection, or lowest (or highest) frequency index and transmit HARQ feedback.

In the above-described examples, a method for determining the index of a candidate PSFCH frequency resource set constituted of PSFCH frequency resources for PSSCH slot index and start subchannel index (or start index of subchannel) has been primarily described. However, this may be extended to a method for determining the index of a candidate PSFCH code resource set constituted of A PSCCH code resources for PSSCH slot index and start subchannel index (or start index of subchannel).

Meanwhile, the above-described PSFCH frequency resource selection method may be used in HARQ operation option 1 of unicast communication and groupcast communication described in connection with FIG. 13D. This is why, as mentioned in FIG. 13D, HARQ operation option 2 of groupcast communication requires that each of the reception UEs participating in groupcast communication transmit HARQ feedback to the transmission UE, requiring as many PSFCH frequency and/or code resources as the number of the reception UEs. In other words, the transmission UE may be required to determine what reception UE the HARQ feedback received from different reception UEs in the group has been transmitted from, and one of the following methods may be considered.

For example, as mentioned in FIG. 13D, the higher layer in groupcast communication may provide group information for groupcast communication. In this case, as mentioned in FIG. 13D, the group information may include at least one the number of group members participating in the groupcast communication and the group IDs. More specifically, upon selecting one PSFCH frequency resource based on group information, as exemplified in FIG. 13D, the reception UE mays elect one PSFCH frequency resource through modulo operation of the group ID and number of group members and transmit HARQ feedback in the corresponding PSFCH frequency resource. Upon selecting a plurality of PSFCH frequency resources, the reception UE may select one PSFCH frequency resource through the above-described modulo operation and select contiguous PSFCH frequency resources based thereon. In other words, upon selecting PSFCH frequency resource index 6 through modulo operation of group ID and number of group members, the reception UE mays elect a plurality of PSFCH frequency resources in the order of indexes 6, 7, 8, . . . (in ascending order). Or, the reception UE may select a plurality of PSFCH frequency resources in the order of indexes 6, 5, 4, . . . (in descending order). The above-described example may be extended to the case of selecting one PSFCH code resource or a plurality of PSFCH code resources.

Meanwhile, the above-described group information-based PSFCH frequency (or code) resource selection method, along with the method for selecting one PSFCH or a plurality of PSFCHs based on the source ID, random selection, or lowest (or highest) frequency index, may be operated as follows. As an example, the reception UE may select one PSFCH frequency resource through modulo operation of group ID and number of group members and select one PSFCH code resource based on the source ID, random selection, or lowest (or highest) code index. The reception UE may transmit the selected PSFCH frequency resource using the code that it selects.

As another example, the reception UE may select one PSFCH frequency resource based on the source ID, random selection, or lowest (or highest) frequency index and select one PSFCH code resource through modulo operation of group ID and number of group members. The reception UE may transmit the selected PSFCH frequency resource using the code that it selects.

In the above-described examples, the code resources (or code) may mean resources distinguished using code, such as scrambling code or orthogonal cover code and different sequences (and cyclic shift applied to sequence) as described in connection with FIG. 9.

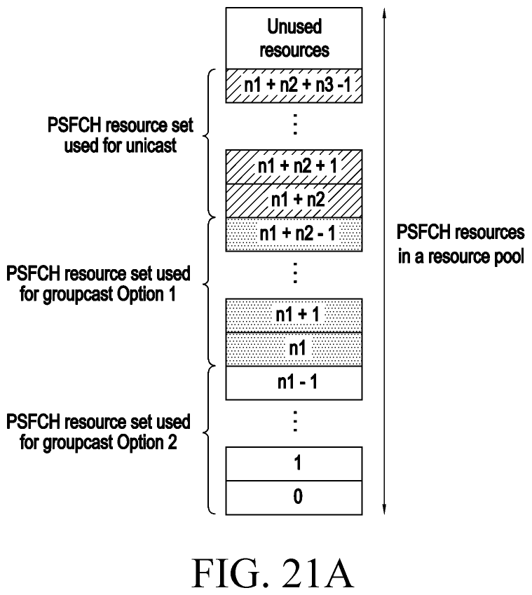

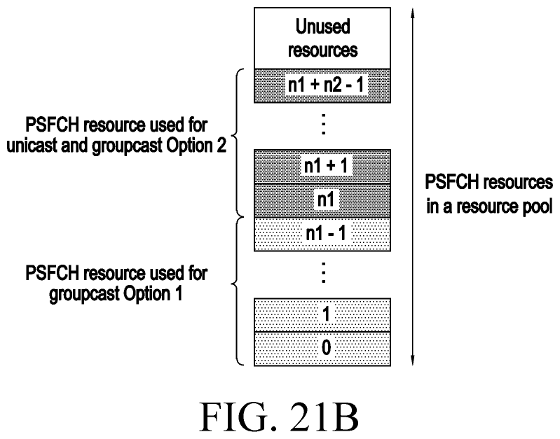

FIGS. 21A and 21B are views illustrating another example of a frequency resource allocation of a sidelink feedback channel according to an embodiment of the disclosure.

As mentioned in FIGS. 9A, 9B to 13D, groupcast communication may have two options depending on sidelink HARQ operation (option 1 and option 2). Meanwhile, as mentioned in FIG. 4, unicast, groupcast, and broadcast communication may be performed in one resource pool. As an example, in resource pool A, UE 1 and UE 2 may perform unicast communication after performing a PC-5 RRC connection setup procedure as exemplified in FIG. 4. In the same resource pool A, UE 3 may perform groupcast communication with the other UEs, and UE 4 may perform broadcast communication with the other UEs. As another example, one UE may perform two or more of unicast, groupcast, and broadcast communication with the same UE or different UEs.

In various scenarios described above, different interferences may be caused with the transmission UE receiving PSFCH depending on PSFCH transmission methods by reception UEs transmitting PSFCH. More specifically, in the case of groupcast HARQ option 1 as described in connection with FIGS. 9A and 9B to 13D, the reception UEs transmitting PSFCH in the same group may transmit NACK using the same time/frequency or the same time/frequency/code resources. In other words, each reception UE in the same group may transmit one sequence which means HARQ NACK, and the receiver of the transmission UE, receiving it, may receive overlapping sequences from two or more reception UEs. Thus, the reception power strength of the PSFCH received in the corresponding time/frequency resource may increase, interfering with the reception of another PSFCH received at an adjacent frequency at the same time. This may be referred to as in-band emission (IBE), which may seriously deteriorate reception performance of PSFCH. As another example, in the case of groupcast HARQ option 2, the reception UEs transmitting PSFCH at the same time in the same group may technically transmit HARQ-ACK or HARQ-NACK using frequency resources independent from each other. However, if the number of reception UEs transmitting PSFCH in the group increases, frequency division multiplexing (FDM) may not be performed between different PSFCHs due to PSFCH frequency resource shortage issue as mentioned in FIG. 13D. Accordingly, it may be required to perform code division multiplexing (CDM) on some PSFCH resources. In this case, as in groupcast option 1 described above, PSFCH reception performance may be seriously deteriorated due to the IBE issue.

As a method for addressing the IBE issue, the method shown in FIGS. 21A and 21B may be used. More specifically, FIG. 21A illustrates that the PSFCH frequency resource sets available for unicast, groupcast option 1 and groupcast option 2 HARQ feedback transmission in a resource pool where PSFCH resources are configured are divided. Unlike FIG. 21A, FIG. 21B illustrates that the PSFCH frequency resource sets available for unicast communication and groupcast option 1 HARQ feedback transmission are separated from PSFCH frequency resource sets available for groupcast option 2 HARQ feedback transmission.

For example, the PSFCH frequency resource set used for groupcast option 2 HARQ feedback transmission may be constituted of n1 RBs or n1 PSFCH subchannels (indexes 0 to n1−1). Further, the PSFCH frequency resource set used for groupcast option 1 HARQ feedback transmission may be constituted of n2 RBs or n2 PSFCH subchannels (indexes n1 to n1+n2−1). The PSFCH frequency resource set used for unicast communication HARQ feedback transmission may be constituted of n3 frequency blocks (RBs) or n3 PSFCH subchannels (indexes n1+n2 to n1+n2+n3−1). Similarly, FIG. 21B illustrates that the PSFCH frequency resource set used for groupcast option 1 HARQ feedback transmission may be constituted of n1 RBs or n1 PSFCH subchannels (indexes 0 to n1−1), and the PSFCH frequency resource set used for unicast or groupcast option 2 HARQ feedback transmission may be constituted of n2 RBs or n2 PSFCH subchannels (indexes n1 to n1+n2−1).

FIGS. 21A and 21B illustrate that the PSFCH frequency resource sets for unicast, groupcast option 1, and groupcast option 2 HARQ feedback transmission are contiguous on the frequency axis, but this is an example, and the PSFCH frequency resource sets for HARQ feedback transmission may be non-contiguous on the frequency axis.

Meanwhile, it may be assumed that the PSFCH frequency resource in the resource pool is constituted of M RBs as shown in FIG. 7 or the resource pool is constituted of M frequency resources as shown in FIG. 6 (i.e., when the symbols used for PSFCH transmission/reception in the PSFCH-configured resource pool use all of the M RBs). In this case, FIG. 21A illustrates that n1+n2+n3<M, and FIG. 21B illustrates that n1+n2<M. In other words, in FIG. 21A, among the M PSFCH frequency resources, M−(n1+n2+n3) frequency resources may not be used for PSFCH transmission/reception. Further, in FIG. 21B, among the M PSFCH frequency resources, M−(n1+n2) frequency resources may not be used for PSFCH transmission/reception. In such a single resource pool, the unused PSFCH frequency resources may be used for another UE to transmit sidelink control information or data information in the corresponding resource pool or be used for frequency division multiplexing of different PSFCH formats.

In other words, in FIG. 21A, the n1+n2+n3 frequency resources may be used as PSFCH frequency resources for transmission/reception of the PSFCH format transmitted based on sequence described in connection with FIG. 9A or 9B, and the remaining M−(n1+n2+n3) PSFCH frequency resources may be used as PSFCH frequency resources for transmission/reception of another PSFCH format transmitted based on channel coding described in connection with FIG. 9A or 9B. Similarly, in FIG. 21B, the n1+n2 frequency resources may be used as PSFCH frequency resources for transmission/reception of the PSFCH format transmitted based on sequence described in connection with FIG. 9A or 9B, and the remaining M−(n1+n2) PSFCH frequency resources may be used as PSFCH frequency resources for transmission/reception of another PSFCH format transmitted based on channel coding described in connection with FIG. 9A or 9B. Although not shown in FIG. 21A, n1+n2+n3=M, and in FIG. 21B, n1+n2=M. This may mean that all of the M PSFCH frequency resources are allocated (i.e., in the PSFCH symbol, the PSFCH frequency resources may not be frequency-divisioned with sidelink control information and data information) or the same PSFCH format is used in the M PSFCH frequency resources.

Further, in FIGS. 21A and 21B, n1, n2, and n3 may mean the same value or different values. Further, the order of mapping PSFCH frequency resources for groupcast option 2, groupcast option 1, unicast communication HARQ feedback as shown in FIG. 21A is an example, and is not limited thereto. Likewise, the order of mapping PSFCH frequency resources for groupcast option 1, groupcast option 2, and unicast communication HARQ feedback as shown in FIG. 21B is an example, and is not limited thereto.

As mentioned in the examples of FIGS. 10, 11, 13B, 13C, 13D, 14, 15, 16, 17, 18, 19, 20A and 20B, the start point of the PSFCH frequency resource to be transmitted by each reception UE (i.e., the start RB index of PSFCH or the start subchannel index of PSFCH) may be associated with the start RB index (or start subchannel index) of PSCCH or PSSCH transmitted by each transmission UE and/or the slot index of PSCCH or PSSCH transmitted by each transmission UE. Accordingly, in the examples of FIGS. 21A and 21B, information about the start point and end point of the frequency resource set used by the PSFCH (or start point of PSFCH frequency resource set) may be needed for unicast, groupcast option 1 and groupcast option 2 HARQ feedback transmission.

As an example, the PSFCH transmission frequency resource used for unicast HARQ feedback transmission may be determined by the start subchannel index (or start RB index) of PSCCH or PSSCH or the slot index of the PSCCH or PSSCH received by the reception UE as described in connection with FIGS. 13A and 13C. In this case, configuration of an offset value may be required for the UE receiving unicast to transmit PSFCH in the PSFCH frequency resource set (i.e., from index n1+n2 to index n1+n2+n3−1) for unicast communication shown in FIG. 21A. In other words, FIGS. 13B and 13C illustrate that the UE receiving PSCCH or PSSCH in slot index ‘0’ and start subchannel index (or start RB index) ‘0’ transmits a PSFCH having index 0. If the mapping principle of FIG. 13B is applied to FIG. 21A, the UE receiving PSCCH or PSSCH through unicast communication in slot index ‘0’ and start subchannel index (or start RB index) ‘0’ may transmit PSFCH having index n1+n2 (i.e., offset of n1+n2). Further, the UE receiving PSCCH or PSSCH through unicast communication in slot index ‘0’ and start subchannel index (or start RB index) ‘1’ may transmit a PSFCH having index n1+n2+1. Similarly, if the mapping principle of FIG. 13C is applied to FIG. 21A, the UE receiving PSCCH or PSSCH through unicast communication in slot index ‘0’ and start subchannel index (or start RB index) ‘0’ may transmit PSFCH having index n1+n2 (i.e., offset of n1+n2). This may be the same as when the above-described mapping principle of FIG. 13B is applied. However, if the mapping of FIG. 13C is applied, the UE receiving PSCCH or PSSCH through unicast communication in slot index ‘1’ and start subchannel index (or start RB index) ‘0’ may transmit a PSFCH having index n1+n2+1.

Further, the mapping principles of FIGS. 13B and 13C may be applied to FIG. 21B as follows. If the mapping principle of FIG. 13B is applied to FIG. 21B, the UE receiving PSCCH or PSSCH through unicast communication in slot index ‘0’ and start subchannel index (or start RB index) ‘0’ may transmit PSFCH having index n1 (i.e., offset of n1). Further, the UE receiving PSCCH or PSSCH through unicast communication in slot index ‘0’ and start subchannel index (or start RB index) ‘1’ may transmit a PSFCH having index n1+1. Similarly, if the mapping principle of FIG. 13C is applied to FIG. 21B, the UE receiving PSCCH or PSSCH through unicast communication in slot index ‘0’ and start subchannel index (or start RB index) ‘0’ may transmit PSFCH having index n1 (i.e., offset of n1). This may be the same as when the above-described mapping principle of FIG. 13B is applied. However, if the mapping of FIG. 13C is applied, the UE receiving PSCCH or PSSCH through unicast communication in slot index ‘1’ and start subchannel index (or start RB index) ‘0’ may transmit a PSFCH having index n1+1.

The above-described offset value may be included in sidelink resource pool configuration information.

The configuration of the PSFCH transmission frequency resource used for groupcast communication HARQ feedback transmission option 1 may be the same as the configuration of PSFCH transmission frequency resource used for the above-described unicast communication HARQ feedback transmission. In other words, the configuration of PSFCH transmission frequency resource used for groupcast communication HARQ feedback transmission option 1 may be determined by the slot index of PSCCH or PSSCH received by two or more reception UEs and the start subchannel index (or start RB index) of PSCCH or PSSCH. More specifically, if the mapping principle of FIG. 13B is applied to FIG. 21A, the UE receiving PSCCH or PSSCH through groupcast communication option 1 in slot index ‘0’ and start subchannel index (or start RB index) ‘0’ may transmit PSFCH having index n1 (i.e., offset of n1). Further, the UE receiving PSCCH or PSSCH through groupcast communication option 1 in slot index ‘0’ and start subchannel index (or start RB index) ‘1’ may transmit a PSFCH having index n1+1. Similarly, if the mapping principle of FIG. 13C is applied to FIG. 21A, the UE receiving PSCCH or PSSCH through groupcast communication option 1 in slot index ‘0’ and start subchannel index (or start RB index) ‘0’ may transmit PSFCH having index n1 (i.e., offset of n1). This may be the same as when the above-described mapping principle of FIG. 13B is applied. However, if the mapping of FIG. 13C is applied, the UE receiving PSCCH or PSSCH through groupcast communication option 1 in slot index ‘1’ and start subchannel index (or start RB index) ‘0’ may transmit a PSFCH having index n1+1.

Further, the mapping principles of FIGS. 13B and 13C may be applied to FIG. 21B as follows. If the mapping principle of FIG. 13B is applied to FIG. 21B, the UE receiving PSCCH or PSSCH through groupcast communication option 1 in slot index ‘0’ and start subchannel index (or start RB index) ‘0’ may transmit PSFCH having index 0 (i.e., offset of 0). Further, the UE receiving PSCCH or PSSCH through groupcast communication option 1 in slot index ‘0’ and start subchannel index (or start RB index) ‘1’ may transmit a PSFCH having index 1. Similarly, if the mapping principle of FIG. 13C is applied to FIG. 21B, the UE receiving PSCCH or PSSCH through groupcast communication option 1 in slot index ‘0’ and start subchannel index (or start RB index) ‘0’ may transmit PSFCH having index 0 (i.e., offset of 0). This may be the same as when the above-described mapping principle of FIG. 13B is applied. However, if the mapping of FIG. 13C is applied, the UE receiving PSCCH or PSSCH through groupcast communication option 1 in slot index ‘1’ and start subchannel index (or start RB index) ‘0’ may transmit a PSFCH having index 1.

Meanwhile, the configuration of the PSFCH transmission frequency resource used for groupcast communication HARQ feedback transmission option 2 may be different from the configuration of PSFCH transmission frequency resource used for the above-described unicast communication HARQ feedback transmission or groupcast communication HARQ feedback transmission option 1. This is why in groupcast communication HARQ feedback transmission option 2, the reception UEs in the group, receiving PSCCH and PSSCH from the transmission UE, should independently transmit PSFCH to the transmission UE using different time/frequency/code resources. Accordingly, the number of PSFCH resources needs to increase in proportion to the number of the reception UEs (i.e., PSFCH transmission UE) in the group. To that end, there may be needed a method for transmitting different PSFCH time/frequency/code resources between different reception UEs in the group performing groupcast communication. As the method, one of the methods mentioned in FIGS. 13A and 13D may be used.

As an example, in FIG. 21A, the UEs, receiving PSCCH or PSSCH through groupcast communication option 2 in slot index ‘0’ and start subchannel index (or start RB index) ‘0’ may transmit PSFCH starting from index 0 (i.e., starts PSFCH from the offset of 0). In this case, the number of reception UEs in the group performing the groupcast communication may be assumed to be G0. As described in connection with FIG. 13D, each reception UE may receive, from the higher layer, the number of group members participating in the groupcast communication (G0 reception UEs+one transmission UE=G0+1) and its own group ID. Thus, each reception UE may know that G0 independent PSFCH frequency resources are needed in the PSFCH frequency resource set starting from index 0. Each reception UE may identify the PSFCH resource that it may use from the PSFCH starting from index 0 through its group ID (e.g., the modulo operation mentioned in FIG. 13D). If the mapping principle of FIG. 13B is applied to FIG. 21A, the UEs, receiving PSCCH or PSSCH through groupcast communication option 2 in slot index ‘0’ and start subchannel index (or start RB index) ‘1’, may transmit PSFCH starting from PSFCH index 1. Each reception UE may receive, from the higher layer, the number of group members participating in the groupcast communication (G1 reception UEs+one transmission UE=G1+1) and its own group ID. Thus, each reception UE may know that G1 independent PSFCH frequency resources are needed in the PSFCH frequency resource set starting from index 1. Each reception UE may identify the PSFCH resource that it may use from the PSFCH starting from index 0 through its group ID (e.g., the modulo operation mentioned in FIGS. 13D, 20A, and 20B).

Further, if the mapping principle of FIG. 13C is applied to FIG. 21A, the UEs, receiving PSCCH or PSSCH through groupcast communication option 2 in slot index ‘1’ and start subchannel index (or start RB index) ‘0’, may transmit PSFCH starting from PSFCH index 1. Each reception UE may receive, from the higher layer, the number of group members participating in the groupcast communication (G1 reception UEs+one transmission UE=G1+1) and its own group ID. Thus, each reception UE may know that G1 independent PSFCH frequency resources are needed in the PSFCH frequency resource set starting from index 1. Each reception UE may identify the PSFCH resource that it may use from the PSFCH starting from index 0 through its group ID (e.g., the modulo operation mentioned in FIGS. 13D, 20A, and 20B).

Similarly, in FIG. 21B, the UEs, receiving PSCCH or PSSCH through groupcast communication option 2 in slot index ‘0’ and start subchannel index (or start RB index) ‘0’ may transmit PSFCH starting from index n1 (i.e., starts PSFCH from the offset of n1). In this case, the number of reception UEs in the group performing the groupcast communication may be assumed to be G0. As described in connection with FIG. 13D, each reception UE may receive, from the higher layer, the number of group members participating in the groupcast communication (G0 reception UEs+one transmission UE=G0+1) and its own group ID. Thus, each reception UE may know that G0 independent PSFCH frequency resources are needed in the PSFCH frequency resource set starting from index n1. Each reception UE may identify the PSFCH resource that it may use from the PSFCH starting from index n1 through its group ID (e.g., the modulo operation mentioned in FIGS. 13D, 20A, and 20B). If the mapping principle of FIG. 13B is applied to FIG. 21B, the UEs, receiving PSCCH or PSSCH through groupcast communication option 2 in slot index ‘0’ and start subchannel index (or start RB index) ‘1’, may transmit PSFCH starting from PSFCH index n1+1. Each reception UE may receive, from the higher layer, the number of group members participating in the groupcast communication (G1 reception UEs+one transmission UE=G1+1) and its own group ID. Thus, each reception UE may know that G1 independent PSFCH frequency resources are needed in the PSFCH frequency resource set starting from index n1+1. Each reception UE may identify the PSFCH resource that it may use from the PSFCH starting from index 0 through its group ID (e.g., the modulo operation mentioned in FIGS. 13D, 20A, and 20B). Meanwhile, if the mapping principle of FIG. 13C is applied to FIG. 21A, the UEs, receiving PSCCH or PSSCH through groupcast communication option 2 in slot index ‘1’ and start subchannel index (or start RB index) ‘0’, may transmit PSFCH starting from PSFCH index n1+1. Each reception UE may receive, from the higher layer, the number of group members participating in the groupcast communication (G1 reception UEs+one transmission UE=G1+1) and its own group ID. Thus, each reception UE may know that G1 independent PSFCH frequency resources are needed in the PSFCH frequency resource set starting from index n1+1. Each reception UE may identify the PSFCH resource that it may use from the PSFCH starting from index n1+1 through its group ID (e.g., the modulo operation mentioned in FIGS. 13D, 20A, and 20B).

Meanwhile, it has been mainly exemplified that the above-described method for determining the start index of PSFCH for unicast, groupcast HARQ option 1 and groupcast HARQ option 2 operation is associated with the slot index where PSSCH is received and/or the subchannel index (or RB index) where PSSCH is received (or associated with the slot index where PSCCH is received and/or the subchannel index (or RB index) where PSCCH is received). However, in addition to this, as mentioned in FIG. 13D, the source ID and destination ID may be utilized. As an example, the start point of the PSFCH frequency resource set shown in FIGS. 21A and 21B may be found through the source ID, and the index of the PSFCH frequency resource used for PSFCH transmission by each reception UE may be determined in the corresponding PSFCH frequency resource set through the correlation between PSSCH and PSFCH in each PSFCH frequency resource set.

The above-described embodiments of FIGS. 21A and 21B may be used simultaneously with the embodiments of FIGS. 20A and 20B. For example, it has been described in FIGS. 20A and 20B that the slot index of PSSCH and the start index of subchannel (or index of start subchannel) and the start index of the frequency and/or code resource of PSFCH are associated, or the slot index of PSSCH and the start index of subchannel (or index of start subchannel) and the start index of the candidate frequency and/or code resource set of PSFCH are associated. In this case, when the above-described correlation between PSSCH resource and PSFCH resource is defined, the mapping relationship may be defined so that the PSFCH resource (or resource of candidate PSFCH set) is mapped to the rest except of the unused resource shown in FIGS. 21A and 21B.

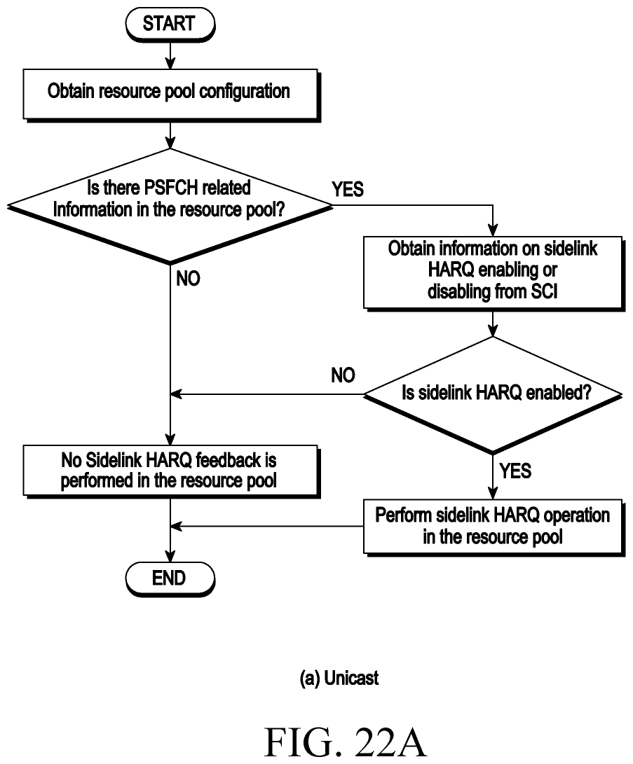

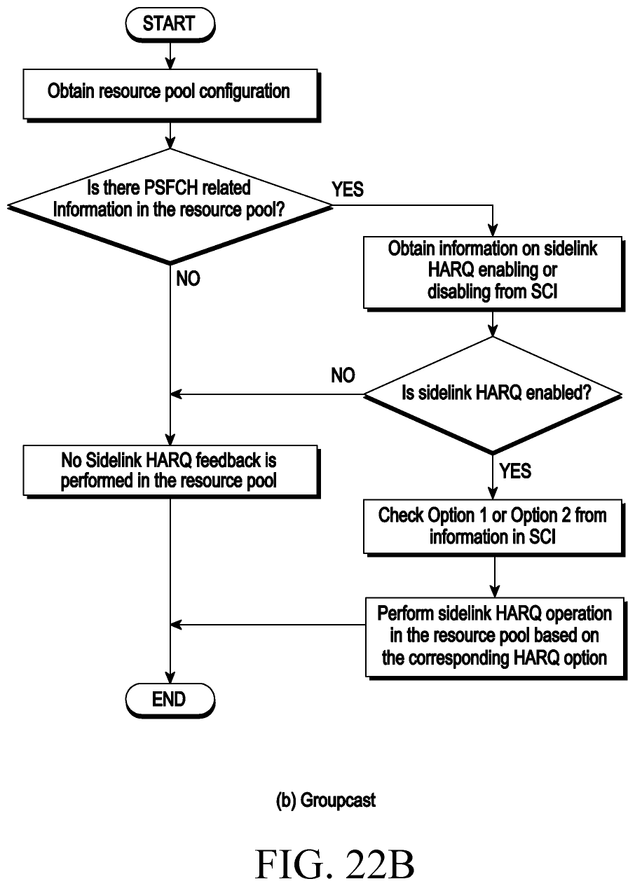

FIGS. 22A and 22B are flowcharts illustrating operations of a reception UE for sidelink HARQ feedback transmission according to an embodiment of the disclosure.

As mentioned in FIGS. 21A and 21B, UEs may coexist which use unicast, groupcast (including option 1 and option 2), and broadcast communication in the same resource pool. In this case, HARQ feedback may not be operated in broadcast communication. Further, as mentioned in FIG. 4, whether to operate HARQ feedback may be activated or inactivated in unicast and groupcast communication. In other words, as described above, whether to operate HARQ feedback may be determined depending on the cast scheme (unicast, groupcast, or broadcast), and in a specific cast scheme (groupcast), various HARQ feedback operation methods (option 1 and option 2) may exist. Further, in some cast schemes (unicast or groupcast), whether to operate HARQ feedback may be activated/inactivated. Therefore, when unicast, groupcast, and broadcast communication share the same resource pool (i.e., when UEs performing unicast, groupcast, and broadcast coexist in one resource pool), a design may be needed for a signaling scheme to support activation/inactivation as to whether to operate HARQ and the above-described HARQ feedback operation method. To that end, at least one of the following embodiments may be considered.

Embodiment 1) Whether to activate/inactivate sidelink HARQ operation may be explicitly or implicitly included in the resource pool information configured through RRC information or system information by the base station. In the out-of-coverage environment where no base station is present, whether to activate/inactivate sidelink HARQ operation may be explicitly or implicitly included in the resource pool information previously configured. Explicitly configuring or pre-configuring whether to activate/inactivate sidelink HARQ operation may mean any one of that whether to activate/inactivate sidelink HARQ operation is explicitly included in the resource pool information configuration information through one bit, that it is explicitly included through ‘Enable/Disable,’ or that it is explicitly included through ‘ON/OFF.’ In contrast, implicitly configuring or pre-configuring whether to activate/inactivate sidelink HARQ operation may mean activating sidelink HARQ operation if the resource pool configuration information includes parameters regarding sidelink HARQ operation and inactivating sidelink HARQ operation unless the resource pool configuration information includes parameters regarding HARQ operation. Accordingly, the V2X transmission UE and reception UEs receiving resource pool configuration information may determine whether to activate/inactivate sidelink HARQ operation in the corresponding resource pool.

Meanwhile, as mentioned in FIG. 2, broadcast communication may mean that the V2X transmission UE broadcasts sidelink control information and data information to multiple unspecified UEs present around the V2X transmission UE. Accordingly, since the V2X transmission UE and V2X reception UEs performing broadcast communication are unaware of their mutual presence, it may be impossible to operate sidelink HARQ feedback. In this case, when the V2X UEs performing broadcast communication share resource pool with V2X UEs performing unicast or groupcast communication, if embodiment 1) described above is used, understanding of whether to operate sidelink HARQ operation may differ between transmission UE and reception UE.

For example, although the transmission UE transmits sidelink data through broadcast communication, the reception UE may transmit HARQ feedback to the transmission UE based on the activation configuration information of HARQ operation included in the resource pool configuration information. Since the transmission UE does not expect feedback from the reception UE because it has used broadcast communication, it may not receive HARQ feedback transmitted by the reception UE. Due to the different understandings between the transmission UE and the reception UE, the reception UE may unnecessarily transmit PSFCH, increasing power consumption and causing the half-duplexing issues. In this case, the half-duplexing issues may cause the reception UE to fail to receive PSFCH from another UE in the corresponding resource pool due to unnecessary PSFCH transmission as described above, for UEs which are incapable of simultaneously performing sidelink transmission and reception (e.g., UEs in which sidelink transmission RF chain and sidelink reception RF chain are not separated).

The above-described issue is described below in detail. The cast type (unicast, groupcast, or broadcast) may be determined by the application layer, and HARQ operation may be performed by the physical layer and MAC layer. Accordingly, when the data generated by the application layer of the transmission UE is broadcast communication, the physical layer and MAC layer of the transmission UE may determine not to perform HARQ operation. Therefore, as in embodiment 1), although HARQ operation activation information is explicitly or implicitly included in the resource pool information received by the transmission UE, the transmission UE may disregard it. However, the UE receiving broadcast data from the transmission UE is unaware of the cast type before receiving the corresponding broadcast data by the application layer of the reception UE, and thus, the physical layer and MAC layer may not identify whether the corresponding data is broadcast-type data. Accordingly, the reception UE using embodiment 1) may transmit HARQ feedback to the transmission UE based on the HARQ operation activation information configured in the resource pool.

Therefore, to address the above-described issues, the following method for the physical layer and MAC layer of the reception UE to recognize whether HARQ operation is activated may be needed.

Embodiment 2) As shown in FIG. 22A, the transmission UE and reception UE to perform unicast communication may obtain activation information of sidelink HARQ operation through resource pool configuration information. In this case, when the sidelink HARQ operation activation information is explicitly or implicitly configured in the resource pool information for sidelink transmission, the transmission UE may transmit a one-bit indicator indicating whether HARQ operation is activated in the sidelink control information (SCI) to the reception UE. For example, ‘0’ may mean activating sidelink HARQ operation, and ‘1’ may mean activating sidelink HARQ operation. The reception UE may transmit HARQ feedback to the transmission UE only when activation of sidelink HARQ operation is explicitly or implicitly configured in the resource pool information for sidelink reception while the one-bit indicator in the SCI transmitted by the transmission UE simultaneously indicates activation of sidelink HARQ operation. Although activation of sidelink HARQ operation is explicitly or implicitly configured in the resource pool information for sidelink reception, if the one-bit indicator of the SCI transmitted by the transmission UE indicates inactivation of HARQ operation, the HARQ feedback may not be transmitted to the transmission UE.

In embodiment 2) described above, such a case may occur where inactivation of HARQ operation may be configured in the resource pool configuration information, and the transmission UE indicates activation of HARQ operation through the one-bit indicator of the SCI. This may mean that the resource pool does not have PSFCH resources for HARQ operation, so that the reception UE gives priority to resource pool configuration information and may not transmit HARQ feedback to the transmission UE. In other words, the reception UE may disregard activation of HARQ operation indicated by the one-bit indicator of the SCI transmitted by the transmission UE.

Meanwhile, in groupcast communication, the transmission UE and reception UEs may need a common agreement on whether to use option 1 or option 2. To that end, the following embodiments may be considered.

Embodiment 3) The resource pool configuration information provided through system and RRC signaling by the base station or pre-configured resource pool configuration information may include HARQ operation information (option 1 or option 2). The UEs transmitting and receiving in groupcast communication in the corresponding resource pool may operate either option 1 or option 2 based on the HARQ operation information configured in the resource pool.

However, a method for the reception UE to identify whether to use option 1 or option 1 in groupcast communication may need to be considered. More specifically, whether to use option 1 and option 2 may be determined by the application layer (or V2X layer between the application layer and AS layer. Hereinafter, application layer is interchangeably used with V2X layer), and the physical layer and MAC layer of the transmission UE may receive whether to use option 1 or option 2 from its application layer. As an example, the application layer may transfer the number of group members of the groupcast communication that the transmission UE involves and group ID information that may be used by the transmission UE to the physical layer through the MAC layer. Upon failing to receive the above-described information from the application layer, the MAC layer and physical layer of the transmission UE are unaware of information about the group (i.e., the number of group members and group ID) and may thus be required to operate option 1. Meanwhile, the MAC layer and physical layer of the transmission UE, receiving the above-described group-related information, may operate option 2. In this case, although the above-described information is provided from the application layer, the MAC layer and physical layer of the transmission UE may operate option 1 according to a condition. As an example, when the number of group members is equal to or more than a specific value configured (or pre-configured) via RRC or system information by the base station, the MAC layer and physical layer of the transmission UE may operate option 1. Or, when the number of PSFCH resources is smaller than the number of group members, the MAC layer and physical layer of the transmission UE may operate option 1.

Based on the above-described examples, whether to use option 1 or option 2 is determined by the application layer. Thus, the physical layer and MAC layer of the UE receiving sidelink data from the transmission UE may be unable to know whether to use option 1 or option 2. Accordingly, similar to whether to activate or inactivate HARQ operation described above, embodiment 3) may not be proper. A method for addressing the issues may be needed, and embodiment 4) below may be considered.

Embodiment 4) As shown in FIG. 22B, the transmission UE and reception UE to perform groupcast communication may obtain activation information of sidelink HARQ operation through resource pool configuration information. In this case, like operations in the above-described unicast communication, the transmission UE may transmit sidelink HARQ feedback activation information to the reception UE through the SCI. Further, the transmission UE may transmit a one-bit indicator for sidelink HARQ operation information to the reception UE as follows. For example, ‘0’ may mean use of option 1, and ‘1’ may mean use of option 2. The reception UE may transmit HARQ feedback to the transmission UE through PSFCH using the method of option 1 or option 2 according to the one-bit indicator in the SCI transmitted from the transmission UE. In other words, according to the above-described example, when sidelink HARQ operation is explicitly or implicitly activated in the resource pool configuration information, one-bit information meaning activation or inactivation of HARQ operation through the SCI may be transmitted and, when HARQ operation is activated through the SCI, a one-bit indicator for HARQ operation information may further be transmitted to the reception UE (i.e., whether HARQ is activated and use of HARQ feedback option 1 or use of option 2 may be indicated through two bits). For example, HARQ activation may be explicitly or implicitly configured in the resource pool configuration information, and the transmission UE to perform groupcast communication in the corresponding resource pool may indicate the following to the reception UE using the 2 bits of the indicator of the SCI. For example, ‘00’ may mean that the reception UE is not to transmit HARQ feedback. ‘01’ may mean that the reception UE is to transmit HARQ feedback through the method of groupcast option 1, and ‘10’ may mean that the reception UE is to transmit HARQ feedback through the method of groupcast option 2.

As described above, the physical layer and MAC layer may not identify unicast, groupcast, and broadcast communication. Accordingly, the number of bits constituting the SCI needs to remain the same to reduce UE SCI decoding complexity regardless of unicast, groupcast, and broadcast communication. Accordingly, the transmission UE, transmitting sidelink control information and data information using the above-described broadcast communication, may configure ‘00’ in the SCI to prevent the reception UE from transmitting HARQ feedback through the PSFCH in the resource pool where HARQ operation is activated. The physical layer and MAC layer of the UE, receiving it, may not transmit PSFCH according to the ‘00’ indicator of the SCI although not identifying the cast type. Similarly, the transmission UE, transmitting sidelink control information and data information using unicast or groupcast communication, may configure ‘00’ in the SCI to prevent the reception UE from transmitting HARQ feedback through the PSFCH in the resource pool where HARQ operation is activated. The physical layer and MAC layer of the UE, receiving it, may not transmit PSFCH according to the ‘00’ indicator of the SCI although not identifying the cast type.

Meanwhile, it is assumed in the above-described groupcast communication examples that activation and inactivation information of sidelink HARQ operation and sidelink HARQ operation information (option 1 or option 2) each are transmitted through an independent one-bit indicator to the SCI. In other words, a two-bit indicator may be needed in the SCI to transmit the two pieces of information. Further, as described above, since the physical layer and MAC layer of the reception end cannot identify the cast type, the two-bit information may be required to be included in the SCI regardless of the cast type to reduce the SCI decoding complexity at the reception end. This may increase the number of bits transmitted to the SCI, thus increasing signaling overhead and channel coding rate, and hence deteriorating SCI coverage capability. Thus, a method for addressing these issues is needed, and at least one of the following methods may be considered.

Since inactivation of HARQ operation in the resource pool configuration information means that no PSFCH resource is configured in the sidelink HARQ operation, it may mean that all of the HARQ operation in unicast communication, HARQ option 1 operation in groupcast communication, HARQ option 2 operation in groupcast communication, and HARQ operation in broadcast communication are impossible.

When HARQ operation is activated in the resource pool configuration information, it may mean that PSFCH resources for sidelink HARQ operation have been configured. Thus, the transmission UE may indicate whether to operate HARQ to the reception UE through one bit of the SCI. More specifically, although HARQ operation is activated in the resource pool configuration information, the transmission UEs performing unicast, groupcast, and broadcast communication may set the one-bit indicator of the SCI to ‘0’ and transmit it to the reception UE to inactivate HARQ operation. The reception UEs receiving it may not transmit HARQ feedback to the transmission UE although HARQ operation is activated in the resource pool configuration information. Meanwhile, when sidelink HARQ operation is activated in the resource pool configuration information, and the transmission UE is to operate HARQ in unicast communication or operate HARQ through option 1 or option 2 in groupcast communication, the transmission UE may set the one-bit indicator of SCI to ‘1’ and transmit it to the reception UE. As mentioned above, since the physical layer and MAC layer of the reception UE cannot identify the cast type, if the one-bit indicator of SCI is set to ‘1’, the physical layer and MAC layer of the reception UE may not determine whether it means HARQ feedback operation in unicast or HARQ feedback operation in groupcast.

This may be determined by the reception UE through the source ID and/or destination ID included in the SCI. For example, when the source ID and/or destination ID are separated into twos sets, and the source ID and/or destination ID corresponding to set 1 is detected, the physical layer and MAC layer of the reception UE may identify that it means unicast communication from the corresponding ID. Further, when the source ID and/or destination ID corresponding to set 2 is detected, the physical layer and MAC layer of the reception UE may identify that it means groupcast communication from the corresponding ID. There may be various methods for configuring set 1 and set 2 described above. As an example, the transmission UE may set the indicator to ‘1’ and transmit the source ID constituted of eight bits and the destination ID constituted of 16 bits to the reception UE through the SCI. In this case, when an even-numbered source ID and/or destination ID is detected, the physical layer of the reception UE may determine that it is unicast communication. When an odd-numbered source ID and/or destination ID is detected, the physical layer of the reception UE may determine that it is groupcast communication. As another example, the eight-bit source ID and the 16-bit destination ID are converted into decimal numbers, and when the source ID and/or destination ID is equal to or larger than a specific threshold (or larger than the threshold), the physical layer of the reception UE may determine that it is unicast communication.

The reception UE, identifying groupcast communication by the above-described methods, needs to further identify whether it means HARQ option 1 in groupcast communication or HARQ option 2. This may be performed through the following method. For example, when the SCI includes information about the location of the transmission UE (e.g., including at least one of the zone ID or latitude and longitudes of the transmission UE) and range requirements, the physical layer of the reception UE may determine that it is to perform groupcast HARQ option 1. When the above-described information is not included in the SCI, the physical layer of the reception UE may determine to perform groupcast HARQ option 2.

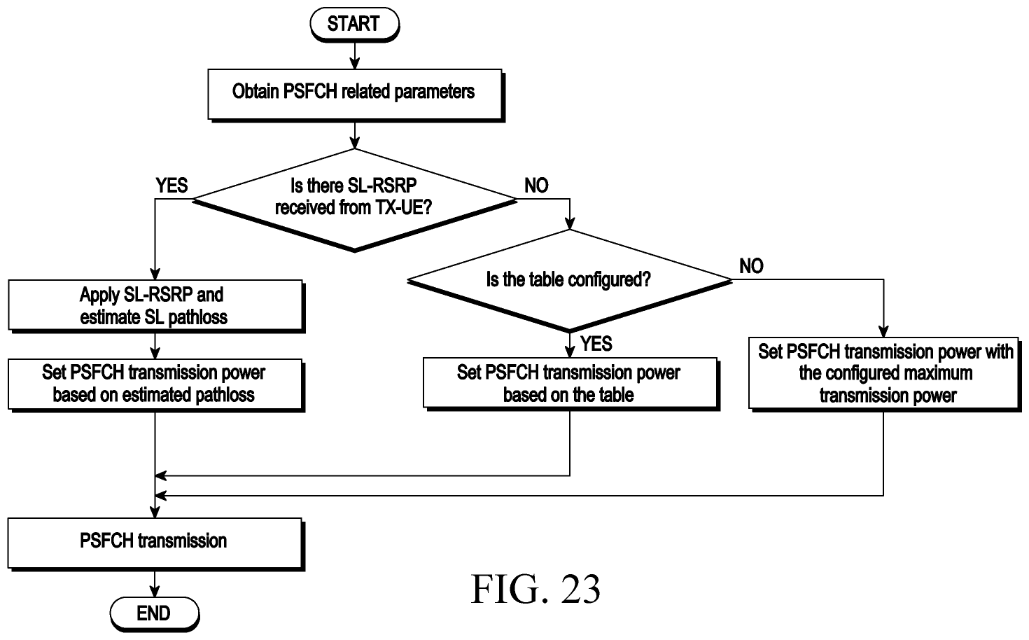

FIG. 23 is a view illustrating a transmission power control method of a sidelink feedback channel according to an embodiment of the disclosure.

The V2X transmission UE may perform sidelink transmit power control for PSCCH and PSSCH transmission. For sidelink transmit power control, the V2X transmission UE may transmit a sidelink reference signal to the V2X reception UE, and the V2X reception UE receiving it may measure sidelink reference signal received power (RSRP) and report it to the V2X transmission UE. In this case, the sidelink RSRP may be measured by the V2X reception UE through sidelink channel state information reference signal (CSI-RS) or be measured by the V2X reception UE using the reference signal (DMRS) transmitted through the sidelink control channel or data channel. The V2X transmission UE, receiving the sidelink RSRP from the V2X reception UE, may estimate pathloss value from the received sidelink RSRP and its transmit power and apply it to perform sidelink transmit power control.

Similarly, when the V2X reception UE transmits PSFCH to the V2X transmission UE, it may be required to perform sidelink transmit power control. The sidelink transmit power control for PSFCH may be performed through at least one of the following methods.

Method 1) The V2X reception UE may transmit PSFCH using configured maximum transmit power. In this case, the configured maximum transmit power may be configured by the V2X reception UE based on the metric (e.g., distance information) configured from the higher layer or QoS received from the higher layer by the V2X reception UE.

Method 2) The V2X reception UE may configure the transmit power value of PSFCH using the downlink pathloss value with the base station and the sidelink transmit power control parameters included in the PSFCH resource pool configuration information. In this case, the downlink pathloss value with the base station may be estimated by the V2X reception UE through the secondary synchronization signal (SSS) transmitted by the base station through downlink or may be estimated by the V2X reception UE through the DMRS of the physical broadcast channel (PBCH) and the SSS. What signal the V2X reception UE should estimate downlink pathloss through may be included in the resource pool information transmitted to the V2X UE through RRC configuration or system information by the base station. When the V2X reception UE is out of the coverage of the base station and thus cannot use downlink pathloss value for PSFCH transmit power control, the V2X reception UE may configure PSFCH transmit power value using only other transmit power control parameters without downlink pathloss value. As another example, PSFCH transmit power may be configured using method 2 when the V2X reception UE is in the coverage of the base station and using method 1 when the V2X reception UE is out of the coverage of the base station.

Method 3) The V2X transmission UE may provide the transmit power value, which it has used for PSCCH or PSSCH transmission, to the V2X reception UE. In this case, the V2X transmission UE may transmit information about its transmit power value to the V2X reception UE through sidelink control information or MAC CE. The V2X reception UE may measure the sidelink RSRP through the sidelink CSI-RS or sidelink DMRS transmitted from the V2X transmission UE through the PSCCH or PSSCH and the transmit power value used for PSCCH or PSSCH transmission received from the V2X transmission UE and estimate the sidelink pathloss value using them. The V2X reception UE may configure the transmit power value of PSFCH using the sidelink pathloss value that it has estimated and the sidelink transmit power parameters included in the PSFCH resource pool configuration information.

Method 4) A mapping relationship may be configured between the sidelink RSRP value measured by the V2X reception UE and the PSFCH transmit power. The mapping relationship is exemplified in Table 2 below, and when the sidelink RSRP value measured by the V2X reception UE is −X1 dBm, the V2X reception UE may use Y1 dBm as the transmit power of PSFCH. Table 2 below may be configured by the base station or be previously configured. There may be two or more mapping tables like Table 2 below, by the power class or QoS (e.g., minimum communication range)) of the V2X UE. Table 2 below exemplifies that the sidelink RSRP and the PSFCH transmit power value have a one-to-one mapping relationship, but there may be a one-to-many mapping relationship. In other words, two or more sidelink RSRP values may be mapped to one PSFCH transmit power value. In Table 2 below, the sidelink RSRP values may have a difference of Z1 dB (i.e., the step size, granularity or resolution of the sidelink RSRP values is Z1 dB). Likewise, the PSFCH transmit power values may have a difference of Z2 dB (i.e., the step size, granularity or resolution of the PSFCH transmit power values is Z2 dB). In this case, Z1 and Z2 may be the same or different. Table 2 below shows a mapping table between sidelink RSRP and PSFCH transmit power.

TABLE 2

| SL-RSRP | PSFCH transmit power value |
|---|---|
| −X₁ dBm | Y₁ dBm |
| . . . | . . . |
| −X_{N} dBm | Y_{N} dBm |

FIG. 23 is a view illustrating an example PSFCH transmit power control method based on the above-described examples. More specifically, the V2X reception UE may obtain information about PSFCH parameters preconfigured or V2X transmission UE or the base station. In this case, information about the PSFCH parameters may include at least one of the PSFCH-related information mentioned in FIG. 4. Further, the information about the PSFCH parameters may include information about the PSFCH transmit power as well as the above-described information. If the V2X reception UE has received sidelink RSRP from the V2X transmission UE (i.e., if the V2X reception UE possesses sidelink RSRP information measured by the V2X transmission UE), the V2X reception UE may estimate the sidelink pathloss. The V2X reception UE may configure PSFCH transmit power using at least one among information about the obtained PSFCH parameters and the estimated pathloss value. The V2X reception UE may transmit PSFCH to the V2X transmission UE using the PSFCH transmit power value that it has configured.

If the V2X reception UE has not received sidelink RSRP from the V2X transmission UE (i.e., if the V2X reception UE does not possess sidelink RSRP information measured by the V2X transmission UE), the V2X reception UE may determine whether the mapping table of sidelink RSRP value and PSFCH transmit power value is configured as exemplified in Table 2. The V2X reception UE, configured with a table as shown in Table 2, may select the PSFCH transmit power value mapped to the sidelink RSRP value, which it has measured, configure the PSFCH transmit power value, and transmit the PSFCH to the V2X transmission UE (method 4).

If failing to be configured with a table such as Table 2, the V2X reception UE may configure the PSFCH transmit power value through methods 1 and 2 described above and transmit PSFCH to the V2X transmission UE.

As another example of FIG. 23, the V2X reception UE which has determined whether there is sidelink RSRP information, may, if there is no sidelink RSRP information, configure the PSFCH transmit power value through methods 1 and 2 described above, without determining whether a table such as Table 2 is configured, and transmit PSFCH to the V2X transmission UE.

As another example, the V2X reception UE may determine whether a table like Table 2 is configured immediately without determining whether there is sidelink RSRP information. When a table as shown in Table 2 is configured, the V2X reception UE may select the PSFCH transmit power value mapped to the sidelink RSRP value, which it has measured, configure the PSFCH transmit power value, and transmit the PSFCH to the V2X transmission UE (method 4). If failing to be configured with a table such as Table 2, the V2X reception UE may configure the PSFCH transmit power value through methods 1 and 2 described above and transmit PSFCH to the V2X transmission UE.

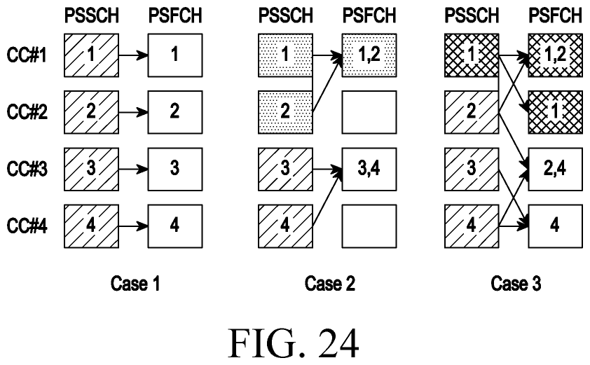

FIG. 24 is a view illustrating a communication method using a sidelink feedback channel (PSFCH) in a wireless communication system supporting a plurality of carriers according to an embodiment of the disclosure. The following embodiments of the disclosure may be applied to various communication systems supporting sidelink, such as, e.g., V2X.

FIG. 24 assumes that a UE(s) performs sidelink communication using one or more carriers (or BWP). When the UE(s) may receive a signal(s) of PSSCHs which are sidelink data channels on a plurality of carriers (CC #1 to CC #4) and should transmit control information including HARQ-ACK information through the PSFCH which is a sidelink feedback channel in response to reception of the PSSCHs, the UE(s) may use one or a combination of the methods of case 1 to case 3 exemplified in FIG. 24. Hereinafter, the data, (control) information or signals transmitted/received through PSSCH and PSFCH are collectively referred to as PSSCH signal and PSFCH signal.

The embodiment of FIG. 24 may be understood as a context in which, in terms of the transmission UE, each of a plurality of transmission UEs transmits PSSCH signals using one or more carriers, or a single transmission UE transmits PSSCH signals using all of the plurality of carriers. In this case, the transmission UE may receive PSFCH signals through one or more carriers determined by one or a combination of the methods of case 1 to case 3 in response to PSSCH transmission using one or more carriers.

Further, the embodiment of FIG. 24 may be understood as a context in which, in terms of the reception UE, each of a plurality of reception UEs receives PSSCH signals using one or more carriers, or a single reception UE receives PSSCH signals using all of the plurality of carriers. In this case, the reception UE may transmit PSFCH signals through one or more carriers determined by one or a combination of the methods of case 1 to case 3 in response to PSSCH reception using one or more carriers.

Further, in the following description, the carrier may be replaced with the BWP which may then be applied. When replaced with BWP, there may be a context in which the UEs perform sidelink transmission/reception through a plurality of BWPs in one carrier. Further, even when there are a plurality of carriers and a plurality of BWPs in each carrier, it may be possible, and is not limited in the disclosure.

In FIG. 24, case 1 exemplifies a case where PSFCH reception/transmission each is performed in the same carrier in response to PSSCH transmission/reception.

For example, in terms of reception, when the UE receives a PSSCH signal on carrier 1 (CC #1), PSFCH transmission including HARQ-ACK information, in response thereto, may be performed on carrier 1 (CC #1). When the UE receives a PSSCH signal on carrier 2 (CC #2), PSFCH transmission including HARQ-ACK information, in response thereto, may be performed on carrier 2 (CC #2). When the UE receives a PSSCH on carrier 3 (CC #3), PSFCH transmission including HARQ-ACK information, in response thereto, may be performed on carrier 3. When the UE receives a PSSCH signal on carrier 4 (CC #4), PSFCH transmission including HARQ-ACK information, in response thereto, may be performed on carrier 4.

For example, in terms of transmission, when the UE transmits a PSSCH signal on carrier 1 (CC #1), PSFCH reception including HARQ-ACK information, in response thereto, may be performed on carrier 1 (CC #1). When the UE transmits a PSSCH signal on carrier 2 (CC #2), PSFCH reception including HARQ-ACK information, in response thereto, may be performed on carrier 2 (CC #2). When the UE transmits a PSSCH signal on carrier 3 (CC #3), PSFCH reception including HARQ-ACK information, in response thereto, may be performed on carrier 3. When the UE transmits a PSSCH signal on carrier 4 (CC #4), PSFCH transmission including HARQ-ACK information, in response thereto, may be performed on carrier 4.

Accordingly, in a context where four carriers are configured as in the embodiment of FIG. 24, when simultaneously receiving PSSCH signals for each carrier, PSFCH signals for the respective PSSCH signals are simultaneously transmitted in specific slots. In this case, it may be possible to transmit all of scheduled PSFCH signals or transmit only some PSFCH signals depending on the UE capability. When only some PSFCH signals are transmitted, the UE may select some PSFCH signals that may be transmitted using a method, such as ascending order of carrier index or priority information for PSFCH signals. The context where only some PSFCH signals are transmitted may be possible when the maximum number of transmissions of PSFCH signals is determined for each carrier or UE depending on UE capability. Or, even when the sum of the transmit powers of the scheduled PSFCHs exceeds the UE's maximum transmit power, the UE cannot transmit all of the signals of the scheduled PSFCHs, so that only some PSFCH signal(s) may be transmitted.

In FIG. 24, case 2 exemplifies a case where the career where PSSCH transmission/reception is performed and the carrier where PSFCH reception/transmission including HARQ-ACK information is performed in response thereto are equal to or different from each other.

For example, PSFCH reception/transmission including HARQ-ACK information in response to PSSCH transmission/reception on carrier 1 (CC #1) may be performed on carrier 1 (CC #1). PSFCH reception/transmission including HARQ-ACK information in response to PSSCH transmission/reception on carrier 2 (CC #2) may be performed on carrier 1 (CC #1). PSFCH reception/transmission including HARQ-ACK information in response to PSSCH transmission/reception on carrier 3 (CC #3) may be performed on carrier 3 (CC #3). PSFCH reception/transmission including HARQ-ACK information in response to PSSCH transmission/reception on carrier 4 (CC #3) may be performed on carrier 3 (CC #3). Accordingly, the PSFCH signals transmitted/received on a specific carrier may include HARQ-ACK information for the PSSCH signals transmitted/received on a plurality of carriers. When a UE transmits HARQ-ACK information for a plurality of PSSCHs on a PSFCH, since the UEs transmitting the corresponding PSSCH signals may be different, the UE may transmit the PSFCHs through separate independent physical channel resources without multiplexing the HARQ-ACK information. In this case, the PSFCH signals may include 1-bit HARQ-ACK information. If the transmission UEs that transmitted the corresponding PSSCH signals are the same, the reception UE receiving the corresponding PSSCH signals may be able to multiplex the HARQ-ACK information and transmit it on one PSFCH. In this case, the PSFCH signals may include HARQ-ACK information of two or more bits. In case 2, the carrier where PSSCH transmission/reception is performed and the carrier where PSFCH reception/transmission including HARQ-ACK information in response thereto may be previously determined through control information (or configuration information). In the embodiments of the disclosure, the control information (or configuration information) may be higher layer signaling information provided from the base station, such as RRC information or may be the DCI provided from the base station or the SCI provided from the transmission UE. Accordingly, PSFCH reception/transmission for PSSCH transmission/reception on specific carrier i may be performed on specific carrier i or j, and it may be previously determined by the control information. In FIG. 24, case 3 represents another example where the carrier where PSSCH transmission/reception is performed and the carrier where PSFCH reception/transmission including HARQ-ACK information is performed in response thereto are equal to or different from each other. For example, PSFCH reception/transmission including HARQ-ACK information in response to PSSCH transmission/reception on carrier 1 (CC #1) may be performed on carrier 1 (CC #1) or carrier 2 (CC #2). PSFCH reception/transmission including HARQ-ACK information in response to PSSCH transmission/reception on carrier 2 (CC #2) may be performed on carrier 1 (CC #1) or carrier 3 (CC #3). PSFCH reception/transmission including HARQ-ACK information in response to PSSCH transmission/reception on carrier 3 (CC #3) may be performed on carrier 4 (CC #4). PSFCH reception/transmission including HARQ-ACK information in response to PSSCH transmission/reception on carrier 4 (CC #4) may be performed on carrier 3 (CC #3) or carrier 4 (CC #4). To that end, what carrier index the PSFCH is transmitted/received in may be dynamically known through the SCI (or DCI) scheduling PSSCH. Accordingly, the PSFCH signal including HARQ-ACK information for the PSSCH signal transmitted/received on specific carrier i may be transmitted/received on specific carrier i or j and this may be determined through SCI information. In summary, control information (or control information) for the operations of case 2 and case 3 in FIG. 24 may be provided in various schemes as described above. In another embodiment, in case 2, the control information for determining the carrier where the PSFCH signal is transmitted/received may be provided through higher layer signaling information such as RRC information and, in case 3, through SCI (or DCI). In the disclosure, the SCI (or DCI) may also be referred to as L1 information (signal).

The PSCCH scheduling the PSSCH may also be transmitted/received on the same or different carriers. The PSCCH transmission and reception may also be performed, at least, by one or a combination of case 1 to case 3. It may be possible to have a set of different PSSCH carriers for each UE. It may be possible to have a set of different PSFCH carriers for each UE. It may be possible to have a set of different PSCCH carriers for each UE. The above-described carrier may be replaced with the cell or bandwidth part (BWP) or information constituted of time or frequency or code resources.

When the UE supports a plurality of carriers, carrier aggregation (CA) for sidelink transmission and carrier aggregation for sidelink reception may be equal to or different from each other. As an example where carrier aggregations for transmission or reception different from each other, there may be case where the UE performs sidelink reception through a plurality of carriers, but performs sidelink transmission through one carrier. The PSFCH may be configured only in all or some carrier(s) according to control information, and offset and transmission/reception periods of the PSFCHs configured per carrier may be equal to or different from each other. PSFCH-related control information may be determined UE-specifically, carrier-specifically, or carrier group-specifically.

In the following embodiments, a method for determining PSFCH transmission resources for PSSCH signals received through a plurality of carriers by a UE supporting sidelink carrier aggregation (CA) is described below. Basically, it may be considered that PSSCHs may be transmitted/received through a plurality of carriers, and PSFCH signals are transmitted/received through one carrier (e.g., primary cell). Without limitations thereto, even when PSFCH signals including HARQ-ACK information for the PSSCH signals transmitted/received through the plurality of carriers, respectively, are transmitted/received through one carrier, the PSFCH transmission resource determination method according to the disclosure may be applied in the same or similar manner.

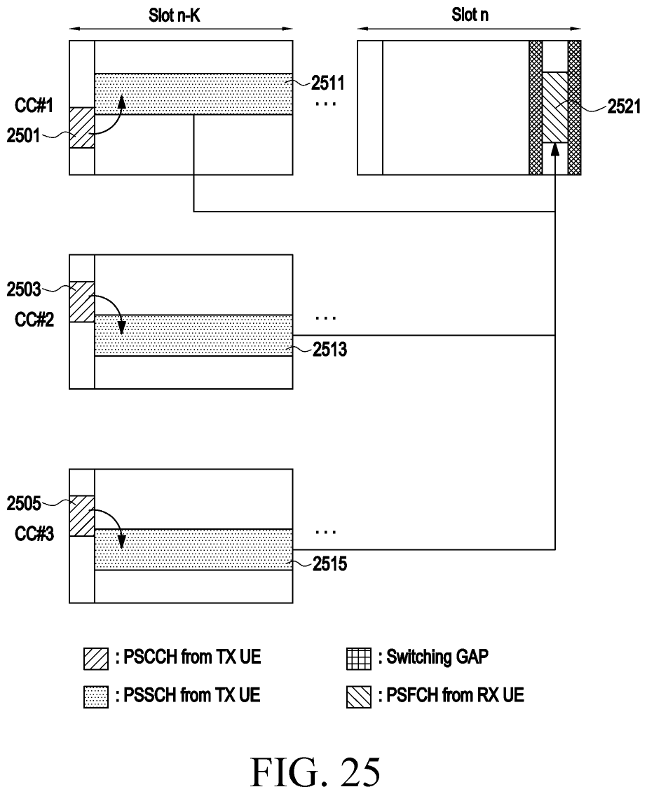

FIG. 25 is a view illustrating an example of resource allocation of a sidelink feedback channel in a CA environment according to an embodiment of the disclosure.

Referring to FIG. 25, a UE may be able to receive PSSCH signals through a sidelink channel present in one or more carriers (or cells). The embodiment of FIG. 25 shows a context in which the PSSCH signals 2511, 2513, and 2515 transmitted/received on three carriers CC #1, CC #2, and CC #3 are scheduled through PSCCH signals 2501, 2503, and 2505 transmitted/received on the respective carriers. The three carriers CC #1, CC #2, and CC #3 are an example, and the number of carriers may be increased/decreased as compared with that in the example of FIG. 25.

In the example of FIG. 25, the context in which the carrier where the PSCCH signal is transmitted/received and the carrier in which the PSSCH signal is transmitted/received are the same is exemplified but, without limitations thereto, the carrier where the PSCCH signal is transmitted/received and the carrier where the PSSCH signal is transmitted/received may differ from each other. This may be determined by control information (or configuration information) or UE capability information or a combination of some thereof. As an example, it may be possible to indicate the carrier where the PSSCH signal is to be transmitted/received by the SCI specific field in the SCI format or to previously designate a carrier where the PSSCH signal is transmitted/received for the carrier where the PSCCH signal is transmitted/received, when configuring resource pool-related control information (or configuration information). When such control information (or configuration information) is absent or there is no separate indication, the UE determines that PSSCH and PSCCH are transmitted/received in the same carrier. Further, one PSCCH (or SCI format) may schedule one or more PSSCHs in which case the plurality of PSSCHs may be present only in one carrier or belong to other carriers.

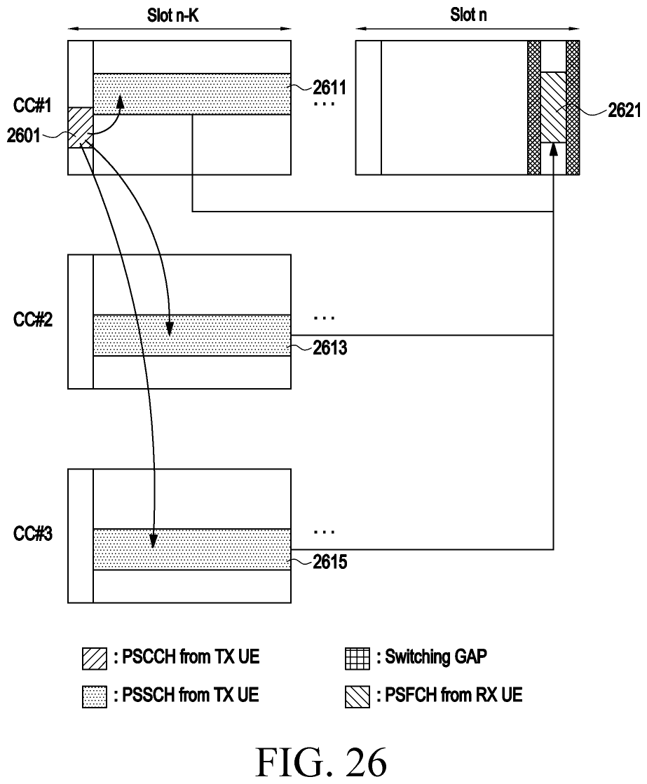

For example, the embodiment of FIG. 26 illustrates a case where PSCCH signal 2601 transmitted/received on one carrier CC #1 schedules a plurality of PSSCH signals 2611, 2613, and 2615 transmitted/received on a plurality of carriers CC #1, CC #2, and CC #3. In this case, a plurality of PSSCHs may be scheduled by one SCI format, or a plurality of PSSCHs may be scheduled by individual SCI formats in one carrier. When PSSCH and PSCCH belong to different carriers, this is referred to as cross-carrier scheduling, and carrier information for cross-carrier scheduling may be determined by the control information (or configuration information). As an example, the carrier indicator information for cross-carrier scheduling may be included in the SCI format, and it may also indicate the carrier where PSCCH is transmitted/received.

The UE may receive the SCI format scheduling the corresponding PSSCH through one or more subchannels among one or more subchannels where PSSCH signals are transmitted/received, and transmit a PSFCH signal including HARQ-ACK information for PSSCH reception based on the control information indicated through the corresponding SCI format. The UE may transmit HARQ-ACK information including ACK or NACK through PSFCH or transmit HARQ-ACK information including only NACK through PSFCH. The former method means transmitting HARQ-ACK/NACK information including ACK when the UE succeeds in PSSCH reception and NACK when it fails. The latter method means transmitting HARQ-ACK information including NACK only when PSSCH reception fails, without transmitting HARQ-ACK information when the UE succeeds in PSSCH reception.

The embodiments of FIGS. 25 and 26 show a context in which HARQ-ACK information including the result of reception of PSSCH signals 2511, 2513, 2515; 2611, 2613, 2615 transmitted/received through a plurality of carriers CC #1, CC #2, and CC #3 is transmitted/received through PSFCH positioned in one carrier 2521; 2621. Embodiments of the disclosure are not limited thereto, and PSFCH signal may be transmitted/received through a plurality of carriers. Specifically, the carrier where PSSCH signal is transmitted/received and the carrier where PSFCH signal including HARQ-ACK information for the PSSCH signal is transmitted/received may be equal to or different from each other, and this may be determined by control information (or configuration information) or UE capability information or a combination of some thereof. As an example, it is possible to separately indicate a carrier where PSFCH signal including HARQ-ACK information for PSSCH reception is transmitted/received by specific field information in the SCI format or the configuration information. As another example, it may be possible to designate a carrier where PSFCH signal including HARQ-ACK information for PSSCH reception is transmitted/received previously by control information (or configuration information).

The UE may be configured with the PSFCH transmission period per carrier or per resource pool. The carriers CC #1, CC #2, and CC #3 shown in the embodiments of FIGS. 25 and 26 may have the same or different subcarrier spacings or cyclic prefixes (CPs). The types of cyclic prefixes may include normal CP and extended CP. When the PSFCH transmission period indicates 0 in a specific carrier or resource pool, the UE does not expect to transmit PSFCH including HARQ-ACK information for the PSSCH received in the corresponding carrier/resource pool. In this case, the UE may regard PSFCH transmission as inactivated. The UE may not perform PSFCH transmission for PSSCH reception by control information (or configuration information). In other words, the UE may perform or may not perform PSFCH transmission for PSSCH reception by the control information (or configuration information) provided from the base station. As an example, the control information may be provided as a specific value of the SCI specific field. If the UE receives PSSCH signal on one carrier or in one resource pool and, in this case, the field value indicating whether HARQ feedback is performed in the SCI format having scheduled PSSCH indicates, e.g., “1”, the UE provides HARQ-ACK information through PSFCH transmission in the corresponding resource pool or another carrier or another resource pool. In contrast, if the UE receives PSSCH on one carrier or in one resource pool, and the field value indicating whether HARQ feedback is performed in the SCI format having scheduled PSSCH indicates, e.g., “0”, the UE does not perform PSFCH transmission in the corresponding resource pool or another carrier or another resource pool and thus may not provide HARQ-ACK information. The UE may transmit PSFCH including HARQ-ACK information of the corresponding PSSCH in the first slot where PSFCH is present, K slots which is a value configured by the control information (or configuration information) after the last slot where PSSCH signal is received. The K slot value may be understood as the minimum processing time for reporting PSFCH including HARQ-ACK information after the UE receives PSSCH and is a value set by the base station. However, the base station may set K, which is a value equal to or larger than the value reported as UE capability, through control information (or configuration information), by referring to the UE capability reporting provided to the base station by the UE.

The embodiments of FIGS. 26 to 29 exemplify a context in which PSFCH including HARQ-ACK information for PSSCH signals scheduled by PSCCH signals transmitted/received on, e.g., three carriers (CC #1, CC #2, and CC #3) is transmitted/received on a specific carrier (CC #1). As an example, the specific carrier where the PSFCH signal is transmitted/received may be indicated by control information (or configuration information) or UE capability information or a combination of some thereof. As another example, when CC #1 is primary cell (PCell), the UE may deem that PSFCH is present only in PCell. When only one-bit HARQ-ACK feedback information may be transmitted through PSFCH for each PSFCH format, the transmission UE and the reception UE may perform selection of resources to transmit/receive PSFCH including HARQ-ACK feedback information for PSSCH signals scheduled by PSCCH signals transmitted/received through a plurality of carriers, by at least one or a combination of some of the following methods.

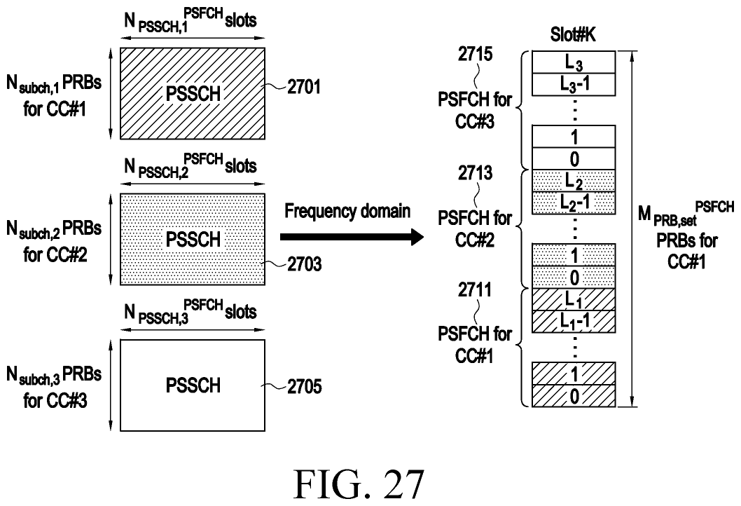

Method A: PSFCH resource selection for PSSCH may be performed by frequency division multiplexing (FDM) for each carrier. As in the example of FIG. 27, the PSFCH resources 2711, 2713, and 2715 for the PSSCH signals 2701, 2703, and 2705 received for the carriers CC #1, CC #2, and CC #3, respectively, may be FDMed, and the UE selects a specific PSFCH resource according to the subchannel (frequency resource) where it receives the PSSCH signal in the frequency resource allocated for each corresponding carrier and slot (time resource). In sum, in method A, the PSFCH resource selected by the UE is determined depending on the carrier resource where the PSSCH signal is received and the frequency and time resources in the corresponding carrier. For example, when the number of carriers associated with one PSFCH is N_{PSSCH}^{cell}, the number of slots of the PSSCH associated with one PSFCH slot in specific carrier k is N_{PSSCH,k}^{PSFCH}, the total number of PRBs allocated for PSFCH transmission is M_{PRB,set}^{PSFCH} and the number of subchannels belonging to the resource pool configured for carrier k is N_{subch,k}, M_{PRB,set}^{PSFCH} is an integer multiple of Σₖ N_{subch,k}·N_{PSSCH,k}^{PSFCH}. Here, Σₖ means the sum of all the carrier k values. In response to PSSCH transmission/reception, the section, range, and/or amount of PRB resources of the transmission slot where PSFCH reception/transmission is performed may be denoted as [A, B] PRBs. In [A, B], “A” may indicate the start PRB for PSFCH transmission and reception, and “B” may indicate the end PRB for PSFCH transmission and reception. For example, the UE may transmit corresponding HARQ-ACK information in [(i+j·N_{PSSCH,k}^{PSFCH}+k·P_{SSCH,k}^{PSFCH}·N_{subch,k})·M_{subch,slot}^{PSFCH}·(i+1+j·N_{PSSCH,k}^{PSFCH}+k·N_{PSSCH,k}^{PSFCH}·N_{subch,k})·M_{subch,slot}^{PSFCH}−1] PRBs of the PSFCH transmission slot for the PSSCH received in slot i, subchannel j, and carrier k among M_{PRB,set}^{PSFCH} PRBs. In this case, i, j, and k have a relationship in sequential ascending order. In other words, when designating the PRB where the PSFCH signal is transmitted/received, the slot index is considered first, and the subchannel index, and then the carrier index are considered. Here, M_{subch,slot}^{PSFCH}=M_{PRB,set}^{PSFCH}/(ΣₖN_{subch,k}·N_{PSSCH,k}^{PSFCH}). M_{PRB,set}^{PSFCH} means the number of PRBs where PSFCH is transmitted. M_{PRB,set}^{PSFCH} means the number of PRBs of the PSFCH that may be allocated for each PSSCH. As another example, as a method for indicating the PRB resources of the transmission slot where PSFCH reception/transmission is performed, related parameters may be configured so that in [A, B] above, “A” denotes the offset information for PSFCH transmission/reception, and “B” denotes the amount of PRB resources for PSFCH transmission/reception. Further, in the resource pool in carrier k, the UE may determine the number of PSFCH resources (number of PRBs) available for HARQ-ACK information multiplexing in PSFCH transmission, through M_{PRB,CS,k}^{PSFCH}=N_{type,k}^{PSFCH}·M_{subch,slot}^{PSFCH}·N_{CS}^{PSFCH}. Here, N_{CS}^{PSFCH} is the number of cyclic shift pairs configured in the resource pool, and N_{type,k}^{PSFCH} is a value set in the resource pool of carrier k through a higher layer signal and may be 1 or N_{subch,k}^{PSFCH}. When N_{subch,k}^{PSFCH}=1, the PRBs of M_{subch,slot}^{PSFCH} are related to the start subchannel index of PSSCH and, when N_{type,k}^{PSFCH}=N_{subch,k}^{PSSCH}, the PRBs of N_{subch,k}^{PSSCH}·M_{subch,slot}^{PSFCH} are associated with one or more subchannels among the N_{subch,k}^{PSSCH} subchannels of the PSSCH. PSFCH resources may be indexed in ascending order of PRB index for N_{type,k}^{PSFCH}·M_{subch,slot}^{PSFCH} PRBs, and be then indexed in ascending order of cyclic shift pair index among N_{CS}^{PSFCH} cyclic shift parts.

The index (unit of PRB) of the PSFCH resource for PSFCH transmission corresponding to the PSSCH reception received by the UE in the resource pool in specific carrier k may be determined by (P_{ID}+M_{ID})mod M_{PRB,CS,k}^{PSFCH}. Here, P_{ID} is the physical channel source ID included in the SCI format for scheduling the PSSCH, M_{ID} is a value determined according to the cast type information value condition included in a specific SCI format, e.g., when a specific SCI format includes a field designating the group cast, M_{ID} is the ID of the UE receiving the corresponding PSSCH signal, and in other cases, M_{ID} is regarded as 0. m₀ and m_{cs} are determined according to the SCI format scheduling PSSCH and the cast type information (broadcast, unicast, or groupcast) in the SCI format to determine the cyclic shift value and thus determines the cyclic shift value α. m₀ is the initial cyclic shift, and m_{cs} is a cyclic shift value determined according to whether it is ACK or NACK. The example of FIG. 27 shows a process of selecting a PSFCH resource by method A described above. For example, the PSSCH signals 2701, 2703, and 2705 transmitted/received through three carriers CC #1, CC #2, and CC #3, respectively, are selected in the FDMed format in the PSSCH transmission slot or symbol resource in one carrier, and L₁, L₂, and L₃ frequency resources in PRB units are divided and used for PSFCH transmission including HARQ-ACK information in response to PSSCH signals transmitted/received on the respective carriers CC #1, CC #2, and CC #3. L₁, L₂, and L₃ may be determined depending on the number of (sub)channels of the resource pool configured for each carrier and the number of PSSCH slots associated with PSFCH transmission slot and be thus equal to or different from each other. The number M_{subch,slot}^{PSFCH} of PRBs of the PSFCH resources 2711, 2713, and 2715 allocated for each carrier through method A is always the same. N_{PSSCH}^{cell}, N_{PSSCH,k}^{PSFCH}, M_{PRB,set}^{PSFCH}, N_{subch,k} may be previously configured through a higher layer signal or, if there is no higher layer information, a value pre-stored in the UE may be used by the UE. M_{PRB,set}^{PSFCH} has been described as a parameter included in the carriers where all PSSCHs associated with PSFCH may be transmitted/received like in case 1, but like in case 2 of FIG. 24, it may be present for each carrier M_{PRB,set}^{PSFCH #1}, M_{PRB,set}^{PSFCH #2}, M_{PRB,set}^{PSFCH #3} where each PSSCH is transmitted/received. Specifically, case 2 may indicate the frequency resource region where the PSFCH for PSSCH transmitted/received for each carrier may be transmitted/received on a specific carrier through independent control information (or configuration information) and, in this case, M_{PRB,set}^{PSFCH #1}, M_{PRB,set}^{PSFCH #2}, M_{PRB,set}^{PSFCH #3} may include at least one of pieces of information indicating the start position and end position (or frequency bandwidth size) of the frequency resource where the PSFCH signal for the PSSCH signal transmitted/received for each carrier may be transmitted/received.

Method B: This is mostly similar to method A but differs as follows. M_{PRB,set}^{PSFCH}=ΣₖM_{PRB,set,k}^{PSFCH}, and M_{PRB,set,k}^{PSFCH} is an integer multiple of N_{subch,k}·N_{PSSCH,k}^{PSFCH}. Here, M_{PRB,set,k}^{PSFCH} means the number of PRBs of the PSFCH allocated for specific carrier k, which may use a value previously configured through control information (or configuration information) or a preconfigured value. It may have a different integer value for each carrier k. As described above, in response to PSSCH transmission/reception, the section, range, and/or amount of PRB resources of the transmission slot where PSFCH reception/transmission is performed may be denoted as [A, B] PRBs. For example, the UE may transmit corresponding HARQ-ACK information in [(i+j·N_{PSSCH,k}^{PSFCH})·M_{subch,slot,k}^{PSFCH}, (i+1+j·N_{PSSCH,k}^{PSFCH})·M_{subch,slot,k}^{PSFCH}−1] PRBs of the PSFCH transmission slot for the PSSCH received in slot i, subchannel j, and carrier k among M_{PRB,set}^{PSFCH} PRBs. In this case, i, j, and k have a relationship in sequential ascending order. In other words, when designating the PRB where the PSFCH is transmitted/received, the slot index is considered first, and the subchannel index, and then the carrier index are considered. M_{subch,slot,k}^{PSFCH}=M_{PRB,set,k}^{PSFCH}/(N_{sub,ch,k}·N_{PSSC,k}^{PSFCH}). The UE may allocate M_{PRB,set,k}^{PSFCH} PRBs among M_{PRB,set}^{PSFCH} PRBs, for each carrier index k. Therefore, unlike method A, in method B, the number M_{subch,slot}^{PSFCH} of PRBs of PSFCH resource allocated for each carrier may vary. The example of FIG. 27 is described. In method A, M_{PRB,set}^{PSFCH} itself is fixed to a preconfigured value regardless of the number of carriers associated with PSFCH but, in method B, L1, L2, and L3 which are the numbers of frequency resources to use PSFCH for the respective carriers may be configured through control information (or configuration information). Here, L1, L2, and L3 may be replaced with M_{PRB,set,1}^{PSFCH} M_{PRB,set,2}^{PSFCH} M_{PRB,set,3}^{PSFCH}. Further, in addition to the number of frequency resources, information indicating the frequency start and end positions may be individually included.

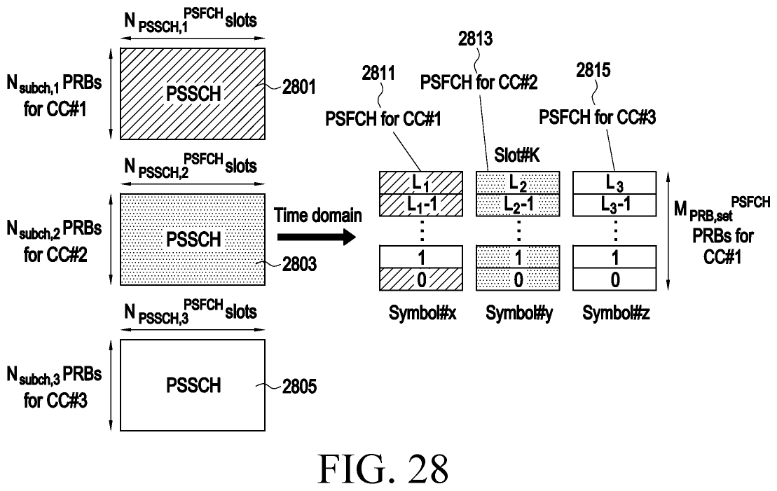

Method C: PSFCH resource selection for PSSCH may be performed by time division multiplexing (TDM) for each carrier. As in FIG. 28, the PSFCH resources 2811, 2813, and 2815 for the PSSCH signals 2801, 2803, and 2805 received for the carriers CC #1, CC #2, and CC #3, respectively, may be TDMed, and the UE selects a specific PSFCH resource according to the subchannel (frequency resource) where it receives the PSSCH signal in the time resource (symbol #x, symbol #y, and symbol #z) allocated for each corresponding carrier and slot (time resource). In sum, in method C, the PSFCH resource selected by the UE is determined depending on the carrier resource where the PSSCH signal is received and the frequency and time resources in the corresponding carrier. For example, when the number of carriers associated with one PSFCH is N_{PSSCH}^{cell}, the number of slots of the PSSCH associated with one PSFCH slot in specific carrier k is N_{PSSCH,k}^{PSFCH}, the total number of PRBs allocated for PSFCH transmission is M_{PRB,set}^{PSFCH}, and the number of subchannels belonging to the resource pool configured for carrier k is N_{subch,k}, M_{PRB,set}^{PSFCH} is an integer multiple of N_{subch,k}·N_{PSSCH,k}^{PSFCH}, and the number M_{PRB,set}^{PSFCH} of PRB resources allocated for PSFCH remains the same regardless of carrier index k. Instead, unlike in methods A and B above, the time resources of PSFCH selected for carrier k vary. In the embodiment of FIG. 28, the UE may transmit PSFCH signal including HARQ-ACK information in symbol #x in response to the PSSCH signal received on CC #1, transmit PSFCH signal including HARQ-ACK information in symbol #y in response to the PSSCH signal received on CC #2, and transmit PSFCH signal including HARQ-ACK information in symbol #z in response to the PSSCH signal received on CC #3. Here, symbol #x, symbol #y, and symbol #z, which are time resources where the PSFCH signals are transmitted, may have one or more symbol units and may have the same or different lengths of time resources. The position of the slot or symbol in which the PSFCH signal corresponding to each carrier k is transmitted/received may be previously configured by control information (or configuration information). Accordingly, a situation in which PSFCHs including HARQ-ACK information are transmitted in the same time resource in response to PSSCH signals received on different carriers will not occur. If PSFCH signals including HARQ-ACK information are instructed to use the same time resource in response to the PSSCH signals received on different carriers by configuration by the base station or configuration by another UE, the UE may transmit the PSFCH signal including HARQ-ACK information only for the PSSCH signal received on the carrier having the lowest (or highest) carrier index or the PSSCH signal selected based on priority information for SCI format scheduling the corresponding PSSCH. As another example, if the PSFCH signal is transmitted in nth symbol of slot i in response to the PSSCH signal received on CC #1, the PSFCH signal may be transmitted in the (n+k)th symbol of slot i in response to the PSSCH signal received on CC #(1+k).

As described above, in response to PSSCH transmission/reception, the section, range, and/or amount of PRB resources of the transmission slot where PSFCH reception/transmission is performed may be denoted as [A, B] PRBs. For example, the UE may transmit corresponding HARQ-ACK information in [(i+j·N_{PSSCH,k}^{PSFCH})·M_{subch,slot}^{PSFCH}(i+1+j·N_{PSSCH,k}^{PSFCH})·M_{subch,slot}^{PSFCH}−1] PRBs in symbol n associated with carrier k in the PSFCH transmission slot for the PSSCH signal received in slot i, subchannel j, and carrier k among M_{PRB,set}^{PSFCH} PRBs. In this case, i and j have a relationship in sequential ascending order. In other words, when designating the PRB where the PSFCH signal is transmitted/received, the slot index is considered first, and the subchannel index, and then the carrier index are considered. Here, M_{subch,slot}^{PSFCH}=M_{PRB,set}^{PSFCH}/(ΣₖN_{subch,k}·N_{PSSCH,k}^{PSFCH}). M_{subch,slot}^{PSFCH} means the number of PRBs where PSFCH is transmitted.

In the resource pool in carrier k, the UE determines the number of PSFCH resources available for HARQ-ACK information multiplexing in PSFCH transmission, through M_{PRB,CS,k}^{PSFCH}=N_{type,k}^{PSFCH}·M_{subch,slot}^{PSFCH}·N_{CS}^{PSFCH}. Here, N_{CS}^{PSFCH} is the number of cyclic shift pairs configured in the resource pool, and N_{type,k}^{PSFCH} is a value set in the resource pool of carrier k through control information (or configuration information) and may be 1 or N_{subch,k}^{PSSCH}. When N_{type,k}^{PSFCH}=1, the PRBs of M_{subch,slot}^{PSFCH} are related to the start subchannel index of PSSCH and, when N_{type,k}^{PSFCH}=N_{subch,k}^{PSSCH}, the PRBs of N_{subch,k}^{PSSCH}·M_{subch,slot}^{PSFCH} are associated with one or more subchannels among the N_{subch,k}^{PSSCH} subchannels of the PSSCH. PSFCH resources may be indexed in ascending order of PRB index for N_{subch,k}^{PSSCH}·M_{subch,slot}^{PSFCH} PRBs, and be then indexed in ascending order of cyclic shift pair index among N_{CS}^{PSFCH} cyclic shift parts.

The index of the PSFCH resource for PSFCH transmission responsive to the PSSCH reception received by the UE in the resource pool in specific carrier k may be determined by (P_{ID}+M_{ID})mod M_{PRB,CS,k}^{PSFCH}. Here, P_{ID} is the physical channel source ID included in the SCI format for scheduling the PSSCH, M_{ID} is a value determined according to the cast type information value condition included in a specific SCI format, e.g., when a specific SCI format includes a field designating the group cast, M_{ID} is the ID of the UE receiving the corresponding PSSCH, and in other cases, M_{ID} is regarded as 0. m₀ and m_{cs} are determined according to the SCI format scheduling PSSCH and the cast type information (broadcast, unicast, or groupcast) in the SCI format to determine the cyclic shift value and thus determines the cyclic shift value α. m₀ is the initial cyclic shift, and m_{cs} is a cyclic shift value determined according to whether it is ACK or NACK. The example of FIG. 28 shows a process of selecting a PSFCH resource by method C described above. For example, the PSSCH signals 2801, 2803, and 2805 transmitted/received through three carriers CC #1, CC #2, and CC #3, respectively, are selected in the TDMed format in the PSSCH transmission slot or symbol resource in one carrier, and the time resources of symbol #1, symbol #y, and symbol #z divided in at least one symbol unit are used for PSFCH transmission including HARQ-ACK information in response to PSSCH signals transmitted/received on the respective carriers CC #1, CC #2, and CC #3. As an example, L1, L2, and L3 representing frequency resources in PRB units may have the same value as M_{PRB,set}^{PSFCH}. As another example, L₁, L₂, and L₃ may be determined depending on the number of subchannels of the resource pool configured for each carrier and the number of PSSCH slots associated with PSFCH transmission slot and be thus equal to or different from each other. The number M_{subch,slot}^{PSFCH} of PRBs of PSFCH resources allocated to each carrier through method C may always be the same. N_{PSSCH}^{cell}, P_{SSCH,k}^{PSFCH}, M_{PRB,net}^{PSFCH}, N_{subch,k} may be configured by a higher layer signal in advance. Further, in response to the PSSCH signal transmitted/received on each carrier, the time resource information (e.g., start symbol position and length) where the PSFCH signal may be transmitted/received may be configured through control information (or configuration information).

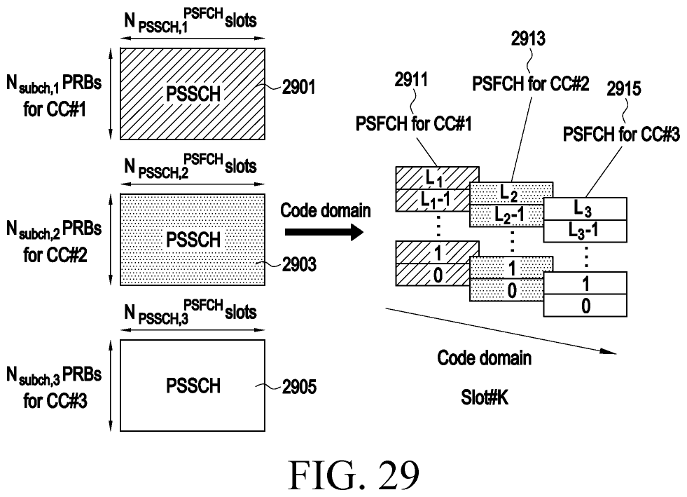

Method D: PSFCH resource selection for PSSCH may be performed by code division multiplexing (CDM) for each carrier. As in FIG. 29, the PSFCH resources 2911, 2913, and 2915 for the PSSCH signals 2901, 2903, and 2905 received for the carriers CC #1, CC #2, and CC #3, respectively, may be CDMed, and the UE selects a specific PSFCH resource, divided by different code resources, according to the subchannel (frequency resource) where it receives the PSSCH signal in the time resource allocated for each corresponding carrier and slot (time resource). In sum, in method D, the PSFCH resource selected by the UE is divided by different code resources and determined depending on the carrier resource where the PSSCH signal is received and the frequency and time resources in the corresponding carrier. For example, when the number of slots of the PSSCH associated with one PSFCH slot in specific carrier k is N_{PSSCH,k}^{PSFCH}, the total number of PRBs allocated for PSFCH transmission is M_{PRB,set}^{PSFCH}, and the number of subchannels belonging to the resource pool configured for carrier k is N_{subch,k}, M_{PRB,set}^{PSFCH} is an integer multiple of N_{subch,k}·N_{PSSCH,k}^{PSFCH}. As another example, M_{PRB,set}^{PSFCH} may be an integer multiple considering the largest value among all the carriers associated with it. In other words, M_{PRB,set}^{PSFCH} may be an integer multiple of maxₖ(N_{subch,k})·maxₖ(N_{PSSCH,k}^{PSFCH}), or M_{PRB,set}^{PSFCH} may be an integer multiple of maxₖ(N_{subch,k}·N_{PSSCH,k}^{PSFCH}). The above equation may be replaced with a min function to obtain the minimum value instead of the max function to obtain the maximum value or with a round function to round to a predetermined decimal place. Since the number of (sub)channels in the resource pool in each carrier and the number of slots of the PSSCH associated with the PSFCH may vary, despite the same M_{PRB,set}^{PSFCH}, the integer multiple may vary. As described above, in response to PSSCH transmission/reception, the section, range, and/or amount of PRB resources of the transmission slot where PSFCH reception/transmission is performed may be denoted as [A, B] PRBs. For example, the UE may transmit corresponding HARQ-ACK information in [(i+j·N_{PSSCH,k}^{PSFCH})·M_{subch,slot}^{PSFCH}·(i+1+j·N_{PSSCH,k}^{PSFCH})·M_{subch,slot}^{PSFCH}−1] PRBS of the PSFCH transmission slot for the PSSCH signal received in slot i, subchannel j, and carrier k among M_{PRB,set}^{PSFCH} PRBs. In this case, i and j have a relationship in sequential ascending order. In other words, when selecting the PRB where the PSFCH is transmitted/received, the slot index is considered first, and the subchannel index, and then the carrier index are considered. Here, M_{subch,slot}^{PSFCH}=M_{PRB,set}^{PSFCH}/(N_{subch,k}·N_{PSSCH,k}^{PSFCH}). M_{subch,slot}^{PSFCH} means the number of PRBs where PSFCH is transmitted.

In the resource pool in carrier k, the UE may determine the number of PSFCH resources available for HARQ-ACK information multiplexing in PSFCH transmission, through M_{PRB,CS,k}^{PSFCH}=N_{type,k}^{PSFCH}·M_{subch,slot}^{PSFCH}·N_{CS}^{PSFCH}. As another example, in the resource pool in carrier k, the UE may determine the number of PSFCH resources available for HARQ-ACK information multiplexing in PSFCH transmission, through M_{PRB,CS,k}^{PSFCH}=N_{type,k}^{PSFCH}·M_{subch,slot}^{PSFCH}·N_{CS}^{PSFCH}·N_{cell}^{PSFCH}. Here, N_{CS}^{PSFCH} is the number of cyclic shift pairs configured in the resource pool, and N_{type,k}^{PSFCH} is a value set in the resource pool of carrier k through a higher layer signal and may be 1 or N_{subch,k}^{PSSCH}. When N_{type,k}^{PSFCH}=1, the PRBs of M_{subch,slot}^{PSFCH} are related to the start subchannel index of PSSCH and, when N_{type,k}^{PSFCH}=N_{subch,k}^{PSSCH}, the PRBs of N_{subch,k}^{PSSCH}·M_{subch,slot}^{PSFCH} are associated with one or more (sub)channels among the N_{subch,k}^{PSSCH} (sub)channels of the PSSCH. PSFCH resources are indexed in ascending order of PRB index for N_{type,k}^{PSFCH}·M_{subch,slot}^{PSFCH} PRBs, and are then indexed in ascending order of cyclic shift pair index among N_{CS}^{PSFCH} cyclic shift parts. N_{cell}^{PSFCH} means the number of carriers associated with PSFCH transmission. The index of the PSFCH resource for PSFCH transmission corresponding to the PSSCH reception received by the UE in the resource pool in specific carrier k is determined by (P_{ID}+M_{ID}+C_{ID})mod M_{PRB,CS,k}^{PSFCH} or {(P_{ID}+M_{ID})mod M_{PRB,CS,k}^{PSFCH}}mod C_{ID}. P Here, P_{ID} is the physical channel source ID included in the SCI format for scheduling the PSSCH, M_{ID} is a value determined according to the cast type information (broadcast, unicast, or groupcast) included in a specific SCI format, e.g., when a specific SCI format includes a field designating the group cast, M_{ID} is the ID of the UE receiving the corresponding PSSCH, and in other cases, M_{ID} is regarded as 0. C_{ID} is the carrier ID or cell ID, meaning the index of the carrier where PSSCH is transmitted/received. m₀ and m_{cs} are determined according to the SCI format scheduling PSSCH and the cast type information in the SCI format to determine the cyclic shift value and thus determines the cyclic shift value α. m₀ is the initial cyclic shift, and m_{cs} is a cyclic shift value determined according to whether it is ACK or NACK. The example of FIG. 29 shows a process of selecting a PSFCH resource by method D described above. For example, the PSSCH signals 2901, 2903, and 2905 transmitted/received through three carriers CC #1, CC #2, and CC #3, respectively, are CDMed according to the PSSCH transmission slot or symbol resource in one carrier and divided into different code resources and are used for PSFCH transmission including HARQ-ACK information in response to PSSCH signals transmitted/received on the respective carriers CC #1, CC #2, and CC #3. N_{PSSCH}^{cell}, N_{PSSCH,k}^{PSFCH}, M_{PRB,set}^{PSFCH}, N_{subch,k} may be configured in advance through control information (or configuration information).

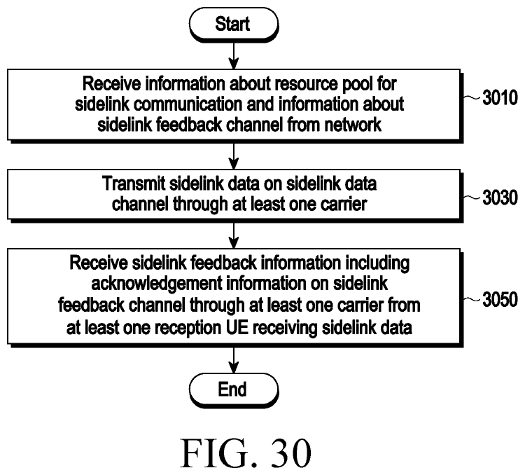

FIG. 30 is a flowchart illustrating operations of a transmission UE supporting sidelink carrier aggregation (CA) according to an embodiment of the disclosure. In the disclosure, the transmission UE may transmit PSCCH and PSSCH and receive PSFCH in response to the PSSCH transmission in a wireless communication system supporting multiple carriers according to embodiments of the disclosure.

Referring to FIG. 30, in step 3010, the transmission UE may receive at least one of information about a resource pool for sidelink communication and information about sidelink feedback channel (PSFCH) from a network. The information about the resource pool and the information about sidelink feedback channel may be higher layer signaling information provided from the base station, such as RRC information or may be the DCI provided from the base station or the SCI provided from the transmission UE. In step 3030, the transmission UE transmits sidelink data on a sidelink data channel (PSSCH) through at least one carrier. Thereafter, in step 3050, the transmission UE receives sidelink feedback information including an acknowledgement information for the sidelink data on the sidelink feedback channel (PSFCH) through at least one carrier from at least one reception UE receiving the sidelink data.

In the disclosure, the transmission UE may receive the sidelink feedback information on the same carrier or a different carrier from the carrier where the sidelink data is transmitted, based on information about the sidelink feedback channel. Further, the sidelink feedback information received from the at least one reception UE may be received on one of the at least one carrier. Further, in the disclosure, when the transmission UE transmits the sidelink data on a plurality of sidelink data channels through a plurality of carriers, resources of a plurality of sidelink feedback channels where the sidelink feedback information including the acknowledgement information is received may be determined by one of an FDM scheme, TDM and CDM using embodiments of method A to method D described above, based on frequency resources and time resources of each carrier where the sidelink data is transmitted. Further, information indicating the start PRB and end PRB among PRB resources of the slot where the sidelink feedback information including the acknowledgement information is received may be determined based on the information about the sidelink feedback channel.

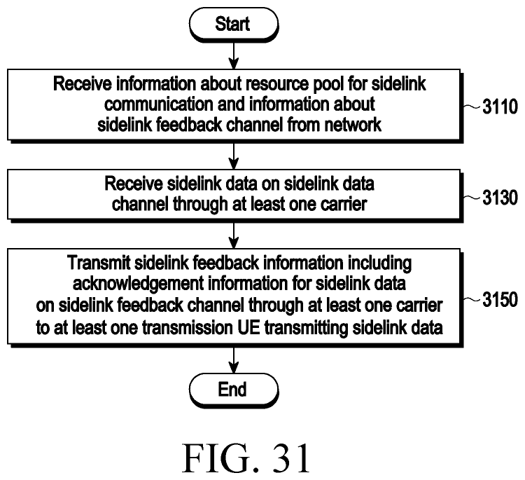

FIG. 31 is a flowchart illustrating operations of a reception UE supporting sidelink carrier aggregation according to an embodiment of the disclosure. In the disclosure, the reception UE may receive PSCCH and PSSCH and transmit PSFCH in response to the PSSCH reception in a wireless communication system supporting multiple carriers according to embodiments of the disclosure.

Referring to FIG. 31, in step 3110, the reception UE may receive at least one of information about a resource pool for sidelink communication and information about sidelink feedback channel from a network. The information about the resource pool and the information about sidelink feedback channel may be higher layer signaling information provided from the base station, such as RRC information or may be the DCI provided from the base station or the SCI provided from the transmission UE. In step 3130, the reception UE receives sidelink data on a sidelink data channel through at least one carrier. Thereafter, in step 3150, the reception UE transmits sidelink feedback information including an acknowledgement information for the sidelink data on the sidelink feedback channel through at least one carrier to at least one transmission UE transmitting the sidelink data.

In the disclosure, the reception UE may transmit the sidelink feedback information on the same carrier or a different carrier from the carrier where the sidelink data is transmitted, based on the information about the sidelink feedback channel. Further, the sidelink feedback information may be transmitted on one of the at least one carrier. Further, in the disclosure, when the reception UE receives the sidelink data on a plurality of sidelink data channels through a plurality of carriers, resources of a plurality of sidelink feedback channels where the sidelink feedback information including the acknowledgement information is transmitted may be determined by one of an FDM scheme, TDM and CDM using embodiments of method A to method D described above, based on frequency resources and time resources of each carrier where the sidelink data is transmitted. Further, information indicating the start PRB and end PRB among PRB resources of the slot where the sidelink feedback information including the acknowledgement information is transmitted may be determined based on the information about the sidelink feedback channel.

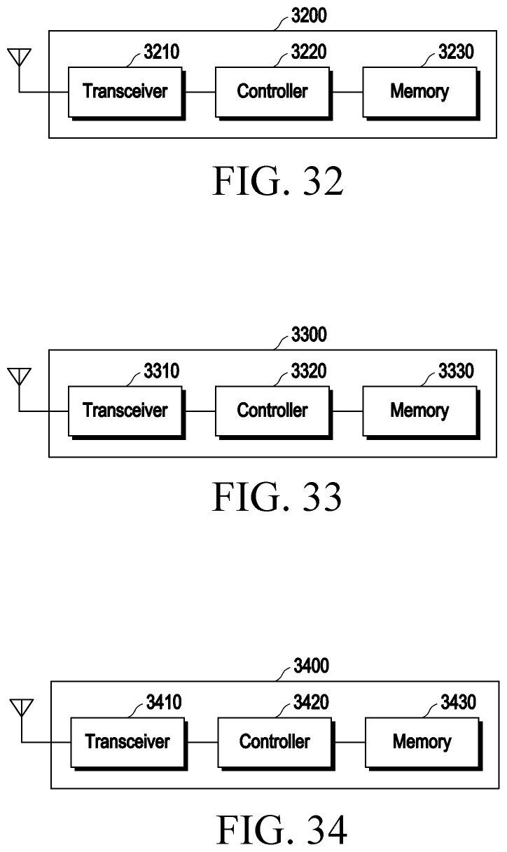

FIG. 32 is a block diagram illustrating an internal structure of a transmission UE according to an embodiment of the disclosure.

Referring to FIG. 32, a transmission UE 3200 of the disclosure may include a transceiver 3210, a controller 3220, and a memory 3230. In an embodiment, the memory 3230 may also be referred to as a storage unit 3230. However, the components of the transmission UE 3200 are not limited thereto. For example, the transmission UE 3200 may include more or fewer components than the above-described components. Thus, the transmission UE 3200 may be implemented to include a transceiver for wireless communication and a processor to control operation according to one or a combination of at least one of the above-described embodiments. The transceiver 3210, the controller 3220, and the memory 3230 may be implemented in the form of a single chip.

In an embodiment, the transceiver 3210 may transmit/receive signals to and from a base station or another UE. The aforementioned signals may include synchronization signals, reference signals, control information and data. To that end, the transceiver 3210 may include a radio frequency (RF) transmitter for frequency-up converting and amplifying signals transmitted and an RF receiver for low-noise amplifying signals received and frequency-down converting the frequency of the received signals. The transceiver 3210 may receive signals via a radio channel, output the signals to the controller 3220, and transmit signals output from the controller 3220 via a radio channel.

In an embodiment, the memory 3230 may store a program and data necessary to operate the transmission UE 3200. The memory 3230 may store control information or data that is included in the signal transmitted/received by the transmission UE 3200. The memory 3230 may include a storage medium, such as ROM, RAM, hard disk, CD-ROM, and DVD, or a combination of storage media. Further, the memory 3230 may include a plurality of memories.

In an embodiment, the controller 3220 may control a series of operations to allow the transmission UE 3200 to operate as per the above-described embodiments. The controller 3220 may include at least one processor. The controller 3220 may include a plurality of processors and execute the program stored in the memory 3230 to control the feedback channel resource allocation method according to embodiments of the disclosure and transmission and reception of the sidelink feedback channel transmitted between UEs.

FIG. 33 is a block diagram illustrating an internal structure of a reception UE according to an embodiment of the disclosure.

Referring to FIG. 33, a reception UE 3300 of the disclosure may include a transceiver 3310, a controller 3320, and a storage unit 3330. However, the components of the reception UE 3300 are not limited thereto. For example, the reception UE 3300 may include more or fewer components than the above-described components. Thus, the reception UE 3300 may be implemented to include a transceiver for wireless communication and a processor to control operation according to one or a combination of at least one of the above-described embodiments. The transceiver 3310, the controller 3320, and the memory 3330 may be implemented in the form of a single chip.

In an embodiment, the transceiver 3310 may transmit/receive signals to and from a base station or another UE. The aforementioned signals may include synchronization signals, reference signals, control information and data. To that end, the transceiver 3310 may include a radio frequency (RF) transmitter for frequency-up converting and amplifying signals transmitted and an RF receiver for low-noise amplifying signals received and frequency-down converting the frequency of the received signals. The transceiver 3310 may receive signals via a radio channel, output the signals to the controller 3320, and transmit signals output from the controller 3320 via a radio channel.

In an embodiment, the storage unit 3330 may store a program and data necessary to operate the reception UE 3300. The storage unit 3330 may store control information or data that is included in the signal transmitted/received by the reception UE 3300. The storage unit 3330 may include a storage medium, such as ROM, RAM, hard disk, CD-ROM, and DVD, or a combination of storage media. Further, the storage unit 3330 may include a plurality of memories.

In an embodiment, the controller 3320 may control a series of operations to allow the reception UE 3300 to operate as per the above-described embodiments. The controller 3320 may include at least one processor. The controller 3320 may include a plurality of processors and execute the program stored in the storage unit 3330 to control the feedback channel resource allocation method according to embodiments of the disclosure and transmission and reception of the sidelink feedback channel transmitted between UEs.

FIG. 34 is a block diagram illustrating an internal structure of a base station according to an embodiment of the disclosure.

Referring to FIG. 34, a base station 3400 of the disclosure may include a transceiver 3410, a controller 3420, and a storage unit 3430. However, the components of the base station 3400 are not limited thereto. For example, the base station 3400 may include more or fewer components than the above-described components. Thus, the base station 3400 may be implemented to include a transceiver for wireless communication and a processor to control operation according to one or a combination of at least one of the above-described embodiments. The transceiver 3410, the controller 3420, and the memory 3430 may be implemented in the form of a single chip.

In an embodiment, the transceiver 3410 may transmit/receive signals to and from a base station or another UE. The aforementioned signals may include synchronization signals, reference signals, control information and data. To that end, the transceiver 3410 may include a radio frequency (RF) transmitter for frequency-up converting and amplifying signals transmitted and an RF receiver for low-noise amplifying signals received and frequency-down converting the frequency of the received signals. The transceiver 3410 may receive signals via a radio channel, output the signals to the controller 3420, and transmit signals output from the controller 3420 via a radio channel.

In an embodiment, the storage unit 3430 may store a program and data necessary to operate the base station 3400. The storage unit 3430 may store control information or data that is included in the signal transmitted/received by the base station 3400. The storage unit 3430 may include a storage medium, such as ROM, RAM, hard disk, CD-ROM, and DVD, or a combination of storage media. Further, the storage unit 3430 may include a plurality of memories.

In an embodiment, the controller 3420 may control a series of processes for the UE to be able to operate according to the above-described embodiments. The controller 3420 may include at least one processor. The controller 3420 may include a plurality of processors and execute the program stored in the storage unit 3430 to control the feedback channel resource allocation method according to embodiments of the disclosure and transmission and reception of the sidelink feedback channel transmitted between UEs.

The methods according to the embodiments described in the specification or claims of the disclosure may be implemented in hardware, software, or a combination of hardware and software.

When implemented in software, there may be provided a computer readable storage medium or computer program product storing one or more programs (software modules). One or more programs stored in the computer readable storage medium or computer program product are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present disclosure have been described above, various changes may be made thereto without departing from the scope of the present disclosure. Thus, the scope of the disclosure should not be limited to the above-described embodiments, and should rather be defined by the following claims and equivalents thereof.

1. A method for communication by a transmission user equipment (UE) in a wireless communication system supporting sidelink carrier aggregation, the method comprising:
receiving, from a network, information about a resource pool for sidelink communication and information about a sidelink feedback channel;
transmitting sidelink data on a sidelink data channel through at least one carrier; and
receiving sidelink feedback information including acknowledgement information for the sidelink data on the sidelink feedback channel through at least one carrier from at least one reception UE receiving the sidelink data.

2. The method of claim 1, wherein the sidelink feedback information is received on the same carrier or a different carrier from the carrier where the sidelink data is transmitted, based on the information about the sidelink feedback channel.

3. The method of claim 1, wherein the sidelink feedback information received from the at least one reception UE is received on one carrier among the at least one carrier.

4. The method of claim 1, wherein when the sidelink data is transmitted on a plurality of sidelink data channels through a plurality of carriers, resources of a plurality of sidelink feedback channels where the sidelink feedback information including the acknowledgement information is received are determined by one of a frequency division multiplexing (FDM) scheme, time division multiplexing (TDM) and code division multiplexing (CDM) based on frequency resources and time resources of each carrier where the sidelink data is transmitted.

5. The method of claim 4, wherein information indicating a start physical resource block (PRB) and end PRB among PRB resources of a slot where the sidelink feedback information including the acknowledgement information is received is determined based on the information about the sidelink feedback channel.

6. A method for communication by a reception UE in a wireless communication system supporting sidelink carrier aggregation, the method comprising:
receiving, from a network, information about a resource pool for sidelink communication and information about a sidelink feedback channel;
receiving sidelink data on a sidelink data channel through at least one carrier; and
transmitting sidelink feedback information including acknowledgement information for the sidelink data on the sidelink feedback channel through at least one carrier to at least one transmission UE transmitting the sidelink data.

7. The method of claim 6, wherein the sidelink feedback information is transmitted on the same carrier or a different carrier from the carrier where the sidelink data is transmitted, based on the information about the sidelink feedback channel.

8. The method of claim 6, wherein the sidelink feedback information transmitted to the at least one transmission UE is transmitted on one carrier among the at least one carrier.

9. The method of claim 6, wherein when the sidelink data is received on a plurality of sidelink data channels through a plurality of carriers, resources of a plurality of sidelink feedback channels where the sidelink feedback information including the acknowledgement information is transmitted are determined by one of a frequency division multiplexing (FDM) scheme, time division multiplexing (TDM) and code division multiplexing (CDM) based on frequency resources and time resources of each carrier where the sidelink data is received.

10. The method of claim 9, wherein information indicating a start physical resource block (PRB) and end PRB among PRB resources of a slot where the sidelink feedback information including the acknowledgement information is transmitted is determined based on the information about the sidelink feedback channel.

11. A transmission UE in a wireless communication system supporting sidelink carrier aggregation, the transmission UE comprising:
a transceiver; and
a processor configured to:
receive, from a network, information about a resource pool for sidelink communication and information about a sidelink feedback channel,
transmit sidelink data on a sidelink data channel through at least one carrier, and
receive sidelink feedback information including acknowledgement information for the sidelink data on the sidelink feedback channel through at least one carrier from at least one reception UE receiving the sidelink data.

12. (canceled)

13. A reception UE in a wireless communication system supporting sidelink carrier aggregation, the reception UE comprising:
a transceiver; and
a processor configured to:
receive, from a network, information about a resource pool for sidelink communication and information about a sidelink feedback channel,
receive sidelink data on a sidelink data channel through at least one carrier, and
transmit sidelink feedback information including acknowledgement information for the sidelink data on the sidelink feedback channel through at least one carrier to at least one transmission UE transmitting the sidelink data.

14. (canceled)

15. The transmission UE of claim 11, wherein the sidelink feedback information is received on the same carrier or a different carrier from the carrier where the sidelink data is transmitted, based on the information about the sidelink feedback channel.

16. The transmission UE of claim 11, wherein the sidelink feedback information received from the at least one reception UE is received on one carrier among the at least one carrier.

17. The transmission UE of claim 11, wherein when the sidelink data is transmitted on a plurality of sidelink data channels through a plurality of carriers, resources of a plurality of sidelink feedback channels where the sidelink feedback information including the acknowledgement information is received are determined by one of a frequency division multiplexing (FDM) scheme, time division multiplexing (TDM) and code division multiplexing (CDM) based on frequency resources and time resources of each carrier where the sidelink data is transmitted.

18. The transmission UE of claim 17, wherein information indicating a start physical resource block (PRB) and end PRB among PRB resources of a slot where the sidelink feedback information including the acknowledgement information is received is determined based on the information about the sidelink feedback channel.

19. The reception UE of claim 13, wherein the sidelink feedback information is transmitted on the same carrier or a different carrier from the carrier where the sidelink data is transmitted, based on the information about the sidelink feedback channel.

20. The reception UE of claim 13, wherein the sidelink feedback information transmitted to the at least one transmission UE is transmitted on one carrier among the at least one carrier.

21. The reception UE of claim 13, wherein when the sidelink data is received on a plurality of sidelink data channels through a plurality of carriers, resources of a plurality of sidelink feedback channels where the sidelink feedback information including the acknowledgement information is transmitted are determined by one of a frequency division multiplexing (FDM) scheme, time division multiplexing (TDM) and code division multiplexing (CDM) based on frequency resources and time resources of each carrier where the sidelink data is received.

22. The reception UE of claim 21, wherein information indicating a start physical resource block (PRB) and end PRB among PRB resources of a slot where the sidelink feedback information including the acknowledgement information is transmitted is determined based on the information about the sidelink feedback channel.
